(19) United States
(12) Patent Application Publication
(10) Pub. No.: US 2024/0216892 A1
(43) Pub. Date: Jul. 4, 2024

(54) TOXIN AND GAS ADSORPTION BY POROUS MELANIN

(71) Applicant: Northwestern University, Evanston, IL (US)

(72) Inventors: Nathan C. GIANNESCHI, Wilmette, IL (US); Zofia E. SIWICKA, Evanston, IL (US); Naneki C. MCCALLUM, San Diego, CA (US)

(73) Assignee: Northwestern University, Evanston, IL (US)

(21) Appl. No.: 18/269,078

(22) PCT Filed: Dec. 22, 2021
(86) PCT No.: PCT/US21/64842

§ 371 Date: Jun. 22, 2023

Related U.S. Application Data
(60) Provisional application No. 63/129,885, filed on Dec. 23, 2020.

(51) Int. Cl. B01J 20/30; B01D 53/02; B01J 20/26; B01J 20/28; B01J 20/32

(52) U.S. Cl. CPC B01J 20/3057; B01D 53/02; B01J 20/262; B01J 20/28069; B01J 20/3208; B01J 20/3272; B01D 2253/202; B01D 2256/245; B01D 2257/102; B01D 2257/108; B01D 2257/406; B01D 2257/504; B01D 2257/7025

(57) ABSTRACT

Aspects of the invention include a method of capturing target compound(s) using a capture device, the method comprising: exposing the device to an environment comprising the target compound(s); wherein the device comprises: a porous artificial melanin material comprising: one or more melanin oligomers and/or polymers; wherein the melanin oligomers and/or polymers comprise a plurality of covalently-bonded melanin base units; wherein the melanin oligomers and/or polymers are arranged to form an internal structure having a plurality of pores; wherein the porous artificial melanin material is characterized by a pore volume per mass of material greater than or equal to 0.1 cm³/g and wherein at least a portion of said pores have at least one size dimension greater than or equal to 0.5 nm; and capturing the target compound(s) via an interaction between the porous artificial melanin material and the target compound(s).

### CROSS-REFERENCE TO RELATED APPLICATIONS

This application claims the benefit of priority to U.S. Provisional Patent Application No. 63/129,885, filed Dec. 23, 2020, which is hereby incorporated by reference in its entirety.

### STATEMENT REGARDING FEDERALLY SPONSORED RESEARCH OR DEVELOPMENT

This invention was made with government support under Award Number AFOSR FA9550-18-1-0142 awarded by the Air Force Office of Scientific Research. The government has certain rights in the invention.

### BACKGROUND OF INVENTION

Adsorption materials for environmental and remediation use are growing in importance. The efficient removal and capture of greenhouse gases and chemical warfare agents are among some of the applications that have an increased demand for adsorption materials. Porous materials are often used for adsorption applications due to their large surface area and pore volume. However, many porous materials that are currently available are often not scalable, expensive and/or time consuming to synthesize, or not chemically stable. Melanin in nature has been shown to adsorb organic molecules and metals from its environment due to its hydroxyl rich functional groups. However, these materials have been limited in their adsorption due to their low surface area and pore volume.

There is a need for materials which are biocompatible, scalable, cheap, and easy to synthesize that have the capability to adsorb gases or toxins. This could be for many applications such as gas storage, water filtration, or for protecting civilians or the military in war-torn areas where chemical warfare agents are still used. To date there are technologies such as metal organic frameworks (MOFs) which perform well at gas and toxin adsorption but their scalability is a challenge, and they require very precise chemistries and include metals which might contaminate sensitive systems such as marine or farming environments.

### SUMMARY OF THE INVENTION

Included herein are methods and devices that utilize porous artificial melanin materials for capturing target compounds, such as gaseous compounds, that may be, for example, toxic or controlled substances. Benefits of using artificial melanin materials may include their biocompatibility, their scalable and relatively inexpensive synthesis, inexpensive synthesis, their stability in aqueous media, their tunability (such as the porosity and pore sizes), absence of metal elements in their composition, and their ability to capture or adsorb various compounds. The toxin and gas adsorption capabilities of the melanin compositions disclosed herein have implications for large scale usage. Applications of the methods and devices disclosed herein may include: (1) adsorption of chemical warfare agents/nerve agents and their analogues; (2) adsorption of pesticides; (3) toxin remediation; (4) gas capture (e.g., CH₄, NH₃, CO₂, N₂ and other gases); (5) organic molecule adsorption (such as dyes and toxins); and (6) waste-water remediation.

Aspects of the invention include a method of capturing one or more target compounds using a capture device, the method comprising: exposing the capture device to an environment comprising the one or more target compounds; wherein the device comprises: a porous artificial melanin material comprising: one or more melanin oligomers, polymers, or a combination thereof; wherein the one or more melanin oligomers, polymers, or a combination thereof comprise a plurality of covalently-bonded melanin base units; wherein the one or more melanin oligomers, polymers, or a combination thereof are arranged to form an internal structure having a plurality of pores; and capturing the one or more target compounds via an interaction between the porous artificial melanin material and the one or more target compounds. Optionally, or preferably for some applications, the porous artificial melanin material is characterized by a pore volume per mass of material greater than or equal to 0.1 cm³/g. Optionally, or preferably for some applications, at least a portion of said pores have at least one size dimension greater than or equal to 0.5 nm. Optionally in any of the methods and devices disclosed herein, the one or more target compounds are one or more gaseous compounds and/or one or more solvated or aqueous compounds; and wherein the environment is a gaseous and/or a liquid environment. Optionally in any of the methods and devices disclosed herein, the one or more target compounds are one or more solvated or aqueous compounds, and the environment is a liquid environment. Optionally in any of the methods and devices disclosed herein, the one or more target compounds are one or more gaseous compounds, the environment is a gaseous environment, and the capture device is a gas-capture device. Optionally in any of the methods and devices disclosed herein, a temperature of the environment (such as gaseous environment) and/or the one or more target compounds is selected from the range of about 270 K to about 325 K, optionally about 270 K to about 400 K, optionally about 270 K to 450 K, or any temperature or range thereof therebetween inclusively. Optionally in any of the methods and devices disclosed herein, the porous artificial melanin material comprises a plurality of the melanin oligomers, polymers, or a combination thereof. Optionally in any devices disclosed herein, the porous artificial melanin material comprises a plurality of the melanin oligomers and/or polymers. Optionally in any of the methods and devices disclosed herein, the interaction between the porous artificial melanin material and the one or more target compounds comprises adsorption. Optionally, interaction between the porous artificial melanin material and the one or more target compounds comprises adsorption of the one or more target compounds (such as gaseous compounds) at or to the porous artificial melanin material. Optionally in any of the methods and devices disclosed herein, the interaction between the porous artificial melanin material and the one or more target compounds is adsorption of the one or more target compounds (such as gaseous compounds) at or to the porous artificial melanin material. Optionally, said porous artificial melanin particles are characterized by an average size dimension or size characteristic selected from the range of 10 nm to 3 μm, optionally 10 nm to 2 μm, optionally 10 nm to 500 nm. Optionally in any method or device herein, the porous artificial melanin material is characterized by an average pore volume per mass of material selected from the range of 0.1 to 1 cm³/g or optionally any subrange or point therebetween inclusively. Optionally in any method or device herein, pores of the porous artificial melanin material are characterized by a distribution of pore sizes over the range of 0.5 nm to 50 nm. Optionally in any method or device herein, the pores of the porous artificial melanin material are characterized by at least one average size dimension, such as a cross sectional dimension and/or longitudinal dimension, selected from the range of 0.5 nm to 25 nm.

Aspects of the invention include a method of capturing one or more target compounds using a capture device, the method comprising: exposing the gas-capture device to an environment comprising the one or more target compounds; wherein the device comprises: a porous artificial melanin material comprising: one or more melanin oligomers, polymers, or a combination thereof; wherein the one or more melanin oligomers, polymers, or a combination thereof comprise a plurality of covalently-bonded melanin base units; wherein the one or more melanin oligomers, polymers, or a combination thereof are arranged to form an internal structure having a plurality of pores; wherein the porous artificial melanin material is characterized by a pore volume per mass of material greater than or equal to 0.1 cm³/g and wherein at least a portion of said pores have at least one size dimension greater than or equal to 0.5 nm; and capturing the one or more target compounds via an interaction between the porous artificial melanin material and the one or more target compounds. Optionally in any of the methods and devices disclosed herein, the one or more target compounds are one or more gaseous compounds and/or one or more solvated or aqueous compounds; and wherein the environment is a gaseous and/or a liquid environment. Optionally in any of the methods and devices disclosed herein, the one or more target compounds are one or more solvated or aqueous compounds, and the environment is a liquid environment. Optionally in any of the methods and devices disclosed herein, the one or more target compounds are one or more gaseous compounds, the environment is a gaseous environment, and the capture device is a gas-capture device. Optionally in any of the methods and devices disclosed herein, a temperature of the environment (such as gaseous environment) and/or the one or more target compounds is selected from the range of about 270 K to about 325 K, optionally about 270 K to about 400 K, optionally about 270 K to 450 K, or any temperature or range thereof therebetween inclusively. Optionally in any of the methods and devices disclosed herein, the porous artificial melanin material comprises a plurality of the melanin oligomers, polymers, or a combination thereof. Optionally in any of the methods and devices disclosed herein, the porous artificial melanin material comprises a plurality of the melanin oligomers and/or polymers. Optionally in any of the methods and devices disclosed herein, the interaction between the porous artificial melanin material and the one or more target compounds comprises adsorption. Optionally, interaction between the porous artificial melanin material and the one or more target compounds comprises adsorption of the one or more target compounds (such as gaseous compounds) at or to the porous artificial melanin material. Optionally in any of the methods and devices disclosed herein, the interaction between the porous artificial melanin material and the one or more target compounds is adsorption of the one or more target compounds (such as gaseous compounds) at or to the porous artificial melanin material.

Aspects of the invention include, a method of capturing one or more gaseous compounds using a gas-capture device, exposing the gas-capture device to a gaseous environment comprising the one or more gaseous compounds; wherein the device comprises: a porous artificial melanin material comprising: one or more melanin oligomers, polymers, or a combination thereof; wherein the one or more melanin oligomers, polymers, or a combination thereof comprise a plurality of covalently-bonded melanin base units; wherein the one or more melanin oligomers, polymers, or a combination thereof are arranged to form an internal structure having a plurality of pores; wherein the porous artificial melanin material is characterized by a pore volume per mass of material greater than or equal to 0.1 cm³/g and wherein at least a portion of said pores have at least one size dimension greater than or equal to 0.5 nm; and capturing the one or more gaseous compounds via an interaction between the porous artificial melanin material and the one or more gaseous compounds. Optionally in any of the methods and devices disclosed herein, the porous artificial melanin material comprises a plurality of the melanin oligomers, polymers, or a combination thereof. Optionally in any of the methods and devices disclosed herein, the porous artificial melanin material comprises a plurality of the melanin oligomers and/or polymers. Optionally in any of the methods and devices disclosed herein, the interaction between the porous artificial melanin material and the one or more target compounds comprises adsorption. Optionally, interaction between the porous artificial melanin material and the one or more target compounds comprises adsorption of the one or more target compounds (such as gaseous compounds) at or to the porous artificial melanin material. Optionally in any of the methods and devices disclosed herein, the interaction between the porous artificial melanin material and the one or more target compounds is adsorption of the one or more target compounds (such as gaseous compounds) at or to the porous artificial melanin material.

Optionally in any of the methods and devices disclosed herein, the step of capturing is characterized by an uptake of the one or more target compounds (such as gaseous compounds) selected from the range of at least 1.5 cm³/g at a temperature selected from the range of about 270 K to about 325 K and at a pressure of substantially 1 bar. Optionally in any of the methods and devices disclosed herein, the step of capturing is characterized by an uptake of the one or more target compounds (such as gaseous compounds) selected from the range of at least 1.5 cm³/g at a temperature of about 273 K, about 288 K, or about 298 K and at a pressure of substantially 1 bar. Optionally in any of the methods and devices disclosed herein, the step of capturing is characterized by: an uptake of CO₂ gas selected from the range of 11 cm³/g to 51 cm³/g (or any value or range thereof therebetween inclusively), an uptake of CH₄ gas selected from the range of 0.2 cm³/g to 14 cm³/g (or any value or range thereof therebetween inclusively), an uptake of H₂ gas selected from the range of 0.2 cm³/g to 13 cm³/g (or any value or range thereof therebetween inclusively), an uptake of N₂ gas selected from the range of 99 cm³/g to 1001 cm³/g (or any value or range thereof therebetween inclusively), and/or an uptake of NH₃ gas selected from the range of 179 cm³/g to 379 cm³/g (or any value or range thereof therebetween inclusively), at a temperature of about 273 K, about 288 K, or about 298 K and at a pressure of substantially 1 bar (preferably, under conditions described in Examples 1A-1B or 2A-2B). Optionally in any of the methods and devices disclosed herein, the step of capturing is characterized by: an uptake of CO₂ gas selected from the range of 11 cm³/g to 51 cm³/g (or any value or range thereof therebetween inclusively), an uptake of CH₄ gas selected from the range of 0.2 cm³/g to 14 cm³/g (or any value or range thereof therebetween inclusively), an uptake of H₂ gas selected from the range of 0.2 cm³/g to 13 cm³/g (or any value or range thereof therebetween inclusively), an uptake of N₂ gas selected from the range of 99 cm³/g to 1001 cm³/g (or any value or range thereof therebetween inclusively), and/or an uptake of NH₃ gas selected from the range of 179 cm³/g to 379 cm³/g (or any value or range thereof therebetween inclusively), at a temperature selected from the range of about 270 K to about 325 K and at a pressure of substantially 1 bar (preferably, under conditions described in Examples 1A-1B or 2A-2B). Optionally in any of the methods and devices disclosed herein, the step of capturing is characterized by: a saturation loading of aqueous diazinon selected from the range of 14 g/g to 125 g/g (or any value or range thereof therebetween inclusively), an affinity of aqueous diazinon selected from the range of 9000 M⁻¹ to 92000 M⁻¹ (or any value or range thereof therebetween inclusively), a saturation loading of aqueous paraoxon selected from the range of 4 g/g to 13 g/g (or any value or range thereof therebetween inclusively), and/or an affinity of aqueous paraoxon selected from the range of 3000 M⁻¹ to 12000 M⁻¹ (or any value or range thereof therebetween inclusively), at a temperature such as about 298 K (preferably, under conditions described in Examples 1A-1B or 2A-2B). Optionally in any of the methods and devices disclosed herein, the step of capturing is characterized by: a peak rate of permeation of aqueous dimethyl methylphosphonate through a nylon-cotton textile having the porous artificial melanin material attached thereto, the peak rate being less than or equal to 1 g/m²/h (preferably, under conditions described in Examples 1A-1B or 2A-2B). It is noted that the step of capturing, in any method disclosed herein, may be performed under conditions (e.g., different temperature and pressure) other than those claimed with the gas uptake, saturation, affinity, and permeation values. It is noted that the devices disclosed herein may be used under conditions (e.g., different temperature and pressure) other than those claimed with the gas uptake, saturation, affinity, and permeation values.

Optionally in any of the methods and devices disclosed herein, the step of capturing is characterized by a selectivity for CO₂ being greater than that for CH₄ by 50% to 200%. Optionally in any of the methods and devices disclosed herein, the one or more target compounds (such as gaseous compounds) are one or more greenhouse gas compounds, one or more toxic compounds, one or more nerve agents, one or more chemical warfare agents, one or more pesticides, one or more chemical irritants, one or more decontamination or sterilization agents, or any combination of these. Optionally in any of the methods and devices disclosed herein, the one or more target compounds (such as gaseous compounds) are selected from the group consisting of CH₄, NH₃, CO₂, N₂, H₂, NH₃, diazinon, paraoxon, dimethyl methylphosphonate, and any combination thereof. Optionally in any of the methods and devices disclosed herein, one or more gaseous compounds are characterized by a relative amount in the gaseous environment selected from the range of greater than 0 mol % to 100 mol %; and wherein the pressure of the gaseous environment is selected from the range of greater than 0 to substantially 1 bar.

Optionally in any of the methods and devices disclosed herein, the interaction between the porous artificial melanin material and the one or more target compounds comprises adsorption. Optionally, interaction between the porous artificial melanin material and the one or more target compounds comprises adsorption of the one or more target compounds (such as gaseous compounds) at or to the porous artificial melanin material. Optionally in any of the methods and devices disclosed herein, the interaction between the porous artificial melanin material and the one or more target compounds is adsorption of the one or more target compounds (such as gaseous compounds) at or to the porous artificial melanin material. Optionally in any of the methods and devices disclosed herein, the interaction between the porous artificial melanin material and the one or more target compounds comprises absorption, adsorption, or both. Optionally, the interaction between the porous artificial melanin material and the one or more target compounds comprises adsorption of the one or more target compounds (such as gaseous compounds) at or to the porous artificial melanin material at and/or on an internal portion or surface and/or external portion or surface of at least a portion of the porous artificial melanin material. Optionally, the interaction between the porous artificial melanin material and the one or more target compounds comprises adsorption of the one or more target compounds (such as gaseous compounds) at, to, and/or on an internal portion or surface and/or an external portion or surface of at least a portion of the porous artificial melanin material. Optionally, the interaction between the porous artificial melanin material and the one or more target compounds comprises adsorption of the one or more target compounds (such as gaseous compounds) at, to, and/or on an internal surface and/or an external surface of at least a portion of the porous artificial melanin material. Optionally, the interaction between the porous artificial melanin material and the one or more target compounds comprises adsorption of the one or more target compounds (such as gaseous compounds) at or to the porous artificial melanin material at and/or on one or more internal portions or surfaces and/or one or more external portions or surfaces of at least a portion of the porous artificial melanin material. Optionally, the interaction between the porous artificial melanin material and the one or more target compounds comprises adsorption of the one or more target compounds (such as gaseous compounds) at, to, and/or on one or more internal portions or surfaces and/or one or more external portions or surfaces of at least a portion of the porous artificial melanin material. Optionally, the interaction between the porous artificial melanin material and the one or more target compounds comprises adsorption of the one or more target compounds (such as gaseous compounds) at, to, and/or on one or more internal surfaces and/or one or more external surfaces of at least a portion of the porous artificial melanin material. Optionally, the interaction between the porous artificial melanin material and the one or more target compounds comprises adsorption of the one or more target compounds (such as gaseous compounds) at one or more internal portions and/or one or more external portions of the porous artificial melanin material. Optionally, the interaction between the porous artificial melanin material and the one or more target compounds comprises adsorption of the one or more target compounds (such as gaseous compounds) at an internal portion and/or an external portion of the porous artificial melanin material. For example, optionally, one or more target compounds can adsorb at an external surface of a porous artificial melanin particle and the one or more target compounds can flow, diffuse, or otherwise transfer into pores of the porous artificial melanin particle and adsorb at an internal surface of the particle.

Optionally in any of the methods and devices disclosed herein, the porous artificial melanin material is a coating on or otherwise incorporated in a textile material; and wherein the textile material comprising the porous artificial melanin material is characterized by a water vapor transport rate within 20% of a water vapor transport rate of the same or equivalent textile material free of the porous artificial melanin material. Optionally in any of the methods and devices disclosed herein, the porous artificial melanin material is on a substrate, the substrate optionally being gas-permeable. Optionally in any of the methods and devices disclosed herein, the device is an article of clothing, is incorporated with an article of clothing, and/or comprises an article of clothing. Optionally in any of the methods and devices disclosed herein, the device is a textile material, is incorporated with a textile material, and/or comprises a textile material. Optionally in any of the methods and devices disclosed herein, the device is a personal protective equipment, is incorporated with a personal protective equipment, and/or comprises a personal protective equipment. Optionally in any of the methods and devices disclosed herein, the porous artificial melanin material is characterized by an average pore volume per mass of material selected from the range of 0.3 cm³/g to 0.7 cm³/g. Optionally in any of the methods and devices disclosed herein, the porous artificial melanin material is characterized by a Brunauer-Emmett-Teller area selected from the range of 100 m²/g to 1000 m²/g. Optionally in any of the methods and devices disclosed herein, the porous artificial melanin material is a microporous material or a mesoporous material. Optionally in any of the methods and devices disclosed herein: (i) the pores of said porous artificial melanin material include micropores each having at least one average size dimension selected from the range of 0.5 nm to 2 nm; and/or (ii) the pores of said porous artificial melanin material include mesopores each having at least one average size dimension selected from the range of 2 nm to 200 nm. Optionally in any of the methods and devices disclosed herein, the pores are characterized by a distribution of pore size dimensions over the range of 0.5 nm to 200 nm. Optionally in any of the methods and devices disclosed herein, said porous artificial melanin material is an at least partially non-crystalline material or amorphous material. Optionally in any of the methods and devices disclosed herein, said pores of said internal structure are formed by close packing and/or self-assembly of said one or more melanin oligomers, polymers, or a combination thereof of said porous artificial melanin material. Optionally in any of the methods and devices disclosed herein, said pores of said internal structure are formed by templating of said one or more melanin oligomers, polymers, or a combination thereof of said porous artificial melanin material. Optionally in any of the methods and devices disclosed herein, the porous artificial melanin material is at least partially in the form of porous artificial melanin particles. Optionally in any of the methods and devices disclosed herein, said porous artificial melanin particles are characterized by an average size dimension (e.g., average diameter) selected from the range of 10 nm to 3 μm, optionally 10 nm to 2.5 μm, optionally 10 nm to 2 μm, optionally 10 nm to 1.5 μm, optionally 10 nm to 1 μm, optionally 10 nm to 500 nm, optionally 20 nm to 500 nm, optionally 30 nm to 500 nm, optionally 40 nm to 500 nm, optionally 50 nm to 300 nm, optionally 10 nm to 300 nm, optionally 40 nm to 300 nm, optionally 50 nm to 100 nm, optionally 50 nm to 200 nm. Optionally in any of the methods and devices disclosed herein, said porous artificial melanin particles are one or more of solid particles, hollow particles, lacey particles, and any combinations of these. Optionally in any of the methods and devices disclosed herein, said porous artificial melanin particles are purified or isolated. Optionally in any of the methods and devices disclosed herein, the porous artificial melanin material porous artificial melanin particles is provided as a film or a coating; or wherein the porous artificial melanin particles are provided as a film or a coating.

Optionally in any of the methods and devices disclosed herein, said melanin base units are one or more substituted or unsubstituted catechol-based monomers, substituted or unsubstituted polyol-based monomers, substituted or unsubstituted phenol-based monomers, substituted or unsubstituted indole-based monomers, substituted or unsubstituted benzothiazine-based monomers, substituted or unsubstituted benzothiazole-based monomers, substituted or unsubstituted dopamine-based monomers or any combination of these. Optionally in any of the methods and devices disclosed herein, the porous artificial melanin material comprises allomelanin. Optionally in any of the methods and devices disclosed herein, at least a portion of said melanin base units each independently comprises substituted or unsubstituted naphthalene, dihydroxynaphthalene, or 1,8-dihydroxynaphthalene. Optionally in any of the methods and devices disclosed herein, each melanin oligomer is free of nitrogen. Optionally in any of the methods and devices disclosed herein, the porous artificial melanin material comprises polydopamine and allomelanin.

Optionally in any of the methods and devices disclosed herein, the porous artificial melanin material comprises polydopamine. Optionally in any of the methods and devices disclosed herein, at least a portion of said melanin base units each independently comprises a substituted or unsubstituted dopamine monomer. Optionally in any of the methods and devices disclosed herein, at least a portion of said melanin base units each independently are selected from the group consisting of substituted or unsubstituted dihydroxydopamine monomers, substituted or unsubstituted dioxydopamine monomers, substituted or unsubstituted dihydroxynaphthalene monomers, substituted or unsubstituted dioxydopamine monomers and any combination of these. Optionally in any of the methods and devices disclosed herein, at least a portion of said melanin base units are selected from the group consisting of 3,4-dihydroxydopamine monomers, 3,4-dioxydopamine monomers, 3,4-dihydroxynaphthalene monomers, and any combination of these. Optionally in any of the methods and devices disclosed herein, the porous artificial melanin material comprises polydopamine and allomelanin.

Optionally in any of the methods and devices disclosed herein, the porous artificial melanin particles are characterized by a peak size selected from the range of 10 nm to 300 nm (optionally 50 nm to 300 nm, optionally 100 nm to 300 nm, optionally 50 nm to 100 nm, optionally 50 nm to 200 nm) and a polydispersity index less than or equal to 0.10. Optionally in any of the methods and devices disclosed herein, the porous artificial melanin particles exhibits structural color. Optionally in any of the methods and devices disclosed herein, the porous artificial melanin material comprises a plurality of the melanin oligomers; and at least 50% of the plurality of melanin oligomers are selected from the group consisting of monomers, dimers, trimers, tetramers, pentamers, and any combination thereof. Optionally in any of the methods and devices disclosed herein, the porous artificial melanin material comprises a plurality of the melanin oligomers; and 20% to 80% of the plurality of melanin oligomers are dimers having two covalently-bonded melanin base units. Optionally in any of the methods and devices disclosed herein, the porous artificial melanin material comprises a plurality of the melanin oligomers; each melanin oligomer is non-covalently associated with at least one other melanin oligomer or a melanin monomer via at least one of hydrogen bonding and π-π stacking of naphthalene rings; and the melanin monomer comprises the melanin base unit.

Aspects of the invention include a gas-capture device comprising a porous artificial melanin material comprising: one or more melanin oligomers, polymers, or a combination thereof; wherein the one or more melanin oligomers, polymers, or a combination thereof comprise a plurality of covalently-bonded melanin base units; wherein the one or more melanin oligomers, polymers, or a combination thereof are arranged to form an internal structure having a plurality of pores; wherein the porous artificial melanin material is characterized by a pore volume per mass of material greater than or equal to 0.1 cm³/g and wherein at least a portion of said pores have at least one size dimension greater than or equal to 0.5 nm. Optionally in any of the devices disclosed herein, the porous artificial melanin material is on a substrate. Optionally in any of the devices disclosed herein, the substrate is gas-permeable. Optionally in any of the devices disclosed herein, the substrate is a templating agent used during a process of making the porous artificial melanin material. Optionally in any of the devices disclosed herein: the device is an article of clothing, is incorporated with an article of clothing, and/or comprises an article of clothing; the device is a textile material, is incorporated with a textile material, and/or comprises a textile material; and/or the device is a personal protective equipment, is incorporated with a personal protective equipment, and/or comprises a personal protective equipment. Optionally in any of the methods and devices disclosed herein, the porous artificial melanin material comprises a plurality of the melanin oligomers, polymers, or a combination thereof. Optionally in any of the methods and devices disclosed herein, the porous artificial melanin material comprises a plurality of the melanin oligomers and/or polymers. Optionally in any devices disclosed herein, the device is exposed to an environment comprising the one or more target compounds and wherein the device is configured to capture the one or more target compounds via an interaction between the porous artificial melanin material and the one or more target compounds. Optionally in any devices disclosed herein, the interaction comprises adsorption. Optionally in any devices disclosed herein, the interaction comprises adsorption of the one or more target compounds at or to the porous artificial melanin material. Optionally in any devices disclosed herein, the interaction is adsorption of the one or more target compounds at or to the porous artificial melanin material. Optionally in any devices disclosed herein, the environment is a gaseous environment, the one or more target compounds are one or more gaseous compounds, and the capture device is a gas-capture device.

Aspects of the invention include a method of making a capture device (such as gas-capture device), the method comprising: depositing or incorporating a porous artificial melanin material onto or into a substrate; wherein the porous artificial melanin material comprises: one or more melanin oligomers, polymers, or a combination thereof; and wherein the one or more melanin oligomers, polymers, or a combination thereof comprise a plurality of covalently-bonded melanin base units; wherein the one or more melanin oligomers, polymers, or a combination thereof are arranged to form an internal structure having a plurality of pores; wherein the porous artificial melanin material is characterized by a pore volume per mass of material greater than or equal to 0.1 cm³/g and wherein at least a portion of said pores have at least one size dimension greater than or equal to 0.5 nm. Optionally, the substrate is gas-permeable. Optionally, the substrate is a textile material. Optionally, the step of depositing comprises: polymerizing artificial melanin precursors in a first aqueous solution, thereby generating a first intermediate melanin product comprising one or more melanin oligomers and/or polymers; wherein the step of polymerizing comprises oxidative oligomerization or polymerization; contacting the first intermediate melanin product with a nonaqueous solvent, thereby resulting in partial dissolution or material removal so as to generate a second intermediate melanin product; and contacting second intermediate melanin product with water or a second aqueous solution, thereby resulting in said porous artificial melanin material. Optionally, the step of depositing comprises: combining artificial melanin precursors and a templating agent in a first aqueous solution; and polymerizing said artificial melanin precursors in the presence of the templating agent, thereby generating an intermediate melanin product comprising one or more melanin oligomers and/or polymers incorporated with the templating agent, thereby resulting in said porous artificial melanin material. Optionally, the method further comprising the step of removing the templating agent. Optionally, the substrate comprises the templating agent. Optionally in any of the methods and devices disclosed herein, the porous artificial melanin material comprises a plurality of the melanin oligomers, polymers, or a combination thereof. Optionally in any of the methods and devices disclosed herein, the porous artificial melanin material comprises a plurality of the melanin oligomers and/or polymers. Optionally in any devices disclosed herein, the device is exposed to an environment comprising the one or more target compounds and wherein the device is configured to capture the one or more target compounds via an interaction between the porous artificial melanin material and the one or more target compounds. Optionally in any devices disclosed herein, the interaction comprises adsorption. Optionally in any devices disclosed herein, the interaction comprises adsorption of the one or more target compounds at or to the porous artificial melanin material. Optionally in any devices disclosed herein, the interaction is adsorption of the one or more target compounds at or to the porous artificial melanin material. Optionally in any devices disclosed herein, the environment is a gaseous environment, the one or more target compounds are one or more gaseous compounds, and the capture device is a gas-capture device.

Optionally in any of the methods and devices disclosed herein, the porous artificial melanin material is polymerized for a time selected from the range of 0.5 hours to 24 hours. Optionally in any of the methods and devices disclosed herein, the porous artificial melanin material has a thickness and/or molecular weight corresponding a polymerization of said porous artificial melanin material for a time selected from the range of 0.5 hours to 24 hours.

Optionally, any of the methods disclosed herein comprises catalytically degrading of the one or more target compounds (such as gaseous compounds). Optionally in any of the methods and devices disclosed herein, the capture device (such as gas-capture device) comprises one or more catalytic materials. Optionally in any of the methods and devices disclosed herein, the capture device (such as gas-capture device) comprises one or more catalytic materials for catalytic degradation of the one or more target compounds (such as gaseous compounds). Optionally, any of the methods disclosed herein comprises: removing or capturing CO₂ from the gaseous environment, removing or capturing toxic gas(es) from air, and/or storing of one or more useful target compounds (such as gaseous compounds), such as for transport and rapid delivery in a solid state device. Optionally in any of the methods and devices disclosed herein, the device is in line with a gas stream and/or is within a pipe or other gas conduit, such as a gas exhaust conduit.

Optionally in any of the methods and devices disclosed herein, the one or more target compounds are one or more gaseous compounds and/or one or more solvated or aqueous compounds; and wherein the environment is a gaseous and/or a liquid environment. Optionally in any of the methods and devices disclosed herein, the one or more target compounds are one or more solvated or aqueous compounds, and the environment is a liquid environment. Optionally in any of the methods and devices disclosed herein, the one or more target compounds are one or more gaseous compounds, the environment is a gaseous environment, and the capture device is a gas-capture device.

Various potentially useful descriptions, background information, applications of embodiments herein, terminology (to the extent not inconsistent with the terms as defined herein), mechanisms, compositions, methods (e.g., including synthetic schemes or procedures), definitions, and/or other embodiments may be found in the following patent applications, each of which is incorporated herein by reference in its entirety to the extent not inconsistent herewith: (1) International Application No. PCT/US2020/039769 (International Patent Publication No. WO2021021350A2; X. Zhou, et al.; “Artificial melanin nanoparticles and methods including porous melanin materials”); and (2) International Application No. PCT/US2017/041596 (International Patent Publication No. WO 2018013609A8; N. C. Gianneschi, et al.; “Synthetic melanin nanoparticles and uses thereof”).

Optionally in any of the methods and devices disclosed herein, the porous artificial melanin material comprises artificial melanin nanoparticles, wherein: each melanin nanoparticle of the plurality of artificial melanin nanoparticles comprises a plurality of melanin oligomers; each melanin oligomer comprises a plurality of covalently-bonded melanin base units; and each melanin base unit comprises substituted or unsubstituted naphthalene.

Optionally in any of the methods and devices disclosed herein, the porous artificial melanin material comprises artificial melanin nanoparticles, wherein: each melanin nanoparticle of the plurality of artificial melanin nanoparticles comprises a plurality of melanin oligomers; each melanin oligomer comprises a plurality of covalently-bonded melanin base units; and the plurality of artificial melanin nanoparticles are characterized by a peak size selected from the range of 100 nm to 300 nm and a polydispersity index selected to be less than or equal to 0.10, and optionally for some embodiments a polydispersity index selected to be less than or equal to 0.3 and optionally for some embodiments a polydispersity index selected to be less than or equal to 0.2. Optionally, the plurality of artificial melanin nanoparticles are characterized by a peak size selected from the range of 100 nm to 200 nm and a polydispersity index selected to be less than or equal to 0.10.

Optionally in any of the methods and devices disclosed herein, the porous artificial melanin material comprises artificial melanin nanoparticles, wherein: each melanin nanoparticle of the plurality of artificial melanin nanoparticles comprises a plurality of melanin oligomers; each melanin oligomer comprises a plurality of covalently-bonded melanin base units; and the plurality of artificial melanin nanoparticles exhibits structural color. Optionally, the plurality of artificial melanin nanoparticles exhibits structural color when the plurality of artificial melanin nanoparticles are in the form of a layer or film, such as a monolayer or thicker, or in the form of a pellet, such as a free-standing pellet, for example. Optionally, the plurality of artificial melanin nanoparticles exhibits structural color when the plurality of artificial melanin nanoparticles are in the form of a packed and/or ordered structure. Optionally, the plurality of artificial melanin nanoparticles exhibits structural color when the plurality of artificial melanin nanoparticles are dried or otherwise deposited onto a substrate.

Optionally in any of the methods and devices disclosed herein, the porous artificial melanin material comprises artificial melanin nanoparticles, wherein: each melanin nanoparticle of the plurality of artificial melanin nanoparticles comprises a plurality of melanin oligomers; each melanin oligomer comprises a plurality of covalently-bonded melanin base units; and at least 50% of the plurality of melanin oligomers are selected from the group consisting of monomers, dimers, trimers, tetramers, pentamers, and any combination thereof. The monomers, dimers, trimers, tetramers, and pentamers have one, two, three, four, and five melanin base units, respectively. Optionally, at least 30%, optionally at least 40%, optionally at least 50%, optionally at least 60%, optionally at least 80%, of the plurality of melanin oligomers are selected from the group consisting of dimers, trimers, tetramers, pentamers, and any combination thereof, and the artificial melanin nanoparticles further comprise monomers. Optionally, at least 50% of the plurality of melanin oligomers are selected from the group consisting of dimers, trimers, tetramers, pentamers, and any combination thereof, and the artificial melanin nanoparticles further comprise monomers. Optionally, at least 30%, optionally at least 40%, optionally at least 50%, optionally at least 60%, optionally at least 80%, of the plurality of melanin oligomers are selected from the group consisting of dimers, trimers, tetramers, and any combination thereof, and the artificial melanin nanoparticles further comprise monomers. Optionally, at least 50% of the plurality of melanin oligomers are selected from the group consisting of dimers, trimers, tetramers, and any combination thereof, and the artificial melanin nanoparticles further comprise monomers. Optionally, at least 30% by mass, optionally at least 40% by mass, optionally at least 50% by mass, optionally at least 60% by mass, optionally at least 80% by mass, of each or of each of at least 80% of the plurality of artificial melanin nanoparticles is the monomers (each monomer having only one melanin base unit) and/or the melanin oligomers selected from the group consisting of dimers, trimers, tetramers, pentamers and any combination thereof. Optionally, at least 30% by mass, optionally at least 40% by mass, optionally at least 50% by mass, optionally at least 60% by mass, optionally at least 80% by mass, of each or of each of at least 80% of the plurality of artificial melanin nanoparticles is the monomers (each monomer having only one melanin base unit) and the melanin oligomers selected from the group consisting of dimers, trimers, tetramers, pentamers and any combination thereof. Optionally, at least 30% by mass, optionally at least 40% by mass, optionally at least 50% by mass, optionally at least 60% by mass, optionally at least 80% by mass, of each or of each of at least 80% of the plurality of artificial melanin nanoparticles is the monomers (each monomer having only one melanin base unit) and/or the melanin oligomers selected from the group consisting of dimers, trimers, tetramers, and any combination thereof. Optionally, at least 30% by mass, optionally at least 40% by mass, optionally at least 50% by mass, optionally at least 60% by mass, optionally at least 80% by mass, of each or of each of at least 80% of the plurality of artificial melanin nanoparticles is the monomers (each monomer having only one melanin base unit) and the melanin oligomers selected from the group consisting of dimers, trimers, tetramers, and any combination thereof.

Optionally in any of the methods and devices disclosed herein, the porous artificial melanin material comprises artificial melanin nanoparticles, wherein: each melanin nanoparticle of the plurality of artificial melanin nanoparticles comprises a plurality of melanin oligomers; each melanin oligomer comprises a plurality of covalently-bonded melanin base units; and each nanoparticle has a sphericity of less than 0.90 and has a shape characterized as at least one of: walnut-like, a collapsed sphere or collapsed ellipsoid, and a sphere or ellipsoid having a plurality of indentations.

Optionally in any of the methods and devices disclosed herein, the porous artificial melanin material comprises artificial melanin nanoparticles, wherein: each melanin nanoparticle of the plurality of artificial melanin nanoparticles comprises a plurality of melanin oligomers; each melanin oligomer comprises a plurality of covalently-bonded melanin base units; and the plurality of artificial melanin nanoparticles are characterized by a radical scavenging activity greater than that of polydopamine nanoparticles having the same diameter as the plurality of artificial melanin nanoparticles under otherwise identical condition. Optionally, the plurality of artificial melanin nanoparticles are characterized by a radical scavenging activity at least 5%, optionally at least 10%, optionally at least 15%, optionally at least 20%, greater than that of polydopamine nanoparticles having the same diameter as the plurality of artificial melanin nanoparticles under otherwise identical condition.

Optionally in any method or device disclosed herein, each melanin base unit comprises substituted or unsubstituted naphthalene. Optionally in any method or device disclosed herein, each melanin base unit comprises dihydroxynaphthalene. Optionally in any method or device disclosed herein, each melanin base unit comprises 1,8-dihydroxynaphthalene. Optionally in any method or device disclosed herein, each melanin base unit comprises a structure having the formula FX1:

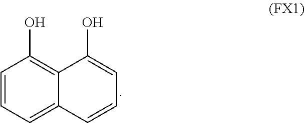 [SMILES: Oc1cccc2cccc(O)c12]

Optionally in any method or device disclosed herein, each melanin oligomer is free of nitrogen. Optionally in any method or device disclosed herein, at least 20%, optionally at least 40%, optionally at least 50%, optionally at least 80% of the plurality of melanin oligomers are dimers having two covalently-bonded melanin base units. Optionally in any method or device disclosed herein, 20% to 80% of the plurality of melanin oligomers are dimers having two covalently-bonded melanin base units. Optionally in any method or device disclosed herein, at least 50% of the plurality of melanin oligomers are selected from the group consisting of monomers, dimers, trimers, tetramers, pentamers, and any combination thereof. The monomers, dimers, trimers, tetramers, and pentamers have one, two, three, four, and five melanin base units, respectively. Optionally, at least 30%, optionally at least 40%, optionally at least 50%, optionally at least 60%, optionally at least 80%, of the plurality of melanin oligomers are selected from the group consisting of dimers, trimers, tetramers, pentamers, and any combination thereof, and the artificial melanin nanoparticles further comprise monomers. Optionally in any method or device disclosed herein, at least 40% of the plurality of melanin oligomers are selected from the group consisting of monomers, dimers, trimers, tetramers, pentamers, and any combination thereof. Optionally in any method or device disclosed herein, at least 20%, optionally at least 40%, optionally at least 80%, of the plurality of melanin oligomers are selected from the group consisting of monomers, dimers, and trimers, and any combination thereof. Optionally in any method or device disclosed herein, at least 50% of the plurality of melanin oligomers are selected from the group consisting of monomers, dimers, and trimers, and any combination thereof. Optionally in any method or device disclosed herein, at least 30% by mass, optionally at least 40% by mass, optionally at least 50% by mass, optionally at least 60% by mass, optionally at least 80% by mass, of each or of each of at least 80% of the plurality of artificial melanin nanoparticles is the monomers (each monomer having only one melanin base unit) and/or the melanin oligomers selected from the group consisting of dimers, trimers, tetramers, pentamers and any combination thereof. Optionally in any method or device disclosed herein, at least 30% by mass, optionally at least 40% by mass, optionally at least 50% by mass, optionally at least 60% by mass, optionally at least 80% by mass, of each or of each of at least 80% of the plurality of artificial melanin nanoparticles is the monomers (each monomer having only one melanin base unit) and the melanin oligomers selected from the group consisting of dimers, trimers, tetramers, pentamers and any combination thereof. Optionally in any method or device disclosed herein, at least 30% by mass, optionally at least 40% by mass, optionally at least 50% by mass, optionally at least 60% by mass, optionally at least 80% by mass, of each or of each of at least 80% of the plurality of artificial melanin nanoparticles is the monomers (each monomer having only one melanin base unit) and/or the melanin oligomers selected from the group consisting of dimers, trimers, tetramers, and any combination thereof. Optionally in any method or device disclosed herein, at least 30% by mass, optionally at least 40% by mass, optionally at least 50% by mass, optionally at least 60% by mass, optionally at least 80% by mass, of each or of each of at least 80% of the plurality of artificial melanin nanoparticles is the monomers (each monomer having only one melanin base unit) and the melanin oligomers selected from the group consisting of dimers, trimers, tetramers, and any combination thereof. Optionally in any method or device disclosed herein, each melanin oligomer is non-covalently associated with at least one other melanin oligomer via at least one of hydrogen bonding and π-π stacking of naphthalene rings. Optionally in any method or device disclosed herein, each melanin oligomer is non-covalently associated with at least one other melanin oligomer or melanin monomer via at least one of hydrogen bonding and π-π stacking of naphthalene rings.

Optionally in any method or device disclosed herein, each nanoparticle is characterized by a sphericity of greater than 0.90. Optionally in any method or device disclosed herein, at least 50%, optionally at least 75%, optionally at least 90%, optionally at least 95%, of the plurality of nanoparticles is characterized by a sphericity of greater than 0.90. Optionally in any method or device disclosed herein, each nanoparticle is characterized by a sphericity of greater than 0.99. Optionally in any method or device disclosed herein, at least 50%, optionally at least 75%, optionally at least 90%, optionally at least 95%, of the plurality of nanoparticles is characterized by a sphericity of greater than 0.95. Optionally in any method or device disclosed herein, each nanoparticle is characterized by a sphericity of greater than 0.99. Optionally in any method or device disclosed herein, at least 50%, optionally at least 75%, optionally at least 90%, optionally at least 95%, of the plurality of nanoparticles is characterized by a sphericity of greater than 0.99. Optionally in any method or device disclosed herein, the plurality nanoparticles is characterized by a polydispersity index less than or equal to 0.10. Optionally in any method or device disclosed herein, each nanoparticle has a size characteristics, such as diameter, selected from the range of 100±50 nm to 300±50 nm. Optionally in any method or device disclosed herein, each nanoparticle has a size characteristics, such as diameter, selected from the range of 100 nm to 300 nm. Optionally in any method or device disclosed herein, each nanoparticle has a size characteristics, such as diameter, selected from the range of 20 nm to 300±50 nm. Optionally in any method or device disclosed herein, the plurality of artificial melanin nanoparticles are characterized by a peak size selected from the range of 100 nm to 300 nm. Optionally in any method or device disclosed herein, the plurality of artificial melanin nanoparticles are characterized by a peak size selected from the range of 100 nm to 200 nm. Optionally in any method or device disclosed herein, the plurality of artificial melanin nanoparticles are characterized by a peak size selected from the range of 50 nm to 300 nm, optionally 50 nm to 200 nm.

Optionally in any method or device disclosed herein, each nanoparticle has a sphericity of less than 0.90 and has a shape characterized as at least one of: walnut-like, a collapsed sphere or collapsed ellipsoid, and a sphere or ellipsoid having a plurality of indentations. Optionally in any method or device disclosed herein, at least 50%, optionally at least 75%, optionally at least 90%, optionally at least 95%, of the plurality of nanoparticles has a sphericity of less than 0.90 and has a shape characterized as at least one of: walnut-like, a collapsed sphere or collapsed ellipsoid, and a sphere or ellipsoid having a plurality of indentations.

Optionally in any method or device disclosed herein, the plurality of artificial melanin nanoparticles are dispersed in a solvent or solvent mixture, thereby forming an artificial nanoparticle dispersion. Optionally in any method or device disclosed herein, the solvent or solvent mixture is at least 50% water, optionally at least 75% water, optionally at least 90% water, optionally at least 95%, by volume. Optionally in any method or device disclosed herein, the solvent or solvent mixture comprises an organic solvent. Optionally in any method or device disclosed herein, the solvent or solvent mixture comprises a buffer. Optionally in any method or device disclosed herein, the organic solvent comprises methanol, ethanol, acetonitrile, acetone dichloromethane, dimethylformamide, ethyl acetate, acetone, or any combination thereof. In some embodiments, artificial melanin nanoparticles are allowed to further age or further oxidize after synthesis. In some embodiments, aging or further oxidation of the nanoparticles affects the solubility or dispersibility, such as increasing stability in the presence of organic solvents. Optionally in any method or device disclosed herein, the nanoparticles in the artificial nanoparticle dispersion are characterized by a zeta potential or an average zeta potential selected from the range of −50 mV to −10 mV, optionally −40 to −20 mV, optionally in a solvent or solvent solution that is at least 95% water by volume. Optionally in any method or device disclosed herein, the nanoparticles in the artificial nanoparticle dispersion are stably dispersed without forming precipitates after at least 5 hours at a concentration selected from the range of 0.01 mg/ml to 5 mg/mL, optionally 0.01 mg/mL to 1 mg/mL, optionally within 20% of 0.1 mg/mL. Optionally in any method or device disclosed herein, the nanoparticles in the artificial nanoparticle dispersion are stably dispersed without forming precipitates after at least 12 hours at a concentration selected from the range of 0.01 mg/ml to 5 mg/mL, optionally 0.01 mg/mL to 1 mg/mL, optionally within 20% of 0.1 mg/mL.

Optionally in any method or device disclosed herein, the plurality of artificial melanin nanoparticles is internalized in one or more viable biological cells. Optionally in any method or device disclosed herein, the plurality of artificial melanin nanoparticles form a plurality of perinuclear caps in one or more viable biological cells. Optionally in any method or device disclosed herein, internalization of the plurality of nanoparticles in biological cells provides a cell viability of at least 80%, optionally at least 90%, with respect to water as a control. In some embodiments, aging or further oxidation of the nanoparticles affects the toxicity of the plurality of artificial melanin nanoparticles, such as decreasing their toxicity with aging or further oxidation.

Optionally in any method or device disclosed herein, the plurality of artificial melanin nanoparticles is characterized by a radical scavenging activity greater than that of polydopamine nanoparticles having the same diameter as the plurality of artificial melanin nanoparticles under otherwise identical condition. Optionally in any method or device disclosed herein, the plurality of artificial melanin nanoparticles is characterized by a radical scavenging activity at least 10%, optionally at least 15%, optionally at least 50%, greater than that of polydopamine nanoparticles having the same diameter as the plurality of artificial melanin nanoparticles under otherwise identical condition. Optionally in any method or device disclosed herein, the plurality of artificial melanin nanoparticles is characterized by a radical scavenging activity of at least 0.012 mol/g using an assay of 2,2-diphenyl-1-(2,4,6-trinitrophenyl) hydrazyl (DPPH).

Also disclosed herein are processes for forming any plurality of artificial melanin nanoparticles disclosed herein, including any one or any combination of embodiments disclosed herein. The processes for forming any plurality of artificial melanin nanoparticles include polymerizing a plurality of melanin monomers via oxidative oligomerization, each melanin monomer comprising the melanin base unit.

Also disclosed herein are methods for making any plurality of artificial melanin nanoparticles disclosed herein, including any one or any combination of embodiments disclosed herein. The methods for making a plurality of artificial melanin nanoparticles include polymerizing a plurality of melanin monomers via oxidative oligomerization, each melanin monomer comprising the melanin base unit. Optionally in any method or device disclosed herein, the step of polymerizing comprising reacting the plurality of melanin monomers with one or more oxidation agents. Optionally in any method or device disclosed herein, the step of polymerizing comprising dissolving the plurality of melanin monomers and the one or more oxidation agents in a solvent or solvent mixture. Optionally in any method or device disclosed herein, the solvent or solvent mixture comprises water. The solvent or solvent mixture optionally comprises water and an organic solvent and/or buffer. Optionally in any method or device disclosed herein, the step of dissolving comprises rapidly injecting the one or more oxidation agents into a stirred monomer solution comprising the plurality of melanin monomers in the solvent or solvent mixture. Optionally in any method or device disclosed herein, the step of reacting comprises the plurality of melanin monomers and the one or more oxidation agents being reacted in the solvent or solvent mixture for a time selected from the range of 1 to 24 hours. Optionally in any method or device disclosed herein, the method comprises isolating the polymerized artificial melanin nanoparticles. Optionally in any method or device disclosed herein, the step of dissolving is characterized by a molar ratio of one or more oxidation agents to melanin monomers selected from the range of 0.08 to 1.5, optionally 0.2 to 1.5, optionally 0.08 to 0.6, optionally 0.1 to 1, optionally 0.1 to 2, optionally 0.05 to 2.5, optionally 0.05 to 5. The molar ratio of one or more oxidation agents to melanin monomers may be selected to be different depending on the particular selected oxidation agent(s) and melanin monomers. Optionally in any method or device disclosed herein, each nanoparticle is characterized by a sphericity of greater or equal to than 0.90 when the molar ratio of one or more oxidation agents to melanin monomers is less than 1. Optionally in any method or device disclosed herein, each nanoparticle is characterized by a sphericity of less than 0.90 when the molar ratio of one or more oxidation agents to melanin monomers is greater than or equal to 1. The characteristics, such as shape, of the artificial melanin nanoparticles may vary and be controlled by selected of particular oxidation agent(s) and melanin monomers, as well as by selection of the molar ratio of one or more oxidation agents to melanin monomers. For example, to obtain a particle with a particular sphericity, different molar ratios of one or more oxidation agents to melanin monomers may be selected for different oxidation agent(s). Optionally in any method or device disclosed herein, the step of dissolving further comprises dissolving a buffer solution in the solvent or solvent mixture. Optionally in any method or device disclosed herein, the one or more oxidation agents is a salt, optionally an inorganic salt, which is soluble in the solvent or solvent mixture. Optionally in any method or device disclosed herein, the one or more oxidation agents selected from the group consisting of NaIO₄, KMnO₄, a persulfate salt, ammonium persulfate, and any combination thereof. Optionally in any method or device disclosed herein, the one or more oxidation agents is NaIO₄ or KMnO₄. Optionally in any method or device disclosed herein, each melanin monomer comprises substituted or unsubstituted naphthalene. Optionally in any method or device disclosed herein, each melanin monomer comprises dihydroxynaphthalene. Optionally in any method or device disclosed herein, each melanin monomer comprises 1,8-dihydroxynaphthalene. Optionally in any method or device disclosed herein, each melanin monomer is free of nitrogen. Optionally in any method or device disclosed herein, the method does not comprise deriving or extracting the at least one of the plurality of melanin base units, the plurality of melanin oligomers, and the plurality of artificial melanin nanoparticles from a biological source or a living organism.

Aspects disclosed herein may include, the invention provides compositions comprising porous melanin materials. Optionally in any method or device disclosed herein, a porous artificial melanin material comprises: (i) one or more melanin oligomers, polymers or a combination thereof; wherein the one or more melanin oligomers and/or polymers comprise a plurality of covalently-bonded melanin base units; wherein the melanin oligomers and/or polymers are arranged to form an internal structure having a plurality of pores; wherein the porous artificial melanin material is characterized by a pore volume per mass of material greater than or equal to 0.1 cm³/g, optionally greater than or equal to 0.3 cm³/g, and wherein at least a portion of the pores have at least one size dimension, such as cross section dimension or longitudinal dimension, greater than or equal to 0.5 nm.

The porous melanin materials may include a range of physical, chemical and structural characteristics, such as relating to porosity, chemical composition, phase and physical state or condition (e.g., particle, film, dispersion, etc.).

Optionally in any method or device disclosed herein, the porous artificial melanin material is characterized by an average pore volume per mass of material selected from the range of 0.1 cm³/g to 0.6 cm³/g, optionally 0.1 to 1 cm³/g (optionally any subrange or point therebetween inclusively), optionally 0.3 cm³/g to 1 cm³/g, optionally 0.3 cm³/g to 0.6 cm³/g. Optionally in any method or device disclosed herein, the porous artificial melanin material is a microporous material or a mesoporous material. Optionally in any method or device disclosed herein, the pores of the porous artificial melanin material include micropores each having at least one average size dimension, such as a cross sectional dimension and/or longitudinal dimension, selected from the range of 0.5 nm to 2.5 nm, and optionally 0.5 nm to 1.3 nm. Optionally in any method or device disclosed herein, the pores of the porous artificial melanin material include mesopores each having at least one average size dimension, such as a cross sectional dimension and/or longitudinal dimension, selected from the range of 2 nm to 50 nm, and optionally 2 nm to 25 nm. Optionally in any method or device disclosed herein, the pores are characterized by a distribution of pore sizes over the range of 0.5 nm to 50 nm.

In some embodiments, for example, the pores of the internal structure are formed by organization of the melanin oligomers and/or polymers of the porous artificial melanin material. In some embodiments, for example, the pores of the internal structure are formed by close packing and/or self-assembly of the melanin oligomers and/or polymers of the porous artificial melanin material. In some embodiments, for example, the pores of the internal structure are formed by templating of the melanin oligomers and/or polymers of the porous artificial melanin material.

In some embodiments, for example, the pores are not uniformly distributed throughout the porous melanin materials, for example, because the material is non-crystalline and/or amorphous. Optionally in any method or device disclosed herein, the porous artificial melanin material is an at least partially non-crystalline material and/or an amorphous material. In some embodiments, for example, the pores of the internal structure are randomly distributed. In some embodiments, for example, the pores of the internal structure are provided in repeating structures the amorphous porous artificial melanin material provided in an at least partial non-crystalline or amorphous state.

In some embodiments, for example, the pores of porous artificial melanin material include one or more pore types selected from the group of cylindrical pores, channel-like pores, slit-shape pores, ink-bottle pores and any combination of these.

The porous artificial melanin material may be provided in a range of physical states and or as components of materials or systems. In some embodiments, for example, the porous artificial melanin material comprise porous melanin particles, such as nanoparticles. In some embodiments, for example, the porous melanin particles are characterized by an average size selected from the range of 20 nm to 500 nm in diameter. In some embodiments, for example, the porous melanin particles are one or more of solid particles, hollow particles, lacey particles, and any combinations of these. In an embodiment, the porous artificial melanin material is a solid porous artificial melanin particle, for example, with pores distributed throughout the particle, for example uniformly distributed or randomly distributed, and without a hollow configuration. In an embodiment, the porous artificial melanin material is a lacey porous artificial melanin particle, for example, with pores distributed throughout the particle, for example uniformly distributed or randomly distributed, and without a hollow configuration. In an embodiment, the porous artificial melanin material is not a hollow particle, for example is not a hollow sphere particle.

In an embodiment, the porous melanin particles are purified or isolated. In an embodiment, the porous melanin particles are provided as a film or a coating. In an embodiment, the porous melanin particles are provided as a dispersion comprising the porous melanin particles dispersed in a continuous phase.

The porous artificial melanin material may encompass a range of chemical compositions. In some embodiments, for example, the melanin base units are one or more substituted or unsubstituted catechol-based monomers, substituted or unsubstituted polyol-based monomers, substituted or unsubstituted phenol-based monomers, substituted or unsubstituted indole-based monomers, substituted or unsubstituted benzothiazine-based monomers, substituted or unsubstituted benzothiazole-based monomers, substituted or unsubstituted dopamine-based monomers or any combination of these.

In some embodiments, for example, the porous artificial melanin material comprises allomelanin. In some embodiments, for example, at least a portion of, and optionally all of, the melanin base units each independently comprises substituted or unsubstituted naphthalene. In some embodiments, for example, at least a portion of, and optionally all of, the melanin base units each independently comprises dihydroxynaphthalene. In some embodiments, for example, at least a portion of, and optionally all of, the melanin base units each independently comprises 1,8-dihydroxynaphthalene. In some embodiments, for example, at least a portion of, and optionally all of, the melanin base units each independently comprises a structure having the formula FX1:

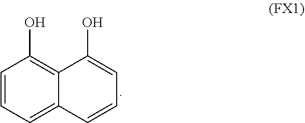 [SMILES: Oc1cccc2cccc(O)c12]

In some embodiments, for example, each melanin oligomer is free of nitrogen.

In some embodiments, for example, the porous artificial melanin material comprises polydopamine. In some embodiments, for example, at least a portion of, and optionally all of, the melanin base units each independently comprises a substituted or unsubstituted dopamine monomer. In some embodiments, for example, at least a portion of, and optionally all of, the melanin base units each independently are selected from the group consisting of substituted or unsubstituted dihydroxydopamine monomers, substituted or unsubstituted dioxydopamine monomers, substituted or unsubstituted dihydroxynaphthalene monomers, substituted or unsubstituted dioxydopamine monomers and any combination of these. In some embodiments, for example, at least a portion of, and optionally all of, the melanin base units each independently are selected from the group consisting of 3,4-dihydroxydopamine monomers, 3,4-dioxydopamine monomers, 3,4-dihydroxynaphthalene monomers, and any combination of these.

Aspects disclosed herein may include, methods for making porous artificial melanin materials are providing including etching, dissolution, incubating and templating synthetic approaches.

Optionally in any method or device disclosed herein, a method of making a porous artificial melanin material employing a dissolution or etching approach comprises: (i) polymerizing artificial melanin precursors in a first aqueous solution, thereby generating a first intermediate melanin product comprising one or more melanin oligomers and/or polymers; (ii) contacting the first intermediate melanin product with a nonaqueous solvent, thereby resulting in partial dissolution or materials removal so as to generate a second intermediate melanin product; and (iii) contacting second intermediate melanin product with water or a second aqueous solution, thereby resulting in the porous artificial melanin material.

Optionally in any method or device disclosed herein, the step of polymerizing the artificial melanin precursors in a first aqueous solution comprises oxidative oligomerization or polymerization. Optionally in any method or device disclosed herein, the artificial melanin precursors are provided in the first aqueous solution at a concentration selected from the range of 0.1 mg/mL to 10 mg/mL. Optionally in any method or device disclosed herein, the step of polymerizing the artificial melanin precursors in the first aqueous solution is carried out at a temperature selected from the range of 15° C. to 30° C. Optionally in any method or device disclosed herein, the step of polymerizing the artificial melanin precursors in the first aqueous solution is carried out for a time duration selected over the range of 4 hours to 24 hours. Optionally in any method or device disclosed herein, the step of contacting the first intermediate melanin product with the nonaqueous solvent comprises removing the first intermediate melanin product from contact with at least a portion of, and optionally all of, the first aqueous solution and contacting the removed first intermediate melanin product with the nonaqueous solvent.

Optionally in any method or device disclosed herein, the method further comprises removing water from the first intermediate melanin product prior to the step of contacting the first intermediate melanin product with the nonaqueous solvent. Optionally in any method or device disclosed herein, the nonaqueous solvent is one or more of an alcohol, hydrocarbon, organic solvent or any combination of these. Optionally in any method or device disclosed herein, the one or more alcohol is methanol, ethanol, propyl alcohol, butyl alcohol or any combination of these. Optionally in any method or device disclosed herein, the nonaqueous solvent is acetonitrile, acetic acid, acetone or any combination of these. Optionally in any method or device disclosed herein, the step of contacting the first intermediate melanin product with the nonaqueous solvent is carried out at a temperature selected from the range of 15° C. to 30° C. Optionally in any method or device disclosed herein, the step of contacting the first intermediate melanin product with the nonaqueous solvent is carried out for a time duration selected over the range of 1 second to 1 week.

Optionally in any method or device disclosed herein, the step of contacting the second intermediate melanin product with water or a second aqueous solution comprises diluting the second intermediate melanin product with the water or second aqueous solution. Optionally in any method or device disclosed herein, the step of contacting second intermediate melanin product with water or a second aqueous solution comprises dialyzing the second intermediate melanin product into the water or second aqueous solution.

Optionally in any method or device disclosed herein, the artificial melanin precursors are one or more substituted or unsubstituted catechol-based monomers, substituted or unsubstituted polyol-based monomers, substituted or unsubstituted phenol-based monomers, substituted or unsubstituted indole-based monomers, substituted or unsubstituted benzothiazine-based monomers, substituted or unsubstituted benzothiazole-based monomers, substituted or unsubstituted dopamine-based monomers or any combination of these.

Optionally in any method or device disclosed herein, at least a portion of, and optionally all of, the artificial melanin precursors each independently comprises substituted or unsubstituted naphthalene. Optionally in any method or device disclosed herein, at least a portion of, and optionally all of, the artificial melanin precursors each independently comprises dihydroxynaphthalene. Optionally in any method or device disclosed herein, at least a portion of, and optionally all of, the artificial melanin precursors each independently comprises 1,8-dihydroxynaphthalene. Optionally in any method or device disclosed herein, at least a portion of, and optionally all of, the artificial melanin precursors each independently comprises a structure having the formula FX1:

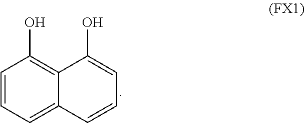 [SMILES: Oc1cccc2cccc(O)c12]

Optionally in any method or device disclosed herein, each melanin oligomer and/or polymer is free of nitrogen. Optionally in any method or device disclosed herein, the porous artificial melanin material comprises allomelanin.

Optionally in any method or device disclosed herein, the porous artificial melanin material made by methods using a dissolution or etching approach is characterized by a pore volume per mass of material greater than or equal to 0.1 cm³/g and wherein at least a portion of the pores have at least one size dimension, such as a cross sectional dimension and/or longitudinal dimension, greater than or equal to 0.5 nm. Optionally in any method or device disclosed herein, the porous artificial melanin material made by methods using a dissolution or etching approach is characterized by an average pore volume per mass of material selected from the range of 0.1 cm³/g to 1 cm³/g. Optionally in any method or device disclosed herein, the porous artificial melanin material made by methods using a dissolution or etching approach is a microporous material or a mesoporous material. Optionally in any method or device disclosed herein, the pores of the porous artificial melanin material made by methods using a dissolution or etching approach include primary pores having at least one average size dimension, such as a cross sectional dimension and/or longitudinal dimension, selected from the range of 0.5 nm to 2 nm.

Optionally in any method or device disclosed herein, a method of making a porous artificial melanin material employing a templating approach comprises: (i) combining artificial melanin precursors and a templating agent in a first aqueous solution; and (ii) polymerizing the artificial melanin precursors in the presence of the templating agent, thereby generating an intermediate melanin product comprising one or more melanin oligomers and/or polymers incorporated with the templating agent, thereby resulting in the porous artificial melanin material. A wide range of templating agents are useful in the present methods including materials with a defined structure that may be coated with or accommodated by the melanin monomer or polymerization products thereof.

In some embodiments, the method further comprising the step of removing the templating agent, for example, using chemical or thermal removal process(es). In some embodiments the template is not removed and thus remains a component of the porous artificial melanin material.

Optionally in any method or device disclosed herein, the step of polymerizing the artificial melanin precursors in a first aqueous solution comprises oxidative oligomerization or polymerization. Optionally in any method or device disclosed herein, the artificial melanin precursors are provided in the first aqueous solution at a concentration selected from the range of 0.1 to 10 mg/mL. Optionally in any method or device disclosed herein, the templating agent is provided in the first aqueous solution at a concentration selected from the range of 0.1 to 10 mg/mL. Optionally in any method or device disclosed herein, the mass ratio of artificial melanin precursors to templating agent is selected from the range of 1:100 to 100:1. Optionally in any method or device disclosed herein, the step of polymerizing the artificial melanin precursors in the first aqueous solution is carried out at a temperature selected from the range of 15° C. to 30° C. Optionally in any method or device disclosed herein, the step of polymerizing the artificial melanin precursors in the first aqueous solution is carried out for a time duration selected over the range of 1 hour to 1 week.

Optionally in any method or device disclosed herein, at least a portion of the artificial melanin precursors each independently comprises a substituted or unsubstituted dopamine monomer. Optionally in any method or device disclosed herein, at least a portion of the artificial melanin precursors each independently are selected from the group consisting of substituted or unsubstituted dihydroxydopamine monomers, substituted or unsubstituted dioxydopamine monomers, substituted or unsubstituted dihydroxynaphthalene monomers, substituted or unsubstituted dioxydopamine monomers and any combination of these. Optionally in any method or device disclosed herein, at least a portion of the artificial melanin precursors each independently are selected from the group consisting of 3,4-dihydroxydopamine monomers, 3,4-dioxydopamine monomers, 3,4-dihydroxynaphthalene monomers, and any combination of these.

Optionally in any method or device disclosed herein, the templating agent is a microporous or mesoporous templating agent. Optionally in any method or device disclosed herein, the templating agent is a porous silicon dioxide material, a porous ceramic material, porous metal material, porous carbon material, porous polymer material, an organic framework, a metal organic framework, a covalent organic framework, a porous polystyrene material, a hydrogel, one or more surfactants or any combination of these. Optionally in any method or device disclosed herein, the templating agent is silica, alumina, titania, gold, silver, platinum, copper, cobalt, palladium, nickel, zinc, iron, calcium, carbon, polystyrene, polydimethylsiloxane, poly (acrylic acid), poly (methyl methacrylate), poly (vinyl pyrrolidone), ethylene glycol dimethacrylate, polyurethane, divinylbenzene, bis(2-ethylhexyl) sulfosuccinate, ethylene trimethacrylate, acrylamide, bisacrylamide, covalent organic framework, metal organic framework, porous aromatic framework, polymer with intrinsic microporosity, hyper-conjugated polymer, conjugate microporous polymer, amino acids, poloxamers, trimethyl benzene, cetyl trimethyl ammonium bromide, ammonium sulfate, sodium dodecyl sulfate or any combination of these. Optionally in any method or device disclosed herein, the templating agent is removed via etching, dissolution, calcination, dehydration, denaturation or any combination of these processes.

Optionally in any method or device disclosed herein, the porous artificial melanin material generated by the templating method is characterized by a pore volume per mass of material greater than or equal to 0.1 cm³/g and wherein at least a portion of the pores have at least one size dimension, such as a cross sectional dimension and/or longitudinal dimension, greater than or equal to 0.5 nm. Optionally in any method or device disclosed herein, the porous artificial melanin material generated by the templating method is characterized by an average pore volume per mass of material selected from the range of 0.1 cm³/g to 1 cm³/g. Optionally in any method or device disclosed herein, the porous artificial melanin material generated by the templating method is a microporous material or a mesoporous material. Optionally in any method or device disclosed herein, the porous artificial melanin material generated by the templating method includes primary pores having an average size dimension, such as a cross sectional dimension and/or longitudinal dimension, selected from the range of 0.5 to 50 nm. Optionally in any method or device disclosed herein, the porous artificial melanin material generated by the templating method comprises a templated structure. Optionally in any method or device disclosed herein, the porous artificial melanin material generated by the templating method comprises polydopamine.

Without wishing to be bound by any particular theory, there may be discussion herein of beliefs or understandings of underlying principles relating to the devices and methods disclosed herein. It is recognized that regardless of the ultimate correctness of any mechanistic explanation or hypothesis, an embodiment of the invention can nonetheless be operative and useful.

### BRIEF DESCRIPTION OF THE DRAWINGS

FIGS. 1A-1B. N₂ sorption at 77 K. FIG. 1A: Nitrogen adsorption (solid markers) and desorption (open markers) of pre-etched 5% and 25% Loaded (MS@5% SPM and MS@25% SPM, respectively). FIG. 1B: Pore size distribution of MS@5% SPM and MS@25% SPM determined using density functional theory (DFT).

FIGS. 2A-2B. N₂ sorption at 77 K. FIG. 2A: Nitrogen adsorption (solid markers) and desorption (open markers) of 5% Loaded SPM, 25% SPM, and PDA. FIG. 2B: Pore size distribution of 5% and 25% Loaded SPM determined using density functional theory (DFT).

FIGS. 3A-3D. Gas adsorption curves of SPM. FIGS. 3A-3B: 5% and 25% Loaded SPM adsorption curves of CO₂, respectively, at 273, 288, and 298 K. FIGS. 3C-3D: 5% and 25% Loaded SPM adsorption curves of CH₄, respectively, at 273, 288, and 298 K.

FIGS. 4A-4B. H₂ adsorption curves at 273 K, 288 K, and 298 K. FIG. 4A: 5% Loaded SPM H₂ adsorption. FIG. 4B: 25% Loaded SPM H₂ adsorption.

FIG. 5. Selectivity of CO₂/CH₄ for 5% and 25% Loaded SPM at 273, 288, and 298 K as calculated by Ideal Adsorption Solution Theory (IAST). 5% CO₂ and 95% CH₄ mixture were used for these calculations.

FIGS. 6A-6D. CO₂ and CH₄ Q_{ST} of 5% Loaded SPM (blue) and 25% Loaded SPM (red). FIG. 6A: CO₂ Qst of 5% Loaded SPM. FIG. 6B: CO₂ Qst of 25% Loaded SPM. FIG. 6C: CH₄ Qst of 5% Loaded SPM. FIG. 6D: CH₄ Qst of 25% Loaded SPM.

FIG. 7. Ammonia adsorption curves of 25% Loaded SPM, 5% Loaded SPM, and PDA.

FIGS. 8A-8B. Toxin simulant adsorption with 5% Loaded SPM, 25% Loaded SPM, and PDA. FIG. 8A: Diazinon adsorption. FIG. 8B: Paraoxon adsorption. Adsorption data was fitted with a Langmuir isotherm.

FIGS. 9A-9N. Dimethyl methylphosphonate (DMMP) breakthrough studies on polydopamine coated NyCo fabric. FIG. 9A: Photographs before and after coating NyCo fabric with dopamine+tris buffer (0.4 mg deposited), polydopamine (9.3 mg deposited), 5% Loaded SPM (9.9 mg deposited), and 25% Loaded SPM (11.0 mg deposited). FIG. 9B: Results of DMMP breakthrough studies of coated NyCo fabrics. FIGS. 9C-9E: Dopamine+tris buffer coated fabric. FIGS. 9F-9H: PDA coated NyCo fabric. FIGS. 9I-9K: 5% Loaded SPM coated NyCo fabric. FIGS. 9L-9N: 25% Loaded SPM coated NyCo fabric. (FIGS. 9C, 9F, 9I and 9L). Scale bars 1 mm. (FIGS. 9D, 9G, 9J and 9M) Scale bars 5 μm. (FIGS. 9E, 9H, 9K and 9N) Scale bars 2 μm.

FIG. 10. Permeation of DMMP of NyCo control and NyCo coated dopamine+tris buffer, PDA, 5% Loaded SPM, and 25% Loaded SPM.

FIG. 11. Water vapor permeation of NyCo control, polytetrafluoroethylene (PTFE) membrane, and NyCo coated dopamine+tris buffer, PDA, 5% Loaded SPM, and 25% Loaded SPM. PTFE membrane acting as a water non-permeable control.

FIGS. 12A-12O. Schematic of allomelanin nanoparticle (AMNP) synthesis, with characterization by bright-field scanning transmission electron microscopy (BF-STEM), high angle annular dark field STEM (HAADF-STEM), scanning electron microscopy (SEM), and atomic force microscopy (AFM). FIGS. 12A-12E: 1,8-DHN is oxidized using NaIO₄ to form self-assembled, “Solid” structures (S-AMNP) which can be partially dissolved in MeOH at discrete timepoints to form “Hollow” (H-AMNP, f-j) or “Lacey” (L-AMNP, k-o) nanostructures. FIG. 12A: S-AMNP synthetic scheme. FIG. 12B: BF-STEM. FIG. 12C: HAADF-STEM. FIG. 12D: SEM. FIG. 12E: AFM. FIG. 12F: H-AMNP synthetic scheme. FIG. 12G: BF-STEM. FIG. 12H: HAADF-STEM. FIG. 12I: SEM. FIG. 12J: AFM. FIG. 12K: L-AMNP synthetic scheme. FIG. 12L: BF-STEM. FIG. 12M: HAADF-STEM. FIG. 12N: SEM. FIG. 12O: AFM. All SEM and BF-STEM scale bars 500 nm, and all HAADF-STEM scale bars 20 nm.

FIGS. 13A-13G. Sorption measurements for Solid (S-AMNP), Lacey (L-AMNP) and Hollow (H-AMNP) nanoparticles and pore size calculations. For sorption measurements, closed markers represent adsorption and open markers represent desorption. FIG. 13A: Nitrogen isotherms. FIG. 13B: Pore volume measurements. FIG. 13C: NH₃ uptake (the two panels show equivalent data, except the left panel shows units of mmol/g and the right panel shows units of cm³/g for the quantity adsorbed). FIG. 13D: CO₂ uptake. FIG. 13E: CH₄ uptake. FIG. 13F: IAST calculation for a mixture of 5% CO₂ and 95% CH₄. FIG. 13G: Summarized sorption measurements and pore sizes for AMNPs. “STP” refers to standard temperature and pressure, or about 273 K and about 1 bar.

FIGS. 14A-14B. Pure-component adsorption isotherms for S-AMNP. Loading (mmol/g) of (FIG. 14A) CO₂ and (FIG. 14B) CH₄ versus pressure (bar) at 298 K. Isotherms were fitted using a BET model with the Python package pyIAST.

FIGS. 15A-15B. Pure-component adsorption isotherms for L-AMNP. Loading (mmol/g) of (FIG. 15A) CO₂ and (FIG. 15B) CH₄ versus pressure (bar) at 298 K. Isotherms were fitted using a BET model with the Python package pyIAST.

FIGS. 16A-16B. Pure-component adsorption isotherms for H-AMNP. Loading (mmol/g) of (FIG. 16A) CO₂ and (FIG. 16B) CH₄ versus pressure (bar) at 298 K. Isotherms were fitted using a BET model with the Python package pyIAST.

FIGS. 17A-17B. Binding of diazinon and paraoxon by Solid (S-AMNP), Lacey (L-AMNP) and Hollow (H-AMNP) nanoparticles. FIG. 17A: Diazinon adsorption. FIG. 17B: Paraoxon adsorption. Error bars represent the variability in the experiments based on three replicate measures.

FIGS. 18A-18L. SEM images of NYCO fabric swatches at three different magnifications—100× low mag (top row), 2,000× (middle row), and 20,000× (bottom row). FIGS. 18A-18C: Uncoated NYCO control (CTRL-NYCO). FIGS. 18D-18F: DHN monomer-based coated NYCO (DHN-NYCO). FIGS. 18G-18I: Solid (S-AMNP) coated NYCO (S-AMNP-NYCO). FIGS. 18J-18L: Lacey (L-AMNP) coated NYCO (L-AMNP-NYCO).

FIGS. 19A-19G. AMNP-coated nylon-cotton (NYCO) fabric toxin permeation studies. FIG. 19A: Photographs of 2.5 cm² NYCO swatches before and after coating with AMNPs or 1,8-DHN monomer. FIGS. 19B-19D: SEM images of H-AMNP-NYCO. Scale bars: b, 200 μm. c, 10 μm. d, 1 μm. FIG. 19E: Time-dependent FID response of dimethyl methylphosphonate (DMMP) permeating through NYCO coated and uncoated fabric swatches. FIG. 19F: Water vapor transport across NYCO coated and uncoated fabric swatches vs polytetrafluoroethylene (PTFE) control membrane. FIG. 19G: Breakthrough times, rates, and total masses for DMMP exposure, and water vapor transport rates across NYCO fabrics.

FIGS. 20A-20G. Scattering analysis of Solid (S-AMNP), Hollow (H-AMNP), and Lacey (L-AMNP) nanoparticles using dynamic light scattering (DLS), static light scattering (SLS), and small-angle x-ray scattering (SAXS). FIG. 20A: DLS plot of the average decay rate of the autocorrelation function (Γ), vs the square of the scalar magnitude of the scattering vector (q²), showing the particles have high uniformity. FIG. 20B: SLS plot for deriving the radius of gyration (R_{g}). FIG. 20C: SAXS patterns for AMNPs and scattering patterns from spherical core-shell (CS) geometric modeling. FIG. 20D: Normalized pair distance distribution functions (p(r)). FIGS. 20E-20G: Representative cross-sections (each 400 Å thick) of the average dummy atom modeling (DAMs) for S-, L, and H-AMNPS, respectively. Color coding represents the normalized bead probability from 0 (blue) to 1 (red); only beads with occupancy >⅓ are shown. Blue mesh represents the surface of all the beads with occupancy >0.1, accessible to an imaginary 180 Å solvent molecule. The cross-sectioned black spheres are for comparison only and have the same radii as the nanoparticle dimensions determined by core-shell modeling of the experimental SAXS data (Tables 2-4, FIGS. 37A-37C, 38 and 39).

FIG. 21. Scanning transmission electron (STEM) images of Fresh Solid particles (Fresh S-AMNPs). Bright-field STEM (BF-STEM, left) and scanning electron (SE) mode STEM (right) images of S-AMNPs 1 hour after synthesis. Scale bars 200 nm.

FIG. 22. UV-Vis of AMNPs over time. Timecourse following the absorbance of Solid AMNPs (S-AMNPs) at 24 h, 5 days, 10 days, and 15 days post-synthesis. This is in comparison to Lacey and Hollow AMNPs (L- and H-AMNPs, respectively) after their formation from S-AMNPs, subsequent incubation in the MeOH etching solution for 6 days, and dialysis into water. The inset is zoomed into the region between 200 nm and 450 nm for clarity. All AMNPs are suspended in water at 0.008 mg/mL.

FIG. 23. Solvent stability screening of S-AMNPs. Freshly synthesized AMNPs (24 h after the initial reaction) were solvent switched from water to organic solvent via centrifugation at 10,000 rpm for 10 minutes, followed by redispersion at 0.5 mg/mL in the solvent of interest (EtOAc, DCM, acetone, DMF, ACN, 1-octanol, acetic acid, IPA, EtOH, or MeOH) and incubated for 1 month in the etching solution. Some solvents (EtOAc, ACN, acetic acid, and EtOH) caused more aggregation than others, which is reflected in the TEM images. Images are arranged by increasing solvent polarity. Images were acquired on a JEOL 1230 TEM operating at 80 kV.

FIG. 24. STEM images of S-AMNPs etched in MeOH 30 minutes after synthesis. A TEM grid was immediately prepared from the MeOH dispersion. Scale bars 200 nm. Images were acquired on a Hitachi HD2300 STEM operating at 200 kV.

FIG. 25. STEM timeseries showing the etching of S-AMNPs and subsequent formation of L- and H-AMNPs. Freshly synthesized S-AMNPs were solvent switched to MeOH between 1 and 4 days after synthesis (rows). In each of those conditions, they were incubated for between 1 and 6 days in the same MeOH etching solution, followed by dialysis into water (columns). The particles are more well-defined, and with less collapsed structures after 5 or 6 days in the MeOH solution containing the etched species. H-AMNPs are best obtained upon solvent switching to MeOH 24 h post-reaction, and L-AMNPs are best obtained 48 h post-reaction. A slightly etched structure can be obtained after 72 hours, resembling L-AMNP but to a lesser degree, and 4 days post-reaction, the particles are stable enough in MeOH that there are no visible morphological changes, as observed by STEM. Images were acquired on a Hitachi HD2300 STEM operating at 200 kV.

FIGS. 26A-26D. HAADF-STEM analysis of AMNPs. FIG. 26A: HAADF-STEM micrograph of 1:1:1 Solid: Lacey: Hollow AMNP mixture used for size analysis. FIG. 26B: Frequency distributions for Solid and Lacey AMNP diameters as well as the inner (ID) and outer (OD) diameters of Hollow AMNP. FIG. 26C: Normalized total intensity as a function of the distance from the center of a single AMNP. The lightly colored area around each curve is the standard deviation of the measurements of at least 4 AMNP particles. FIG. 26D: Total intensity normalized by volume of the NP as a function of their outer diameter, with accompanying trendline. See FIGS. 27A-27D for more details.

FIGS. 27A-27D. Image analysis sequence for STEM intensity measurements from FIGS. 26A-26D. Intensity from the masked image is summed and normalized. FIG. 27A: Raw H-AMNP HAADF-STEM image. FIG. 27B: Moving average. FIG. 27C: Thresholding. FIG. 27D: Masking. Analysis was performed in MATLAB.

FIGS. 28A-28D. Photographs of AMNPs in MeOH or Milli-Q water at different timepoints and at different concentrations. FIG. 28A: S-AMNPs were dispersed in MeOH at 24 h or 2 weeks after the initial reaction, and L-AMNPs and H-AMNPs were re-dispersed in MeOH after the etching and incubation process was completed and after the particles were dialyzed into water for purification. All AMNPs shown at 0.5 mg/mL in MeOH. FIG. 28B: Tubes from a were pelletized by centrifugation at 10,000 rpm for 10 minutes. FIG. 28C: AMNPs were dispersed in water at 0.08 mg/mL (subsequently diluted 10× for UV-Vis analysis, see FIG. 22). FIG. 28D: S-AMNPs forming in the initial reaction mixture (1 mg/mL in H₂O/ACN) 1 minute after injection of the NaIO₄ oxidant, or at 4 mg/mL 1 h or 12 d after the reaction was completed (particles were clean and purified). L- and H-AMNPs at 4 mg/mL in water after the etching, incubation, and dialysis process was completed. The concentration was re-measured after dialysis.

FIG. 29. Relative amount of 1,8-DHN dimer shedding from S-AMNP over time as the particles “age” (oxidize further) in water. Aliquots from a fresh batch of purified S-AMNP were removed every day for 13 days, pelletized by centrifugation at 14,000 rpm for 8 minutes, the supernatant removed, and the particles re-suspended by vortexing in MeOH to a final concentration of 0.5 mg/mL. The solution/suspension was then re-pelletized by centrifugation at 14,000 rpm for 8 minutes and the supernatant analyzed by HPLC. The amount of dimer in the supernatant was plotted as a function of time, with the starting concentration at 24 hours normalized to 1.

FIG. 30. STEM micrograph of H-AMNPs, resin-embedded and sectioned to 80 nm thickness. The sample was not post-stained after sectioning. Scale bar 500 nm.

FIG. 31. STEM micrographs of S-AMNPs (left) and H-AMNPs (right), imaged 18 months after synthesis. The particles were stored in water on the benchtop at room temperature. They were imaged using a Hitachi HD2300 STEM operating at 200 kV. Scale bars 200 nm.

FIG. 32. Effective diffusion coefficient (D_{eff}) plotted as a function of scattering vector (q). Polydispersity indices (PDI) for the Solid, Lacey, and Hollow particles are 0.17, 0.21, 0.08, respectively.

FIGS. 33A-33C. Autocorrelation functions from DLS measurements. FIG. 33A. Solid (S-AMNP). FIG. 33B. Lacey (L-AMNP). FIG. 33C. Hollow (H-AMNP). These graphs are annotated with an arrow representing a general trend of the data with respect to temperature.

FIG. 34. SAXS pattern and corresponding core-shell modeling parameters of Fresh Solid AMNPs (Fresh S-AMNPs) synthesized 48 hours before the measurement.

FIG. 35. SAXS pattern of S-AMNPs (green circles) with spheroid (blue dashed line) and core-shell model (red dashed line) for comparison of geometrical models.

FIG. 36. Normalized pair distance distribution function (p(r)) for Fresh Solid AMNPs (Fresh S-AMNPs).

FIGS. 37A-37C. Ten individual DAMMIF modeling runs for AMNPs. FIG. 37A: Solid (S-AMNP). FIG. 37B: Lacey (L-AMNP). FIG. 37C: Hollow (H-AMNP). X-ray scattering data displayed as symbols with the DAM fit for each individual run represented with the line. Each modeling run has been vertically offset for clarity.

FIG. 38. Ten individual DAMMIF modeling runs for Fresh Solid (Fresh S-AMNP) nanoparticles. X-ray scattering data displayed as symbols with the DAM fit for each individual run represented with the line. Each modeling run has been vertically offset for clarity.

FIG. 39. Representative cross-sectional slices (400 Å thick) of the average DAM for Fresh Solid (Fresh S-AMNPs) rotated through three different imaging planes. Color coding represents the normalized bead probability from 0 (blue) to 1 (red); only beads with occupancy >⅓ are shown. Blue mesh represents the surface of all the beads with occupancy >0.1, accessible to an imaginary 180 Å solvent molecule. The cross-sectioned black spheres are for comparison only and have the same radii as the nanoparticle dimensions determined by core-shell modeling of the experimental SAXS data. From the ab initio modeling it is important to note that the spherical imperfections evident in the nanoparticle average DAMs could be representing real nanoparticle imperfections, or they could be an artifact of sample polydispersity, insufficient low-q data, inter-particle interference, and the modeling method.

FIG. 40. STEM micrographs of AMNPs recovered after critical activation for BET sorption measurements. There is no visible morphological change before and after the measurements. Left to right—Solid (S-AMNP), Lacey (L-AMNP), and Hollow (H-AMNP). Scale bars 200 nm.

FIG. 41. Exemplary scheme for templated synthesis of an exemplary synthetic porous melanin (SPM), according to various embodiments here.

FIGS. 42A-42J. TEM (FIGS. 42A, 42C, 42E, 42G and 42I) and SEM (FIGS. 42B, 42D, 42F, 42H and 42J) micrographs of representative porous silica templates and oxidatively polymerized polydopamine nanoparticles. FIGS. 42A-42B: Mesoporous silica with 5% loaded polydopamine before etching. FIGS. 42C-42D: Mesoporous silica with 5% loaded polydopamine after etching (5% Loaded SPM). FIGS. 42E-42F: Mesoporous silica with 25% loaded polydopamine before etching. FIGS. 42G-42H: Mesoporous silica with 25% loaded polydopamine after etching (25% Loaded SPM). FIGS. 42I-42J: Polydopamine nanoparticles. All scale bars 1 micron.

FIGS. 43A-43D. Characterization of 5% Loaded SPM, 25% Loaded SPM, PDA, and MS. FIG. 43A: Dynamic light scattering. FIG. 43B: Fourier-transform infrared spectroscopy. FIG. 43C: Ultraviolet visible spectroscopy. FIG. 43D: Thermogravimetric analysis of 5% Loaded SPM.

FIGS. 44A-44D. N₂ sorption at 77 K and images of mesoporous silica (MS). FIG. 44A: N₂ adsorption (solid markers) and desorption (open markers). FIG. 44B: Pore size distribution determined using density functional theory (DFT). FIG. 44C: TEM image. FIG. 44D: SEM image. All scale bars represent 1 micron.

FIGS. 45A-45F. Energy-dispersive X-ray spectroscopy (EDS) of 5% Loaded SPM. FIG. 45A: TEM of mesoporous silica coated with dopamine (SPM before etching). FIG. 45B: EDS silicon signal of SPM before etching. FIG. 45C: Overlay of TEM image and EDS silicon signal for SPM before etching. FIG. 45D: TEM of SPM (after etching). FIG. 45E: EDS silicon signal of SPM (after etching). FIG. 45F: Overlay of TEM image and EDS silicon signal of SPM (after etching). All scale bars represent 1 micron.

FIGS. 46A-46B. Cryogenic TEM micrographs of SPM. FIG. 46A: 5% Loaded SPM, scale bar 1 micron. FIG. 46B: 25% Loaded SPM, scale bar 1 micron.

FIGS. 47A-47F. TEM micrographs of 5% Loaded SPM with different ratios of dopamine to mesoporous silica by mass. FIG. 47A: 5:10. FIG. 47B: 6:10. FIG. 47C: 7:10. FIG. 47D: 8:10. FIG. 47E: 9:10. FIG. 47F: 10:10. All scale bars 1 micron. Dopamine was polymerized on mesoporous silica for four hours.

### STATEMENTS REGARDING CHEMICAL COMPOUNDS AND NOMENCLATURE

In general, the terms and phrases used herein have their art-recognized meaning, which can be found by reference to standard texts, journal references and contexts known to those skilled in the art. The following definitions are provided to clarify their specific use in the context of the invention.

The term “melanin” generally refers to one or more compounds or materials that function as a pigment, such as when internalized or taken up by a biological cell, for example. It is also noted that melanin is not necessarily taken up by cells. Melanin can be used for forming cell walls in fungi, for example, such as to provide rigidity, defense mechanisms, and more. In another illustrative example, melanin is used by birds, such as where melanin is organized in a matrix of keratin or similar type of biological material, where it can be organized into monolayers or multilayers to provide structural color, warmth, and more. A melanin compound or material may be, but is not limited to, a melanin monomer, a melanin oligomer, a melanin polymer, or a melanin nanoparticle, a melanin layer (e.g., a melanin thin film), or other melanin material, for example. For example, melanin nanoparticles internalized by a biological cell function as a pigment in the cell.

The terms “artificial melanin” and “synthetic melanin” are used interchangeably herein and refer to one or more melanin compounds, molecules, or materials, such as melanin monomers, melanin oligomers, or melanin nanoparticles, that are synthesized and are at least partially, or preferably entirely, not derived from or not extracted from a natural source, such as a biological source, a living organism, or a once living organism. The terms “synthetic” and “artificial” are used interchangeably herein when referring to a melanin or a material comprising a melanin. Optionally in some embodiments, artificial melanin or synthetic melanin may be referred to as artificial melanin mimic or synthetic melanin mimic, respectively. The terms “synthetic melanin nanoparticles” and “artificial melanin nanoparticles” are used interchangeably herein, and are intended to have the same meaning throughout the present disclosure, and refer to nanoparticles formed of artificial melanin, such as artificial melanin monomers and/or artificial melanin oligomers. The terms “synthetic melanin thin film” and “artificial melanin thin film” are used interchangeably herein, and are intended to have the same meaning throughout the present disclosure, and refer to a thin film formed of artificial melanin, such as artificial melanin monomers and/or artificial melanin oligomers. The terms “synthetic melanin layer” and “artificial melanin layer” are used interchangeably herein, and are intended to have the same meaning throughout the present disclosure, and refer to a layer formed of artificial melanin, such as artificial melanin monomers and/or artificial melanin oligomers. Optionally in some embodiments, an artificial melanin nanoparticle, artificial melanin thin film, or artificial melanin layer and be referred to as an artificial melanin mimic nanoparticle, artificial melanin mimic thin film, or artificial melanin mimic layer, respectively. Optionally in some embodiments, an artificial melanin nanoparticle, artificial melanin thin film, or artificial melanin layer and be referred to as an artificial melanin-like nanoparticle, artificial melanin-like thin film, or artificial melanin-like layer, respectively. Optionally in some embodiments, a synthetic melanin nanoparticle, synthetic melanin thin film, or synthetic melanin layer and be referred to as an synthetic melanin mimic nanoparticle, synthetic melanin mimic thin film, or synthetic melanin mimic layer, respectively. Optionally in some embodiments, a synthetic melanin nanoparticle, synthetic melanin thin film, or synthetic melanin layer and be referred to as an synthetic melanin-like nanoparticle, synthetic melanin-like thin film, or synthetic melanin-like layer, respectively. An artificial melanin nanoparticle, artificial melanin thin film, artificial melanin layer, and any compound, material, or formulation comprising any of these, comprises artificial melanin monomers, artificial melanin oligomers, and/or artificial melanin polymers. Optionally, an artificial melanin nanoparticle, artificial melanin thin film, artificial melanin layer, and any compound, material, or formulation comprising any of these, consists of or consists essentially of artificial melanin, such as artificial melanin monomers, artificial melanin oligomers, and/or artificial melanin polymers. Optionally, an artificial melanin nanoparticle, artificial melanin thin film, artificial melanin layer, and any compound, material, or formulation comprising any of these, is free (or substantially free) of artificial melanin monomers and comprises artificial melanin oligomers and/or artificial melanin polymers. Preferably, each artificial melanin monomer, artificial melanin oligomer, and artificial melanin polymer of an artificial melanin nanoparticle, artificial melanin thin film, artificial melanin layer, and any compound, material, or formulation comprising any of these, is not bound to, conjugated to, attached to, coated by, encompassed by or chemically otherwise associated with a natural or biological proteinaceous matrix, component, or lipid. A natural or biological proteinaceous matrix or component refers to a naturally or biologically derived matrix or component or a matrix or component extracted from a natural or biological source, such as a once living organism, said matrix or component comprising one or more proteins. A natural or biological proteinaceous lipid refers to a naturally or biologically derived lipid or a lipid extracted from a natural or biological source, such as a once living organism, said lipid comprising one or more proteins such as the lipid (plasma) membrane of a melanocyte or melanosome). Optionally, each artificial melanin monomer, artificial melanin oligomer, and artificial melanin polymer of an artificial melanin nanoparticle, artificial melanin thin film, artificial melanin layer, and any compound, material, or formulation comprising any of these, is not bound to, conjugated to, attached to, coated by, encompassed by or otherwise chemically associated with a natural or biological lipid (e.g. a lipid bilayer, lipid membrane or phospholipid compound). A natural or biological lipid refers to a naturally or biologically derived lipid or a lipid extracted from a natural or biological source, such as a once living organism. Optionally, any artificial melanin monomer, artificial melanin oligomer, and artificial melanin polymer of an artificial melanin nanoparticle, artificial melanin thin film, artificial melanin layer, and any compound, material, or formulation comprising any of these, is bound to, conjugated to, attached to, coated by, encompassed by, and/or otherwise associated with a synthetic or artificial lipid or with a synthetic or artificial phospholipid. A synthetic or artificial lipid refers to a synthesized lipid that is not derived from or is not extracted from a natural or biological source, such as a once living organism.

The term “aging”, when used in reference to artificial melanin nanoparticles herein, refers to a process by which synthesized and isolated artificial melanin nanoparticles oxidize, and optionally further darker, over time during exposure to oxygen, such due to exposure to air. Isolated artificial melanin nanoparticles can be artificial melanin nanoparticles that are purified, such as by centrifugation, and re-dispersed in water, such as ultrapure water, or optionally another solvent or solvent solution. For example, artificial melanin nanoparticles may age if the particles are dispersed in water and are stored in a vial with the vial's top on (closed) and with the top not being opened for some extended period of time, because there is residual oxygen in the container. The aging process can alter certain properties or characteristics of artificial melanin nanoparticles, such as increasing solubility in organic solvent or decreasing toxicity to certain living biological cells. For example, without wishing to be bound by any particular theory, in some embodiments, freshly synthesized artificial melanin nanoparticles can be dynamic and shed monomers or oligomers into a cell when internalized by the cell. For example, without wishing to be bound by any particular theory, in some embodiments, freshly synthesized artificial melanin nanoparticles can be dynamic and have surface chemistry oxidation state that is not optimal for living cells when internalized by cells. For example, without wishing to be bound by any particular theory, in some embodiments, the aging process can lead to more crosslinking or otherwise chemical association between melanin compounds (monomers, oligomers) in the artificial melanin nanoparticles, potentially leading to reduced cytotoxicity, such as due to reduced shedding of melanin compounds into the cell and/or altering or stabilizing of the particles' surface chemistry.

The term “polydispersity” or “dispersity” refers to a measure of heterogeneity of sizes particles. For example, polydispersity can be used to characterize a width of a particle size distribution (e.g., particle size vs. count or frequency), such as a particle size distribution of artificial melanin nanoparticles. For example, polydispersity may characterize heterogeneity of sizes of artificial melanin nanoparticles, such as artificial melanin nanoparticles in a solvent or artificial melanin nanoparticles in a dry state, such as those forming a film or layer. A “polydispersity index” is a measure of polydispersity. A polydispersity index can be measured using Dynamic Light Scattering (DLS), for example. Particles characterized by a polydispersity index of less than 0.1 are typically referred to as “monodisperse”. For example, a polydispersity index (PDI) can be calculated as the square of the standard deviation of the particle size distribution divided by its

$$mean := {( \frac{σ}{d} )}^{2} ,$$

where σ is standard deviation of the particle size distribution and d is the mean diameter of the particle size distribution. Polydispersity and polydispersity index, as well as techniques for determining these, are further described in “NanoComposix's Guide to Dynamic Light Scattering Measurement and Analysis” [dated February 2015 (version 1.4), published by nanoComposix of San Diego, CA, and available at nanoComposix_Guidelines_for_DLS_Measurements_and_Analysis (last accessed Jun. 26, 2019)], which is incorporated herein by reference. The polydispersity index can also be calculated from electron microscope (SEM and/or TEM) images where the diameter is measured using software such as ImageJ, followed by calculating a mean size of the distribution, and then using the aforementioned equation to calculate the polydispersity index.

The term “nanoparticle” as used herein, refers to a physical particle whose longest size characteristic or physical dimension is less than 1 μm.

The term “size characteristic” refers to a property, or set of properties, of particle(s) or feature(s) that directly or indirectly relates to a size attribute. According to some embodiments, a size characteristic corresponds to an empirically-derived size characteristic of particle(s) or feature(s) being detected, such as a size characteristic based on, determined by, or corresponding to data from any technique or instrument that may be used to determine a particle or feature size, such as electron microscope (e.g., SEM and TEM) or a light scattering technique (e.g., DLS). For example, a size characteristic can correspond to a spherical particle exhibiting similar or substantially same properties, such as aerodynamic, hydrodynamic, optical, and/or electrical properties, as the particle(s) being detected). According to some embodiments, a size characteristic corresponds to a physical dimension, such as a cross-sectional size (e.g., length, width, thickness, or diameter). The term “size dimension” is used interchangeably herein with the term “size characteristic.”

The term “particles” refers to small solid objects that may be dispersed and/or suspended in a fluid (e.g., liquid). For example, a slurry, a dispersion, and a suspension each include particles in a fluid. For example, a slurry includes particles dispersed and/or suspended therein. The terms “particle” and “particulate” may be used interchangeably. An exemplary particle is an artificial melanin nanoparticle. A plurality of particles may be associated together to form an agglomerate of particles. Generally, the term “particle”, such as “nanoparticle” or “melanin nanoparticle”, refers to an individual particle rather than to an agglomerate of such individual particles.

The term “sphericity” may be used to describe a given particle and refers to a ratio of surface area of a sphere (having the same volume as the given particle) to the surface area of the particle. An ideal sphere has a sphericity of 1. For example, an ideal cylinder has a sphericity of approximately 0.874.

The terms “collapsed ellipsoid” optionally refers a structure resembling an ellipsoid that has partially collapsed or imploded, such as a deflated balloon, for example. A collapsed ellipsoid may resemble an ellipsoid having indentations therein. A sphere is an exemplary ellipsoid. A collapsed sphere may resemble, but is not limited to, structures described in Vliegenthart, et al. (G A Vliegenthart and G Gompper, 2011 New J. Phys. 13 045020, DOI 10.1088/1367-2630/13/4/045020). Some walnut-like structures resemble collapsed ellipsoids or ellipsoids having indentations.

The term “dispersed” in regard to solid particles in a fluid refers to a dispersion, or a microscopically homogenous, or uniform, mixture of solid particles in a fluid. A dispersion may be thermodynamically favored remain stably dispersed, or a dispersion may be thermodynamically favored to segregate by sedimentation but wherein sedimentation is kinetically slowed or prevented. Generally, a dispersion is a microscopically homogenous mixture having solid particles therein. One example of a dispersion is a colloid. Particles stably dispersed remain dispersed and do not sediment or precipitate out of the solution for at least 5 hours, optionally at least 12 hours, optionally at least 24 hours, and optionally at least 1 week, under normal temperature and pressure and exposure to air. Particles that are not or cannot be dispersed in a fluid refer to particles that form precipitates or sediments upon being mixed in the fluid.

The term “structural color” refers to the generation of color due to interference of visible light structural features, such as a film or layer or a microstructured surface. A layer of melanin nanoparticles may exhibit color due to interference of visible light with the microstructure of the layer, rather than solely due to pigmentation. Without wishing to be bound by any particular theory, the effect of structural color can enable a spectrum on non-fading, non-photobleaching colors which can be iridescent or non-iridescent. Without wishing to be bound by any particular theory, high refractive index of melanin and synthetic melanin, and its broadband absorption across the visible spectrum allows it to interact with light in such a way that a multitude of colors are produced.

The term “peak size” size refers to the statistical mode, or peak frequency, of a particle size distribution, or the particle size most commonly found in the particle size distribution. A particle size distribution can be measured using dynamic light scattering, for example.

The term “sphere” as used herein, in the usual and customary sense, refers to a round or substantially round geometrical object in three-dimensional space that is substantially the surface of a completely round ball, analogous to a circular object in two dimensions. A sphere may be defined mathematically as the set of points that are all at the same or substantially all at the same distance r from a given point, but in three-dimensional space, where r is the radius of the mathematical ball and the given point is the center or substantially the center of the mathematical ball. In embodiments, the longest straight line through the ball, connecting two points of the sphere, passes through the center and its length is thus twice the radius; it is a diameter of the ball. A nanosphere is a nanoparticle having a radius of less than 1 μm.

The terms “ultraviolet induced damage” and “UV induced damage” as used interchangeably herein refer, in the usual and customary sense, to chemical changes attending irradiation of light of sufficient energy. UV induced damage can include scission of nucleic acids (e.g., DNA or RNA), and breaking of bonds in proteins, lipids, and other physiological molecules. For example, the damage can be damage resulting from reactive oxygen species (ROS).

The terms “reactive oxygen species” and “ROS” as used interchangeably herein refer, in the usual and customary sense, to transient species, typically formed during exposure to radiation (e.g., UV irradiation) capable of inducing oxidative decomposition.

The terms “cell” and “biological cell” are used interchangeably are refer to a cell carrying out metabolic or other function sufficient to preserve or replicate its genomic DNA. A cell can be identified by well-known methods in the art including, for example, presence of an intact membrane, staining by a particular dye, ability to produce progeny or, in the case of a gamete, ability to combine with a second gamete to produce a viable offspring. Cells may include prokaryotic and eukaryotic cells. Prokaryotic cells include but are not limited to bacteria. Eukaryotic cells include but are not limited to yeast cells and cells derived from plants and animals, for example mammalian, insect (e.g., spodoptera) and human cells. A “viable cell” is a living biological cell.

The term “self-assembly” refers to a process in which individual elements assemble into a network or organized structure without external direction. In an embodiment, self-assembly leads to a decrease in entropy of a system. In an embodiment, self-assembly may be induced, or initiated, via contacting or reacting the individual elements, optionally at a certain critical concentration, and/or via temperature and/or via pressure. A “self-assembled structure” is a structure or network formed by self-assembly. In an embodiment, self-assembly is a polymer crystallization process. The Gibbs free energy of the self-assembled structure is lower than of the sum of the individual components in their non-organized arrangement prior to self-assembly under otherwise identical conditions (e.g., temperature and pressure). In an embodiment, entropy of a self-assembled structure is lower than that of the sum of the individual components in their non-organized arrangement prior to self-assembly under otherwise identical conditions (e.g., temperature and pressure). For example, artificial melanin nanoparticles of this disclosure can form by self-assembly of a plurality of oligomers and/or melanin monomers. For example, structures or layers (e.g., films) for artificial melanin nanoparticles may form by self-assembly, such as structures or layers formed of artificial melanin nanoparticles and exhibiting structural color.

The term “substantially” refers to a property, condition, or value that is within 20%, 10%, within 5%, within 1%, optionally within 0.1%, or is equivalent to a reference property, condition, or value. The term “substantially equal”, “substantially equivalent”, or “substantially unchanged”, when used in conjunction with a reference value describing a property or condition, refers to a value that is within 20%, within 10%, optionally within 5%, optionally within 1%, optionally within 0.1%, or optionally is equivalent to the provided reference value. For example, a diameter is substantially equal to 100 nm (or, “is substantially 100 nm”) if the value of the diameter is within 20%, optionally within 10%, optionally within 5%, optionally within 1%, within 0.1%, or optionally equal to 100 nm. The term “substantially greater”, when used in conjunction with a reference value describing a property or condition, refers to a value that is at least 1%, optionally at least 5%, optionally at least 10%, or optionally at least 20% greater than the provided reference value. The term “substantially less”, when used in conjunction with a reference value describing a property or condition, refers to a value that is at least 1%, optionally at least 5%, optionally at least 10%, or optionally at least 20% less than the provided reference value. As used herein, the terms “about” and “substantially” are used interchangeably and have identical means. For example, a particle having a size of about 1 μm is understood to have a size is within 20%, optionally within 10%, optionally within 5%, optionally within 1%, optionally within 0.1%, or optionally equal to 1 μm.

The terms “keratinocyte” and “keratinocytes” as used herein, refer to the predominant cell type in the epidermis, the outermost layer of the skin, constituting the majority (e.g., 90%-95%) of the cells found there. Keratinocytes are found in the deepest basal layer of the stratified epithelium that comprises the epidermis, and are sometimes referred to as basal cells or basal keratinocytes. Keratinocytes are maintained at various stages of differentiation in the epidermis and are responsible for forming tight junctions with the nerves of the skin. They also keep Langerhans cells of the epidermis and lymphocytes of the dermis in place. Keratinocytes contribute to protecting the body from UV radiation by taking up melanosomes. Keratinocytes contribute to protecting the body from UV radiation by taking up melanosomes, vesicles containing the endogenous photoprotectant melanin, from epidermal melanocytes. Each melanocyte in the epidermis has several dendrites that stretch out to connect it with many keratinocytes. The melanin is then stored within keratinocytes and melanocytes in the perinuclear area as “supranuclear caps”, where it protects the DNA from UV-induced damage. In addition to their structural role, keratinocytes play a role in immune system function. The skin is the first line of defense and keratinocytes serve as a barrier between an organism and its environment. In addition to preventing toxins and pathogens from entering an organisms body, they prevent the loss of moisture, heat and other important constituents of the body. In addition to their physical role, keratinocytes serve a chemical immune role as immunomodulators, responsible for secreting inhibitory cytokines in the absence of injury and stimulating inflammation and activating Langerhans cells in response to injury. Langerhans cells serve as antigen-presenting cells when there is a skin infection and are the first cells to process microbial antigens entering the body from a skin breach.

The terms “under conditions suitable to afford uptake”, “taken up” and “take up” as used herein, refer, in the usual and customary sense, to experimental conditions well known in the art which allow uptake (e.g., endocytosis) of a species into a cell. In some embodiments, the term “internalized” when referring to particles internalized in or by a biological cell, refers to particles taken up by the biological cell, such as by, but not limited to, formation of perinuclear caps.

The term “endocytosis” as used herein, refers to a form of active transport in which a cell transports molecules (such as proteins) into the cell by engulfing them in an energy-using process. Endocytosis includes pinocytosis and phagocytosis. Pinocytosis is a mode of endocytosis in which small particles are brought into the cell, forming an invagination, and then suspended within small vesicles. These pinocytotic vesicles subsequently fuse with lysosomes to hydrolyze (break down) the particles. Phagocytosis is the process by which a cell engulfs a solid particle to form an internal compartment known as a phagosome.

The terms “treating” or “treatment” as used herein, refers to any indicia of success in the treatment or amelioration of an injury, disease, pathology or condition, including any objective or subjective parameter such as abatement; remission; diminishing of symptoms or making the injury, pathology or condition more tolerable to the patient; slowing in the rate of degeneration or decline; making the final point of degeneration less debilitating; improving a patient's physical or mental well-being. The treatment or amelioration of symptoms can be based on objective or subjective parameters; including the results of a physical examination, neuropsychiatric exams, and/or a psychiatric evaluation. The term “treating,” and conjugations thereof, include prevention of an injury, pathology, condition, or disease.

The term “effective amount” as used herein, refers to an amount sufficient to accomplish a stated purpose (e.g. Achieve the effect for which it is administered, treat a disease, reduce one or more symptoms of a disease or condition, and the like). An example of an “effective amount” is an amount sufficient to contribute to the treatment, prevention, or reduction of a symptom or symptoms of a disease, which could also be referred to as a “therapeutically effective amount.” A “reduction” of a symptom or symptoms (and grammatical equivalents of this phrase) means decreasing of the severity or frequency of the symptom(s), or elimination of the symptom(s). A “prophylactically effective amount” of a drug is an amount of a drug that, when administered to a subject, will have the intended prophylactic effect, e.g., preventing or delaying the onset (or reoccurrence) of an injury, disease, pathology or condition, or reducing the likelihood of the onset (or reoccurrence) of an injury, disease, pathology, or condition, or their symptoms. The full prophylactic effect does not necessarily occur by administration of one dose, and may occur only after administration of a series of doses. Thus, a prophylactically effective amount may be administered in one or more administrations. The exact amounts will depend on the purpose of the treatment, and will be ascertainable by one skilled in the art using known techniques (see, e.g., Lieberman, Pharmaceutical Dosage Forms (vols. 1-3, 1992); Lloyd, The Art, Science and Technology of Pharmaceutical Compounding (1999); Pickar, Dosage Calculations (1999); and Remington: The Science and Practice of Pharmacy, 20th Edition, 2003, Gennaro, Ed., Lippincott, Williams & Wilkins).

The term “administering” as used herein, refers to oral administration, administration as an inhaled aerosol or as an inhaled dry powder, suppository, topical contact, intravenous, parenteral, intraperitoneal, intramuscular, intralesional, intrathecal, intranasal or subcutaneous administration, or the implantation of a slow-release device, e.g., a mini-osmotic pump, to a subject. Administration is by any route, including parenteral and transmucosal (e.g., buccal, sublingual, palatal, gingival, nasal, vaginal, rectal, or transdermal). Parenteral administration includes, e.g., intravenous, intramuscular, intra-arteriole, intradermal, subcutaneous, intraperitoneal, intraventricular, and intracranial. Other modes of delivery include, but are not limited to, the use of liposomal formulations, intravenous infusion, transdermal patches, etc. By “co-administer” it is meant that a composition described herein is administered at the same time, just prior to, or just after the administration of one or more additional therapies, for example cancer therapies such as chemotherapy, hormonal therapy, radiotherapy, or immunotherapy. The compound of the invention can be administered alone or can be co-administered to the patient. Co-administration is meant to include simultaneous or sequential administration of the compound individually or in combination (more than one compound or agent). The compositions of the present invention can be delivered transdermally, by a topical route, formulated as applicator sticks, solutions, suspensions, emulsions, gels, creams, ointments, pastes, jellies, paints, powders, and aerosols. Oral preparations include tablets, pills, powder, dragees, capsules, liquids, lozenges, cachets, gels, syrups, slurries, suspensions, etc., suitable for ingestion by the patient. Solid form preparations include powders, tablets, pills, capsules, cachets, suppositories, and dispersible granules. Liquid form preparations include solutions, suspensions, and emulsions, for example, water or water/propylene glycol solutions. The compositions of the present invention may additionally include components to provide sustained release and/or comfort. Such components include high molecular weight, anionic mucomimetic polymers, gelling polysaccharides and finely-divided drug carrier substrates. These components are discussed in greater detail in U.S. Pat. Nos. 4,911,920; 5,403,841; 5,212,162; and 4,861,760. The entire contents of these patents are incorporated herein by reference in their entirety for all purposes. The compositions of the present invention can also be delivered as microspheres for slow release in the body. For example, microspheres can be administered via intradermal injection of drug-containing microspheres, which slowly release subcutaneously (see Rao, J Biomater Sci. Polym. Ed. 7:623-645, 1995; as biodegradable and injectable gel formulations (see, e.g., Gao Pharm. Res. 12:857-863, 1995); or, as microspheres for oral administration (see, e.g., Eyles, J Pharm. Pharmacol. 49:669-674, 1997). In another embodiment, the formulations of the compositions of the present invention can be delivered by the use of liposomes which fuse with the cellular membrane or are endocytosed, i.e., by employing receptor ligands attached to the liposome, that bind to surface membrane protein receptors of the cell resulting in endocytosis. By using liposomes, particularly where the liposome surface carries receptor ligands specific for target cells, or are otherwise preferentially directed to a specific organ, one can focus the delivery of the compositions of the present invention into the target cells in vivo. (See, e.g., Al-Muhammed, J. Microencapsul. 13:293306, 1996; Chonn, Curr. Opin. Biotechnol. 6:698-708, 1995; Qstio, Am. J Hasp. Pharm. 46: 1576-1587, 1989).

The term “contacting” may include allowing two species to react, interact, or physically touch, wherein the two species may be, for example, a pharmaceutical composition as provided herein and a cell. In embodiments contacting includes, for example, allowing a pharmaceutical composition as described herein to interact with a cell or a patient.

The terms “analog” and “analogue” are used interchangeably and are used in accordance with their plain ordinary meaning within Chemistry and Biology and refers to a chemical compound that is structurally similar to another compound (i.e., a so-called “reference” compound) but differs in composition, e.g., in the replacement of one atom by an atom of a different element, or in the presence of a particular functional group, or the replacement of one functional group by another functional group, or the absolute stereochemistry of one or more chiral centers of the reference compound, including isomers thereof. Accordingly, an analog is a compound that is similar or comparable in function and appearance but not in structure or origin to a reference compound.

Except where otherwise specified, the term “molecular weight” refers to an average molecular weight. Except where otherwise specified, the term “average molecular weight,” refers to number-average molecular weight. Number average molecular weight is defined as the total weight of a sample volume divided by the number of molecules within the sample. As is customary and well known in the art, peak average molecular weight and weight average molecular weight may also be used to characterize the molecular weight of the distribution of polymers within a sample.

The term “weight-average molecular weight” (M_{w}) refers to the average molecular weight defined as the sum of the products of the molecular weight of each polymer molecule (Mᵢ) multiplied by its weight fraction (wᵢ): M_{w}=ΣwᵢMᵢ. As is customary and well known in the art, peak average molecular weight and number average molecular weight may also be used to characterize the molecular weight of the distribution of polymers within a sample.

The term “oligomerization” refers to a chemical process of converting a monomer or a mixture of monomers into an oligomer. The term “oxidative oligomerization” refers to a chemical process of oligomerization that includes chemical oxidation of one or more monomers to form an oligomer. An oligomerization is a polymerization process, wherein an oligomer is formed as a result of the polymerization.

As used herein, the term “polymer” refers to a molecule composed of repeating structural units connected by covalent chemical bonds often characterized by a substantial number of repeating units, also referred to as base units, (e.g., equal to or greater than 3 repeating units, optionally, in some embodiments equal to or greater than 10 repeating units, in some embodiments greater or equal to 30 repeating units) and a high molecular weight (e.g. greater than or equal to 10,000 Da, in some embodiments greater than or equal to 50,000 Da or greater than or equal to 100,000 Da). As used herein, a term “polymer” is inclusive of an “oligomer” (i.e., an oligomer is a polymer; i.e., a polymer is optionally an oligomer). Polymers are commonly the polymerization product of one or more monomer precursors. Polymers can have, for example, greater than 50 repeating units, optionally equal to or greater than 100 repeating units. Polymers can have, for example, a high molecular weight, such as greater than 10,000 Da, in some embodiments greater than or equal to 50,000 Da or greater than or equal to 100,000 Da. The term polymer includes homopolymers, or polymers consisting essentially of a single repeating monomer subunit. The term polymer also includes copolymers which are formed when two or more different types of monomers are linked in the same polymer. Copolymers may comprise two or more monomer subunits, and include random, block, brush, brush block, alternating, segmented, grafted, tapered and other architectures. Useful polymers include organic polymers or inorganic polymers that may be in amorphous, semi-amorphous, crystalline or semi-crystalline states. Polymer side chains capable of cross linking polymers (e.g., physical cross linking) may be useful for some applications.

An “oligomer” refers to a molecule composed of repeating structural units, also referred to as base units, connected by covalent chemical bonds often characterized by a number of repeating units less than that of a polymer (e.g., equal to or less than 100 repeating units) and a lower molecular weight (e.g. less than or equal to 10,000 Da) than polymers. Oligomers may be the polymerization product of one or more monomer precursors. Polymerization of one or more monomers, or monomer precursors, resulting in formation of an oligomer may be referred to as oligomerization. An oligomer optionally includes 100 or less, optionally 50 or less, optionally 15 or less, optionally 12 or less, optionally 10 or less, optionally 5 or less repeating units (or, “base units”). An oligomer may be characterized has having a molecular weight of 10,000 Da or less, optionally 5,000 Da or less, optionally 1,000 Da or less, optionally 500 Da or less, optionally 200 Da or less. A dimer, a trimer, a tetramer, or a pentamer is an oligomer having two, three, four, or five, respectively, repeating units, or base units.

The terms “monomer” or “polymerizable monomer” can be used interchangeably and refer to a monomer precursor capable of undergoing polymerization as described herein to form a polymer according to embodiments described herein. The term “polymerizable monomer” is also interchangeably referred to herein as a “monomer precursor.” Generally, the “monomer” or “polymerizable monomer” comprises an olefin capable of undergoing polymerization as described herein.

The terms “monomer unit,” “repeating monomer unit,” “repeating unit,” and “polymerized monomer” can be used interchangeably and refer to a monomeric portion of a polymer described herein which is derived from or is a product of polymerization of one individual “monomer” or “polymerizable monomer.” Each individual monomer unit of a polymer is derived from or is a product of polymerization of one polymerizable monomer. Each individual “monomer unit” or “repeating unit” of a polymer comprises one (polymerized) polymer backbone group. For example, in a polymer that comprises monomer units X and Y arranged as X-Y-X-Y-X-Y-X-Y (where each X is identical to each other X and each Y is identical to each other Y), each X and each Y is independently can be referred to as a repeating unit or monomer unit.

The term “internal structure” refers to the internal geometry or internal configuration in a material (e.g., within the external boundaries (e.g., external surfaces) of the material). The term internal structure does not refer to structure on an atomic length scale of a material, such as the characterization of crystallographic structure. An internal structure comprising pores (e.g voids) can be characterized as a “porous internal structure.”

The term “porous”, as used herein, refers to a material or structure within which pores are present, organized and/or arranged in the material. Thus, for instance, in a porous material, the pores are volumes within the body of the material where there is no material (e.g. voids). Pores in a material are not intended to include the space occupied by atoms, ions and/or molecules of a materials including monomers, oligomers and polymers, for example, of a melanin material. In some embodiments, porous materials and pores may be characterized by a “pore characteristic” including, but not limited to, a size characteristic, size distribution, spatial distribution (e.g., uniform or random), pore type, directionality and/or composition. In some embodiments a size characteristic is a geometrical parameter such as a size dimension or average size dimension, including one or more cross sectional dimensions (e.g., diameter, effective diameter thickness, cross sectional length or width, etc.) and/or one or more longitudinal dimensions (e.g. channel or cavity length, channel or cavity pathway, etc.). Additional pore characteristics including a pore-type, directionality, being a continuous through-pore, a pore distribution and any combinations of these. Geometrical parameters of a pore may be exemplary size characteristics, including average size characteristics of the pores of a material. Optionally in any method or device disclosed herein, a size dimension is one or more, optional all of, cross sectional dimensions or an average cross sectional dimension. In an embodiment, a material is characterized by a uniform spatial distribution or random spatial distribution of pores throughout the material, for example, in contrast to a hollow pore configuration having a central pore.

The term porosity refers to a characteristic of a porous material or structure. In some embodiments, porosity is a measure of the void (i.e. “empty”) spaces, such as pores, in a material. Porosity may be expressed as the fraction of the volume of voids over the total volume, between 0 and 1, or as a percentage between 0% and 100%. “Pore volume per mass” refers to a characteristic of a porous material or porous structure corresponding to the ratio of the volume of pores (e.g., voids) to the mass of a material, for example, the ratio of the volume of pores in a sample of material to the mass of the sample. Pore volume per mass of material may be determined by a range of techniques known in the art including gas sorption measurements, Brunauer-Emmett-Teller (BET) surface measurements, optical measurements, gravimetric measurements, imbibition methods, thermoporosimetry methods and the like. The pores of a porous artificial melanin material may also be characterized by nitrogen isotherms, Brunauer-Emmett-Teller theory analysis, and Density Functional Theory analysis.

The invention provides compositions and related synthetic methods including different categories of porous artificial melanin particles corresponding to different structurally properties such as pore size, pore type and spatial distribution of pores. In some embodiments, for example, the invention provides solid porous artificial melanin particles, lacey porous artificial melanin particles and hollow porous artificial melanin particles, in each case the particles are porous wherein: (i) the lacey porous artificial melanin particles have larger voids interspersed throughout, (ii) the hollow porous artificial melanin particles have a single spherical void, for example, in the center and (iii) the solid porous artificial melanin particles have a uniform distribution or random distribution of material throughout.

The following references provide description of pore types including cylindrical pores, channel-like pores, slit-shape pores and ink-bottle pores, for example, including pore types that are typically characterized by nitrogen isotherms: (i) Bardestani, R.; Patience, G. S.; Kaliaguine, S., Experimental methods in chemical engineering: specific surface area and pore size distribution measurements—BET, BJH, and DFT. The Canadian Journal of Chemical Engineering 2019, 97 (11), 2781-2791. DOI: 10.1002/cjce.23632; (ii) Sing, K. S. W.; Everett, D. H.; Haul, R. A. W.; Moscou, L.; Pierotti, R. A.; Rouquerol, J.; Siemieniewska, T., Reporting physisorption data for gas/solid systems with special reference to the determination of surface area and porosity. Pure Appl. Chem. 1985, 57 (4), 603-619. DOI: 10.1351/pac198557040603

“Microporous” refers to a material containing pores having at least one size dimension, such as a cross sectional dimension (e.g, effective diameter), less than 2 nm. “Mesoporous” refers to a material containing pores having at least one cross sectional dimension (e.g., effective diameter), greater than 2 nm and less than 50 nm.

As used herein, the term “group” may refer to a functional group of a chemical compound. Groups of the present compounds refer to an atom or a collection of atoms that are a part of the compound. Groups of the present invention may be attached to other atoms of the compound via one or more covalent bonds. Groups may also be characterized with respect to their valence state. The present invention includes groups characterized as monovalent, divalent, trivalent, etc. valence states.

The term “moiety” refers to a group, such as a functional group, of a chemical compound or molecule. A moiety is a collection of atoms that are part of the chemical compound or molecule. The present invention includes moieties characterized as monovalent, divalent, trivalent, etc. valence states. Generally, but not necessarily, a moiety comprises more than one functional group.

As used herein, the term “substituted” refers to a compound wherein one or more hydrogens is replaced by another functional group, provided that the designated atom's normal valence is not exceeded. An exemplary substituent includes, but is not limited to: a halogen or halide, an alkyl, a cycloalkyl, an aryl, a heteroaryl, an acyl, an alkoxy, an alkenyl, an alkynyl, an alkylaryl, an arylene, a heteroarylene, an alkenylene, a cycloalkenylene, an alkynylene, a hydroxyl (—OH), a carbonyl (RCOR′), a sulfide (e.g., RSR′), a phosphate (ROP(═O)(OH)₂), an azo (RNNR′), a cyanate (ROCN), an amine (e.g., primary, secondary, or tertiary), an imine (RC(═NH)R′), a nitrile (RCN), a pyridinyl (or pyridyl), a diamine, a triamine, an azide, a diimine, a triimine, an amide, a diimide, or an ether (ROR′); where each of R and R′ is independently a hydrogen or a substituted or unsubstituted alkyl group, aryl group, alkenyl group, or a combination of these. Optional substituent functional groups are also described below. In some embodiments, the term substituted refers to a compound wherein each of more than one hydrogen is replaced by another functional group, such as a halogen group. For example, when the substituent is oxo (i.e., ═O), then two hydrogens on the atom are replaced. The substituent group can be any substituent group described herein. For example, substituent groups can include one or more of a hydroxyl, an amino (e.g., primary, secondary, or tertiary), an aldehyde, a carboxylic acid, an ester, an amide, a ketone, nitro, an urea, a guanidine, cyano, fluoroalkyl (e.g., trifluoromethane), halo (e.g., fluoro), aryl (e.g., phenyl), heterocyclyl or heterocyclic group (i.e., cyclic group, e.g., aromatic (e.g., heteroaryl) or non-aromatic where the cyclic group has one or more heteroatoms), oxo, or combinations thereof. Combinations of substituents and/or variables are permissible provided that the substitutions do not significantly adversely affect synthesis or use of the compound.

As used herein, the term “derivative” refers to a compound wherein an atom or functional group is replaced by another atom or functional group (e.g., a substituent function group as also described below), including, but not limited to: a hydrogen, a halogen or halide, an alkyl, a cycloalkyl, an aryl, a heteroaryl, an acyl, an alkoxy, an alkenyl, an alkynyl, an alkylaryl, an arylene, a heteroarylene, an alkenylene, a cycloalkenylene, an alkynylene, a hydroxyl (—OH), a carbonyl (RCOR′), a sulfide (e.g., RSR′), a phosphate (ROP(═O)(OH)₂), an azo (RNNR′), a cyanate (ROCN), an amine (e.g., primary, secondary, or tertiary), an imine (RC(═NH)R′), a nitrile (RCN), a pyridinyl (or pyridyl), a diamine, a triamine, an azide, a diimine, a triimine, an amide, a diimide, or an ether (ROR′); where each of R and R′ is independently a hydrogen or a substituted or unsubstituted alkyl group, aryl group, alkenyl group, or a combination of these. Optional substituent functional groups are also described below. Preferably, the term “derivative” refers to a compound wherein one or two atoms or functional groups are independently replaced by another atom or functional group. Preferably, the term derivative does not refer to or include replacement of a chalcogen atom (S, Se) that is a member of a heterocyclic group. Preferably, and unless otherwise stated, the term derivative does not refer to or include replacement of a chalcogen atom (S, Se) nor a N (nitrogen) where the chalcogen atom and the N are members same heterocyclic group. Preferably, but not necessarily, the term derivative does not include breaking a ring structure, replacement of a ring member, or removal of a ring member.

As is customary and well known in the art, hydrogen atoms in formulas are not always explicitly shown, for example, hydrogen atoms bonded to the carbon atoms of aromatic, heteroaromatic, and alicyclic rings are not always explicitly shown. The structures provided herein, for example in the context of the description of formula, schematics, and structures in the drawings, are intended to convey to one of reasonable skill in the art the chemical composition of compounds of the methods and compositions of the invention, and as will be understood by one of skill in the art, the structures provided do not indicate the specific positions and/or orientations of atoms and the corresponding bond angles between atoms of these compounds.

As used herein, the terms “alkylene” and “alkylene group” are used synonymously and refer to a divalent group derived from an alkyl group as defined herein. The invention includes compounds having one or more alkylene groups. Alkylene groups in some compounds function as linking and/or spacer groups. Compounds of the invention may have substituted and/or unsubstituted C₁-C₂₀ alkylene, C₁-C₁₀ alkylene and C₁-C₅ alkylene groups, for example, as one or more linking groups (e.g. L¹-L⁶).

As used herein, the terms “cycloalkenylene” and “cycloalkenylene group” are used synonymously and refer to a divalent group derived from a cycloalkenyl group as defined herein. The invention includes compounds having one or more cycloalkenylene groups. Cycloalkenylene groups in some compounds function as linking and/or spacer groups. Compounds of the invention may have substituted and/or unsubstituted C₃-C₂₀ cycloalkenylene, C₃-C₁₀ cycloalkenylene and C₃-C₅ cycloalkenylene groups, for example, as one or more linking groups (e.g. L¹-L⁶).

As used herein, the terms “arylene” and “arylene group” are used synonymously and refer to a divalent group derived from an aryl group as defined herein. The invention includes compounds having one or more arylene groups. In some embodiments, an arylene is a divalent group derived from an aryl group by removal of hydrogen atoms from two intra-ring carbon atoms of an aromatic ring of the aryl group. Arylene groups in some compounds function as linking and/or spacer groups. Arylene groups in some compounds function as chromophore, fluorophore, aromatic antenna, dye and/or imaging groups. Compounds of the invention include substituted and/or unsubstituted C₃-C₃₀ arylene, C₃-C₂₀ arylene, C₃-C₁₀ arylene and C₁-C₅ arylene groups, for example, as one or more linking groups (e.g. L¹-L⁶).

As used herein, the terms “heteroarylene” and “heteroarylene group” are used synonymously and refer to a divalent group derived from a heteroaryl group as defined herein. The invention includes compounds having one or more heteroarylene groups. In an embodiment, a heteroarylene is a divalent group derived from a heteroaryl group by removal of hydrogen atoms from two intra-ring carbon atoms or intra-ring nitrogen atoms of a heteroaromatic or aromatic ring of the heteroaryl group. Heteroarylene groups in some compounds function as linking and/or spacer groups. Heteroarylene groups in some compounds function as chromophore, aromatic antenna, fluorophore, dye and/or imaging groups. Compounds of the invention include substituted and/or unsubstituted C₃-C₃₀ heteroarylene, C₃-C₂₀ heteroarylene, C₁-C₁₀ heteroarylene and C₃-C₅ heteroarylene groups, for example, as one or more linking groups (e.g. L¹-L⁶).

As used herein, the terms “alkenylene” and “alkenylene group” are used synonymously and refer to a divalent group derived from an alkenyl group as defined herein. The invention includes compounds having one or more alkenylene groups. Alkenylene groups in some compounds function as linking and/or spacer groups. Compounds of the invention include substituted and/or unsubstituted C₂-C₂₀ alkenylene, C₂-C₁₀ alkenylene and C₂-C₅ alkenylene groups, for example, as one or more linking groups (e.g. L¹-L⁶).

As used herein, the terms “cycloalkenylene” and “cycloalkenylene group” are used synonymously and refer to a divalent group derived from a cycloalkenyl group as defined herein. The invention includes compounds having one or more cycloalkenylene groups. Cycloalkenylene groups in some compounds function as linking and/or spacer groups. Compounds of the invention include substituted and/or unsubstituted C₃-C₂₀ cycloalkenylene, C₃-C₁₀ cycloalkenylene and C₃-C₅ cycloalkenylene groups, for example, as one or more linking groups (e.g. L¹-L⁶).

As used herein, the terms “alkynylene” and “alkynylene group” are used synonymously and refer to a divalent group derived from an alkynyl group as defined herein. The invention includes compounds having one or more alkynylene groups. Alkynylene groups in some compounds function as linking and/or spacer groups. Compounds of the invention include substituted and/or unsubstituted C₂-C₂₀ alkynylene, C₂-C₁₀ alkynylene and C₂-C₅ alkynylene groups, for example, as one or more linking groups (e.g. L¹-L⁶).

As used herein, the term “halo” refers to a halogen group such as a fluoro (—F), chloro (—Cl), bromo (—Br), iodo (—I) or astato (-At).

The term “heterocyclic” refers to ring structures containing at least one other kind of atom, in addition to carbon, in the ring. Examples of such heteroatoms include nitrogen, oxygen and sulfur. Heterocyclic rings include heterocyclic alicyclic rings and heterocyclic aromatic rings. Examples of heterocyclic rings include, but are not limited to, pyrrolidinyl, piperidyl, imidazolidinyl, tetrahydrofuryl, tetrahydrothienyl, furyl, thienyl, pyridyl, quinolyl, isoquinolyl, pyridazinyl, pyrazinyl, indolyl, imidazolyl, oxazolyl, thiazolyl, pyrazolyl, pyridinyl, benzoxadiazolyl, benzothiadiazolyl, triazolyl and tetrazolyl groups. Atoms of heterocyclic rings can be bonded to a wide range of other atoms and functional groups, for example, provided as substituents.

The term “carbocyclic” refers to ring structures containing only carbon atoms in the ring. Carbon atoms of carbocyclic rings can be bonded to a wide range of other atoms and functional groups, for example, provided as substituents.

The term “alicyclic ring” refers to a ring, or plurality of fused rings, that is not an aromatic ring. Alicyclic rings include both carbocyclic and heterocyclic rings.

The term “aromatic ring” refers to a ring, or a plurality of fused rings, that includes at least one aromatic ring group. The term aromatic ring includes aromatic rings comprising carbon, hydrogen and heteroatoms. Aromatic ring includes carbocyclic and heterocyclic aromatic rings. Aromatic rings are components of aryl groups.

The term “fused ring” or “fused ring structure” refers to a plurality of alicyclic and/or aromatic rings provided in a fused ring configuration, such as fused rings that share at least two intra ring carbon atoms and/or heteroatoms.

As used herein, the term “alkoxyalkyl” refers to a substituent of the formula alkyl-O-alkyl.

As used herein, the term “polyhydroxyalkyl” refers to a substituent having from 2 to 12 carbon atoms and from 2 to 5 hydroxyl groups, such as the 2,3-dihydroxypropyl, 2,3,4-trihydroxybutyl or 2,3,4,5-tetrahydroxypentyl residue.

As used herein, the term “polyalkoxyalkyl” refers to a substituent of the formula alkyl-(alkoxy)n-alkoxy wherein n is an integer from 1 to 10, preferably 1 to 4, and more preferably for some embodiments 1 to 3.

Amino acids include glycine, alanine, valine, leucine, isoleucine, methionine, proline, phenylalanine, tryptophan, asparagine, glutamine, glycine, serine, threonine, serine, threonine, asparagine, glutamine, tyrosine, cysteine, lysine, arginine, histidine, aspartic acid and glutamic acid. As used herein, reference to “a side chain residue of a natural α-amino acid” specifically includes the side chains of the above-referenced amino acids. Peptides are comprised of two or more amino-acid connected via peptide bonds.

Alkyl groups include straight-chain, branched and cyclic alkyl groups. Alkyl groups include those having from 1 to 30 carbon atoms. Alkyl groups include small alkyl groups having 1 to 3 carbon atoms. Alkyl groups include medium length alkyl groups having from 4-10 carbon atoms. Alkyl groups include long alkyl groups having more than 10 carbon atoms, particularly those having 10-30 carbon atoms. The term cycloalkyl specifically refers to an alky group having a ring structure such as ring structure comprising 3-30 carbon atoms, optionally 3-20 carbon atoms and optionally 2-10 carbon atoms, including an alkyl group having one or more rings. Cycloalkyl groups include those having a 3-, 4-, 5-, 6-, 7-, 8-, 9- or 10-member carbon ring(s) and particularly those having a 3-, 4-, 5-, 6-, 7-, or 8-member ring(s). The carbon rings in cycloalkyl groups can also carry alkyl groups. Cycloalkyl groups can include bicyclic and tricycloalkyl groups. Alkyl groups are optionally substituted. Substituted alkyl groups include among others those which are substituted with aryl groups, which in turn can be optionally substituted. Specific alkyl groups include methyl, ethyl, n-propyl, iso-propyl, cyclopropyl, n-butyl, s-butyl, t-butyl, cyclobutyl, n-pentyl, branched-pentyl, cyclopentyl, n-hexyl, branched hexyl, and cyclohexyl groups, all of which are optionally substituted. Substituted alkyl groups include fully halogenated or semihalogenated alkyl groups, such as alkyl groups having one or more hydrogens replaced with one or more fluorine atoms, chlorine atoms, bromine atoms and/or iodine atoms. Substituted alkyl groups include fully fluorinated or semifluorinated alkyl groups, such as alkyl groups having one or more hydrogens replaced with one or more fluorine atoms. An alkoxy group is an alkyl group that has been modified by linkage to oxygen and can be represented by the formula R—O and can also be referred to as an alkyl ether group. Examples of alkoxy groups include, but are not limited to, methoxy, ethoxy, propoxy, butoxy and heptoxy. Alkoxy groups include substituted alkoxy groups wherein the alky portion of the groups is substituted as provided herein in connection with the description of alkyl groups. As used herein MeO— refers to CH₃O—. Compositions of some embodiments of the invention comprise alkyl groups as terminating groups, such as polymer backbone terminating groups and/or polymer side chain terminating groups. Substituted alkyl groups may include substitution to incorporate one or more silyl groups, for example wherein one or more carbons are replaced by Si.

Alkenyl groups include straight-chain, branched and cyclic alkenyl groups. Alkenyl groups include those having 1, 2 or more double bonds and those in which two or more of the double bonds are conjugated double bonds. Alkenyl groups include those having from 2 to 20 carbon atoms. Alkenyl groups include small alkenyl groups having 2 to 3 carbon atoms. Alkenyl groups include medium length alkenyl groups having from 4-10 carbon atoms. Alkenyl groups include long alkenyl groups having more than 10 carbon atoms, particularly those having 10-20 carbon atoms. Cycloalkenyl groups include those in which a double bond is in the ring or in an alkenyl group attached to a ring. The term cycloalkenyl specifically refers to an alkenyl group having a ring structure, including an alkenyl group having a 3-, 4-, 5-, 6-, 7-, 8-, 9- or 10-member carbon ring(s) and particularly those having a 3-, 4-, 5-, 6- or 7-member ring(s). The carbon rings in cycloalkenyl groups can also carry alkyl groups. Cycloalkenyl groups can include bicyclic and tricyclic alkenyl groups. Alkenyl groups are optionally substituted. Substituted alkenyl groups include among others those which are substituted with alkyl or aryl groups, which groups in turn can be optionally substituted. Specific alkenyl groups include ethenyl, prop-1-enyl, prop-2-enyl, cycloprop-1-enyl, but-1-enyl, but-2-enyl, cyclobut-1-enyl, cyclobut-2-enyl, pent-1-enyl, pent-2-enyl, branched pentenyl, cyclopent-1-enyl, hex-1-enyl, branched hexenyl, cyclohexenyl, all of which are optionally substituted. Substituted alkenyl groups include fully halogenated or semihalogenated alkenyl groups, such as alkenyl groups having one or more hydrogens replaced with one or more fluorine atoms, chlorine atoms, bromine atoms and/or iodine atoms. Substituted alkenyl groups include fully fluorinated or semifluorinated alkenyl groups, such as alkenyl groups having one or more hydrogen atoms replaced with one or more fluorine atoms. Compositions of some embodiments of the invention comprise alkenyl groups as terminating groups, such as polymer backbone terminating groups and/or polymer side chain terminating groups.

Aryl groups include groups having one or more 5-, 6- 7-, or 8-member aromatic rings, including heterocyclic aromatic rings. The term heteroaryl specifically refers to aryl groups having at least one 5-, 6- 7-, or 8-member heterocyclic aromatic rings. Aryl groups can contain one or more fused aromatic rings, including one or more fused heteroaromatic rings, and/or a combination of one or more aromatic rings and one or more nonaromatic rings that may be fused or linked via covalent bonds. Heterocyclic aromatic rings can include one or more N, O, or S atoms in the ring. Heterocyclic aromatic rings can include those with one, two or three N atoms, those with one or two O atoms, and those with one or two S atoms, or combinations of one or two or three N, O or S atoms. Aryl groups are optionally substituted. Substituted aryl groups include among others those that are substituted with alkyl or alkenyl groups, which groups in turn can be optionally substituted. Specific aryl groups include phenyl, biphenyl groups, pyrrolidinyl, imidazolidinyl, tetrahydrofuryl, tetrahydrothienyl, furyl, thienyl, pyridyl, quinolyl, isoquinolyl, pyridazinyl, pyrazinyl, indolyl, imidazolyl, oxazolyl, thiazolyl, pyrazolyl, pyridinyl, benzoxadiazolyl, benzothiadiazolyl, and naphthyl groups, all of which are optionally substituted. Substituted aryl groups include fully halogenated or semihalogenated aryl groups, such as aryl groups having one or more hydrogens replaced with one or more fluorine atoms, chlorine atoms, bromine atoms and/or iodine atoms. Substituted aryl groups include fully fluorinated or semifluorinated aryl groups, such as aryl groups having one or more hydrogens replaced with one or more fluorine atoms. Aryl groups include, but are not limited to, aromatic group-containing or heterocylic aromatic group-containing groups corresponding to any one of the following: benzene, naphthalene, naphthoquinone, diphenylmethane, fluorene, anthracene, anthraquinone, phenanthrene, tetracene, tetracenedione, pyridine, quinoline, isoquinoline, indoles, isoindole, pyrrole, imidazole, oxazole, thiazole, pyrazole, pyrazine, pyrimidine, purine, benzimidazole, furans, benzofuran, dibenzofuran, carbazole, acridine, acridone, phenanthridine, thiophene, benzothiophene, dibenzothiophene, xanthene, xanthone, flavone, coumarin, azulene or anthracycline. As used herein, a group corresponding to the groups listed above expressly includes an aromatic or heterocyclic aromatic group, including monovalent, divalent and polyvalent groups, of the aromatic and heterocyclic aromatic groups listed herein are provided in a covalently bonded configuration in the compounds of the invention at any suitable point of attachment. In embodiments, aryl groups contain between 5 and 30 carbon atoms. In embodiments, aryl groups contain one aromatic or heteroaromatic six-member ring and one or more additional five- or six-member aromatic or heteroaromatic ring. In embodiments, aryl groups contain between five and eighteen carbon atoms in the rings. Aryl groups optionally have one or more aromatic rings or heterocyclic aromatic rings having one or more electron donating groups, electron withdrawing groups and/or targeting ligands provided as substituents. Compositions of some embodiments of the invention comprise aryl groups as terminating groups, such as polymer backbone terminating groups and/or polymer side chain terminating groups.

Arylalkyl groups are alkyl groups substituted with one or more aryl groups wherein the alkyl groups optionally carry additional substituents and the aryl groups are optionally substituted. Specific alkylaryl groups are phenyl-substituted alkyl groups, e.g., phenylmethyl groups. Alkylaryl groups are alternatively described as aryl groups substituted with one or more alkyl groups wherein the alkyl groups optionally carry additional substituents and the aryl groups are optionally substituted. Specific alkylaryl groups are alkyl-substituted phenyl groups such as methylphenyl. Substituted arylalkyl groups include fully halogenated or semihalogenated arylalkyl groups, such as arylalkyl groups having one or more alkyl and/or aryl groups having one or more hydrogens replaced with one or more fluorine atoms, chlorine atoms, bromine atoms and/or iodine atoms. Compositions of some embodiments of the invention comprise arylalkyl groups as terminating groups, such as polymer backbone terminating groups and/or polymer side chain terminating groups.

As to any of the groups described herein which contain one or more substituents, it is understood that such groups do not contain any substitution or substitution patterns which are sterically impractical and/or synthetically non-feasible. In addition, the compounds of this invention include all stereochemical isomers arising from the substitution of these compounds. Optional substitution of alkyl groups includes substitution with one or more alkenyl groups, aryl groups or both, wherein the alkenyl groups or aryl groups are optionally substituted. Optional substitution of alkenyl groups includes substitution with one or more alkyl groups, aryl groups, or both, wherein the alkyl groups or aryl groups are optionally substituted. Optional substitution of aryl groups includes substitution of the aryl ring with one or more alkyl groups, alkenyl groups, or both, wherein the alkyl groups or alkenyl groups are optionally substituted.

Optional substituents for any alkyl, alkenyl and aryl group includes substitution with one or more of the following substituents, among others:
halogen, including fluorine, chlorine, bromine or iodine;
pseudohalides, including —CN;
—COOR where R is a hydrogen or an alkyl group or an aryl group and more specifically where R is a methyl, ethyl, propyl, butyl, or phenyl group all of which groups are optionally substituted;
—COR where R is a hydrogen or an alkyl group or an aryl group and more specifically where R is a methyl, ethyl, propyl, butyl, or phenyl group all of which groups are optionally substituted;
—CON(R)₂ where each R, independently of each other R, is a hydrogen or an alkyl group or an aryl group and more specifically where R is a methyl, ethyl, propyl, butyl, or phenyl group all of which groups are optionally substituted; and where R and R can form a ring which can contain one or more double bonds and can contain one or more additional carbon atoms;
—OCON(R)₂ where each R, independently of each other R, is a hydrogen or an alkyl group or an aryl group and more specifically where R is a methyl, ethyl, propyl, butyl, or phenyl group all of which groups are optionally substituted; and where R and R can form a ring which can contain one or more double bonds and can contain one or more additional carbon atoms;
—N(R)₂ where each R, independently of each other R, is a hydrogen, or an alkyl group, or an acyl group or an aryl group and more specifically where R is a methyl, ethyl, propyl, butyl, phenyl or acetyl group, all of which are optionally substituted; and where R and R can form a ring which can contain one or more double bonds and can contain one or more additional carbon atoms;
—SR, where R is hydrogen or an alkyl group or an aryl group and more specifically where R is hydrogen, methyl, ethyl, propyl, butyl, or a phenyl group, which are optionally substituted;
—SO₂R, or —SOR where R is an alkyl group or an aryl group and more specifically where R is a methyl, ethyl, propyl, butyl, or phenyl group, all of which are optionally substituted;
—OCOOR where R is an alkyl group or an aryl group;
—SO₂N(R)₂ where each R, independently of each other R, is a hydrogen, or an alkyl group, or an aryl group all of which are optionally substituted and wherein R and R can form a ring which can contain one or more double bonds and can contain one or more additional carbon atoms; and
—OR where R is H, an alkyl group, an aryl group, or an acyl group all of which are optionally substituted. In a particular example R can be an acyl yielding —OCOR″ where R″ is a hydrogen or an alkyl group or an aryl group and more specifically where R″ is methyl, ethyl, propyl, butyl, or phenyl groups all of which groups are optionally substituted.

Specific substituted alkyl groups include haloalkyl groups, particularly trihalomethyl groups and specifically trifluoromethyl groups. Specific substituted aryl groups include mono-, di-, tri, tetra- and pentahalo-substituted phenyl groups; mono-, di-, tri-, tetra-, penta-, hexa-, and hepta-halo-substituted naphthalene groups; 3- or 4-halo-substituted phenyl groups, 3- or 4-alkyl-substituted phenyl groups, 3- or 4-alkoxy-substituted phenyl groups, 3- or 4-RCO-substituted phenyl, 5- or 6-halo-substituted naphthalene groups. More specifically, substituted aryl groups include acetylphenyl groups, particularly 4-acetylphenyl groups; fluorophenyl groups, particularly 3-fluorophenyl and 4-fluorophenyl groups; chlorophenyl groups, particularly 3-chlorophenyl and 4-chlorophenyl groups; methylphenyl groups, particularly 4-methylphenyl groups; and methoxyphenyl groups, particularly 4-methoxyphenyl groups.

As to any of the above groups which contain one or more substituents, it is understood that such groups do not contain any substitution or substitution patterns which are sterically impractical and/or synthetically non-feasible.

Many of the molecules disclosed herein contain one or more ionizable groups. Ionizable groups include groups from which a proton can be removed (e.g., —COOH) or added (e.g., amines) and groups that can be quaternized (e.g., amines). All possible ionic forms of such molecules and salts thereof are intended to be included individually in the disclosure herein. With regard to salts of the compounds herein, one of ordinary skill in the art can select from among a wide variety of available counterions that are appropriate for preparation of salts of this invention for a given application. In specific applications, the selection of a given anion or cation for preparation of a salt can result in increased or decreased solubility of that salt.

The compounds of this invention can contain one or more chiral centers. Accordingly, this invention is intended to include racemic mixtures, diastereomers, enantiomers, tautomers and mixtures enriched in one or more stereoisomer. The scope of the invention as described and claimed encompasses the racemic forms of the compounds as well as the individual enantiomers and non-racemic mixtures thereof.

As used herein, the term “isomers” refers to compounds having the same number and kind of atoms, and hence the same molecular weight, but differing in respect to the structural arrangement or configuration of the atoms.

The term “tautomer,” as used herein, refers to one of two or more structural isomers which exist in equilibrium and which are readily converted from one isomeric form to another.

Unless otherwise stated, structures depicted herein are also meant to include all stereochemical forms of the structure; i.e., the R and S configurations for each asymmetric center. Therefore, single stereochemical isomers as well as enantiomeric and diastereomeric mixtures of the present compounds are within the scope of the invention.

Unless otherwise stated, structures depicted herein are also meant to include compounds which differ only in the presence of one or more isotopically enriched atoms. For example, compounds having the present structures except for the replacement of a hydrogen by a deuterium or tritium, or the replacement of a carbon by ¹³C- or ¹⁴C-enriched carbon are within the scope of this invention.

The compounds of the present invention may also contain unnatural proportions of atomic isotopes at one or more of the atoms that constitute such compounds. For example, the compounds may be radiolabeled with radioactive isotopes, such as for example tritium (³H), iodine-125 (¹²⁵I), or carbon-14 (¹⁴C). All isotopic variations of the compounds of the present invention, whether radioactive or not, are encompassed within the scope of the present invention.

The symbol “ [symbol] ” denotes the point of attachment of one or more chemical moieties, one or more functional groups, one or more atoms, one or more ions, an unpaired electron, or one or more other chemical species to the represented molecule, compound, or chemical formula. For example, in the formula

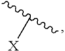

“X” represents a molecule or compound, the symbol “ [symbol] ” denotes a point of attachment of one or more chemical moieties, one or more functional groups, one or more atoms, one or more ions, an unpaired electron, or one or more other chemical species to X (where X corresponds to the represented molecule, compound, or chemical formula) via covalent bonding, wherein the covalent bonding can be any feasible covalent bond, including, but not limited to, a single bond, a double bond, or a triple bond. As an illustrative example, in the moiety

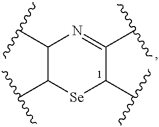 [SMILES: *C1=NC(*)C(*)[Se]C1*]

the carbon labeled “1” has point of attachment which can be a double bond to another species, such a double bond to an oxygen, or two single bonds to two independent species, such as two distinct single bonds each to a hydrogen. As another illustrative example, when two points of attachment are shown on a single atom of a molecule, such as in the moiety

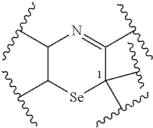 [SMILES: *C1=NC(*)C(*)[Se]C1(*)*]

where the carbon labeled “1” has two points of attachment shown, the shown points of attachment on the same single atom (e.g., carbon 1), can be interpreted as representing either a preferable embodiment of two distinct bonds to that same single atom (e.g., two hydrogens bonded to carbon 1) or an optional embodiment of a single point of attachment to said same single atom (e.g., the two points of attachment on carbon 1 can optionally be consolidated as representing one double to carbon 1, such as a double bond to oxygen). As used herein, the various functional groups represented will be understood to have a point of attachment at the functional group having the hyphen or dash (-) or a dash used in combination with an asterisk (*). In other words, in the case of —CH₂CH₂CH₃ or —CH₂CH₂CH₃, it will be understood that the point of attachment is the CH₂ group at the far left. If a group is recited without an asterisk or a dash, then the attachment point is indicated by the plain and ordinary meaning of the recited group.

Where substituent groups are specified by their conventional chemical formulae, written from left to right, they equally encompass the chemically identical substituents that would result from writing the structure from right to left, e.g., —CH₂O— is equivalent to —OCH₂—.

The term “and/or” is used herein, in the description and in the claims, to refer to a single element alone or any combination of elements from the list in which the term and/or appears. In other words, a listing of two or more elements having the term “and/or” is intended to cover embodiments having any of the individual elements alone or having any combination of the listed elements. For example, the phrase “element A and/or element B” is intended to cover embodiments having element A alone, having element B alone, or having both elements A and B taken together. For example, the phrase “element A, element B, and/or element C” is intended to cover embodiments having element A alone, having element B alone, having element C alone, having elements A and B taken together, having elements A and C taken together, having elements B and C taken together, or having elements A, B, and C taken together.

The term “±” refers to an inclusive range of values, such that “X±Y,” wherein each of X and Y is independently a number, refers to an inclusive range of values selected from the range of X−Y to X+Y. In the cases of “X±Y” wherein Y is a percentage (e.g., 1.0±20%), the inclusive range of values is selected from the range of X−Z to X+Z, wherein Z is equal to X·(Y/100). For example, 1.0±20% refers to the inclusive range of values selected from the range of 0.8 to 1.2.

In an embodiment, a composition or compound of the invention, such as an alloy or precursor to an alloy, is isolated or substantially purified. In an embodiment, an isolated or purified compound is at least partially isolated or substantially purified as would be understood in the art. In an embodiment, a substantially purified composition, compound or formulation of the invention has a chemical purity of 95%, optionally for some applications 99%, optionally for some applications 99.9%, optionally for some applications 99.99%, and optionally for some applications 99.999% pure.

### DETAILED DESCRIPTION OF THE INVENTION

In the following description, numerous specific details of the devices, device components and methods of the present invention are set forth in order to provide a thorough explanation of the precise nature of the invention. It will be apparent, however, to those of skill in the art that the invention can be practiced without these specific details.

### Overview

Adsorption materials for environmental and remediation use are growing in importance. The efficient removal and capture of greenhouse gases and chemical warfare agents are among some of the applications that have an increased demand for adsorption materials. Porous materials are often used for adsorption applications due to their large surface area and pore volume. However, many porous materials that are currently available are often not scalable, expensive and/or time consuming to synthesize, or not chemically stable. Melanin in nature has been shown to adsorb organic molecules and metals from its environment due to its hydroxyl rich functional groups. However, these materials have been limited in their adsorption due to their low surface area and pore volume. Synthesizing porous versions of melanin would allow for higher adsorption capabilities for gas and toxin capture and possible remediation due to the increase of available surface area. These materials would be advantageous against other porous materials such as zeolites and metal-organic frameworks that have been investigated for such applications due to their inexpensive production, degradable and scalable nature, and low-to-no toxicity in animal cells/tissues. We have shown that we can synthesize a porous melanin that is inexpensive, scalable, stable in aqueous conditions, and with tunable porosity. We show that we can mimic two different types of melanin; eumelanin, which mimics melanin found in humans and other animals, and allomelanin, a specific subset of which is found in fungi. The porous melanin mimics could be synthesized by using different monomers such as polydopamine and 1,8-dihydroxynapthalene, which mimic animal and fungal melanin, respectively. The size and porosity of the melanins are also tunable depending on their synthesis conditions.

To Inventors' knowledge no other synthetic porous melanins have been used toward gas, toxin, or other molecule adsorption. Other researchers have used other porous materials such as porous polymers or metal-organic frameworks for the adsorption of gases and toxins. Synthetic versions of melanin have been used in collaboration with other materials for gas and toxin adsorption, but not synthetic melanin on its own.

There is a need for materials which are biocompatible, scalable, cheap, and easy to synthesize that have the capability to adsorb gases or toxins. This could be for many applications such as gas storage, water filtration, or for protecting civilians or the military in war-torn areas where chemical warfare agents are still used. To date there are technologies such as metal organic frameworks (MOFs) which perform well at gas and toxin adsorption but they are not scalable, and they require very precise chemistries and consist of metals which might contaminate sensitive systems such as marine or farming environments. We offer materials which could potentially be used in such sensitive environments due to the fact that the materials are close mimics of natural materials and they are very easy to make.

Materials useful in aspects disclosed herein are able to synthesized on a large scale production starting from low cost and commercially available starting materials using only water and alcohol as solvents. The materials are biocompatible, completely organic, and stable in aqueous conditions, which isn't always the case with the adsorbents commercially available on the market now. The toxin and gas adsorption capabilities of the materials disclosed herein have implications for large scale usage.

Applications of aspects disclosed herein include: (1) adsorption of chemical warfare agents/nerve agents and their analogues; (2) adsorption of pesticides; (3) toxin remediation; (4) gas capture—CH₄, NH₃, CO₂, N₂ and potentially other gases; (5) organic molecule adsorption (such as dyes and toxins); and (6) waste-water remediation. The devices described herein, and associated methods using the devices, are optionally or comprise light weight, biosynthetic materials for gas separation and purification, which has major implications for the design of materials capable of a variety of commercially relevant applications, including but not limited to: removal of CO₂ from gas streams; removal of toxic gases (e.g., NH₃) from air, with applications in industry, chemical plants, and military use; storage of useful gases for transport and rapid delivery in a solid state device; removal of toxins from the air with applications in a variety of civilian and military applications; and breathable but selective capture materials, which can have a serious impact on the design of advanced bio and chemical hazard protective clothing.

Advantages of aspects disclosed herein include: (1) scalable; (2) tunable porosity; (3) tunable size; (4) few starting materials; (5) inexpensive starting materials; (6) templation method amenable to many different melanin monomers; (7) biocompatible; (8) stable in aqueous conditions over time; (9) metal-free.

Non-limiting technical description of aspects included herein:

### Gas and Toxin Adsorption in Polydopamine-Based Synthetic Eumelanin:

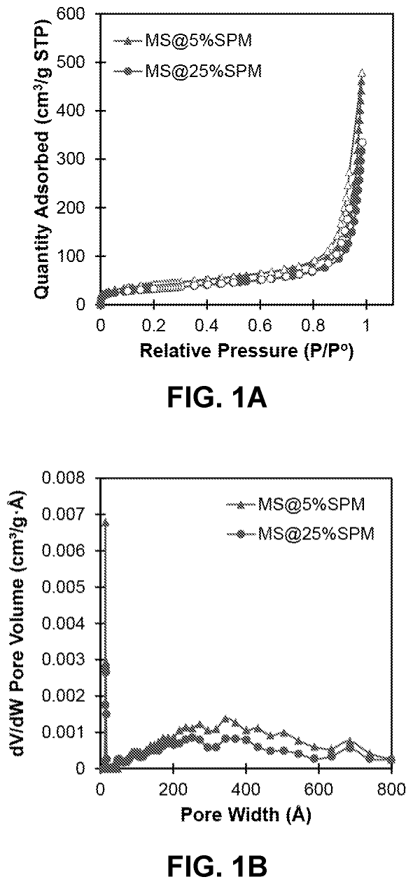

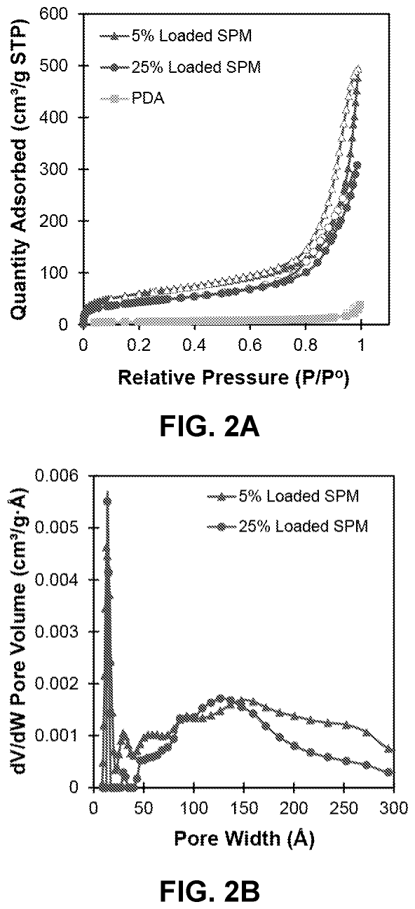

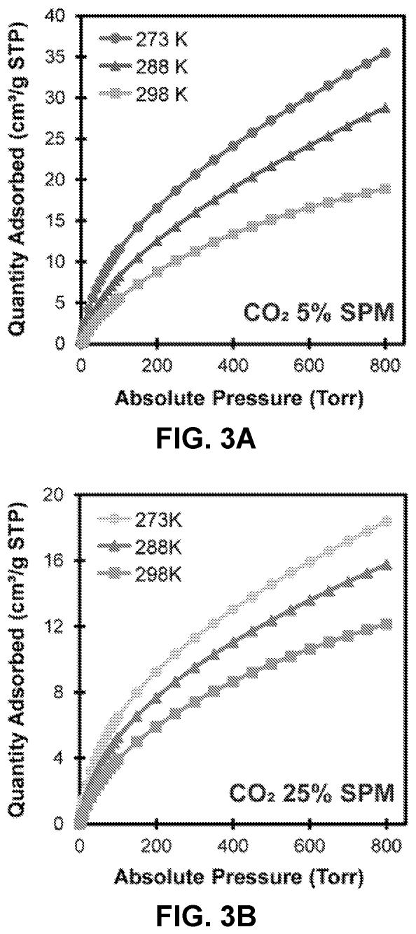

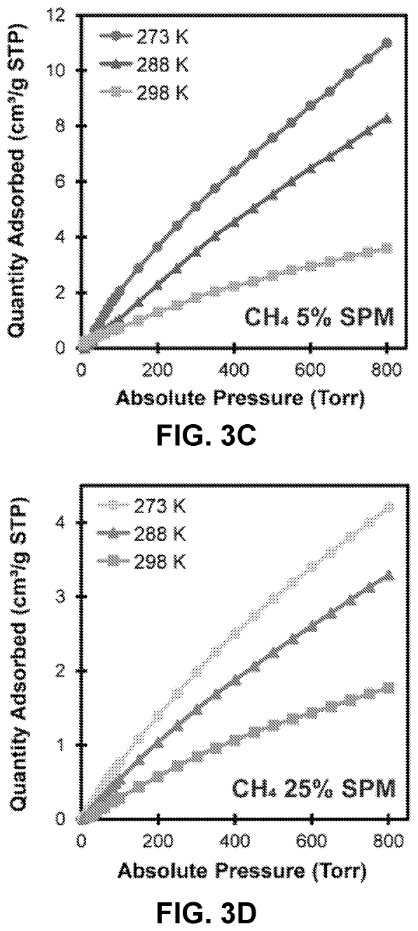

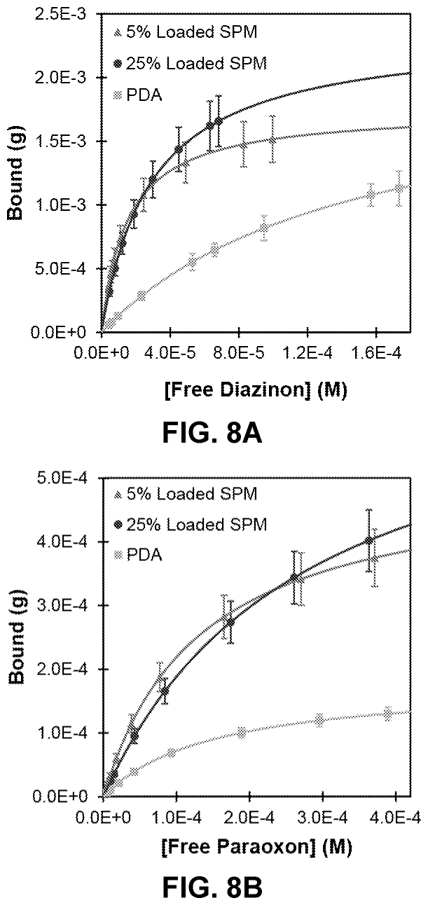

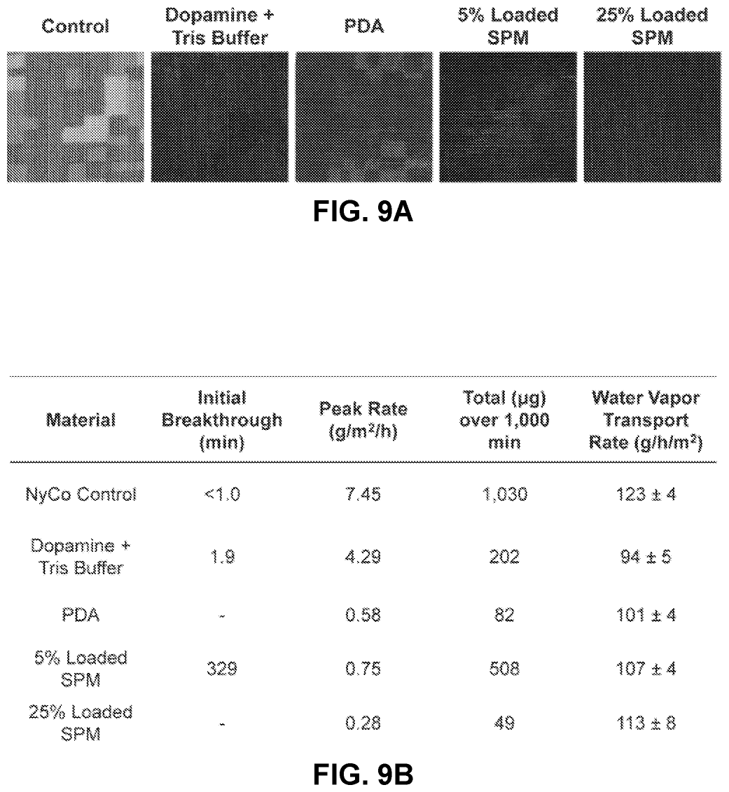

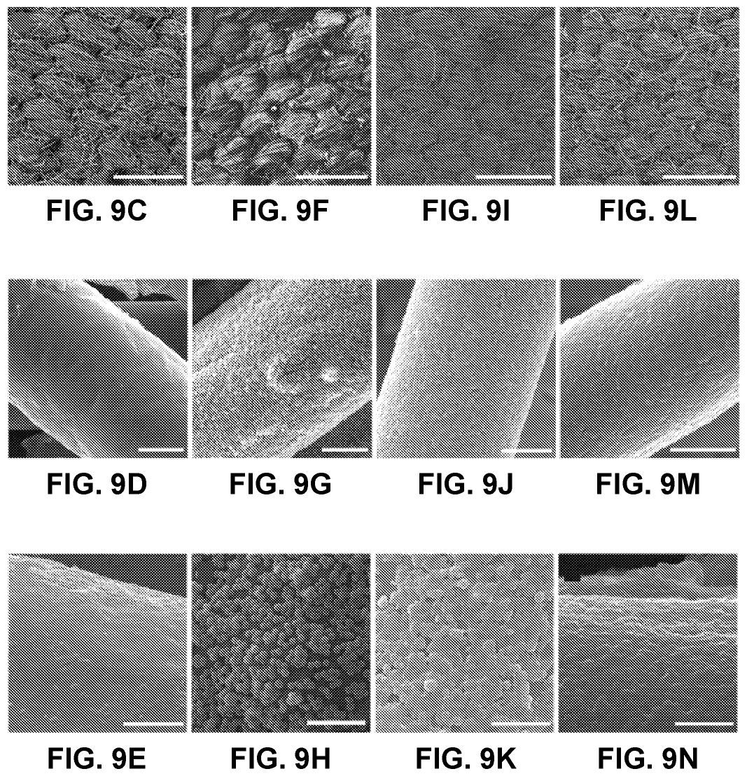

In a non-limiting exemplary aspect, porous Melanin (SPM) is synthesized through a templating strategy. A mesoporous silica (MS) template was coated with polydopamine through the oxidative polymerization of dopamine (MS@SPM). The MS template was then removed through an acid etch leaving only the polydopamine. Depending on the polymerization time, different loadings of polydopamine could be achieved. Longer polymerization times led to higher quantities of polydopamine coated onto and in the silica template and therefore higher loadings, which was evident by the mass of polydopamine remaining after etching as well as the nitrogen isotherms of the coated particles before etching, which decreased after coating. Two types of synthetic porous melanin were made in this manner: a four-hour polymerized, 5% Loaded SPM and a 21-hour polymerized, 25% Loaded SPM. Nitrogen isotherms were taken to probe the porosity and surface of 5% and 25% Loaded SPM before etching (FIGS. 1A-1B) and after etching (FIGS. 2A-2B). The samples were first activated using liquid CO₂ and then nitrogen sorption at 77K was measured (FIGS. 1A and 2A). Brunauer-Emmett-Teller (BET) area of the solid PDA used as a control was 20 m²/g. Meanwhile, The BET areas of 5% and 25% Loaded SPM were 140 and 100 m²/g before etching (MS@5% SPM and MS@25% SPM) and 215 and 140 m²/g after etching, respectively. Pore-size distributions were obtained using density functional theory (DFT) (FIGS. 1B and 2B). The total pore volume of PDA was 0.02 cm³/g, 0.33 cm³/g for 5% Loaded SPM and 0.30 cm³/g for 25% Loaded SPM. Further gas adsorptions studies were done with CO₂, CH₄, and H₂ at 273 K, 288 K, and 298 K, and ammonia at 298 K (FIGS. 3A-3D, 4A-4B, 5, 6A-6D and 7). Toxin adsorptions studies were done in solution with organophosphate pesticides diazinon and paraoxon to simulate the adsorption of nerve gas agents (FIGS. 8A-8B). Additionally, dimethyl methylphosphonate (DMMP) breakthrough studies were conducted with SPM and MNP coated nylon-cotton (NyCo or NYCO) fabrics (FIGS. 9A-9N, 10 and 11).

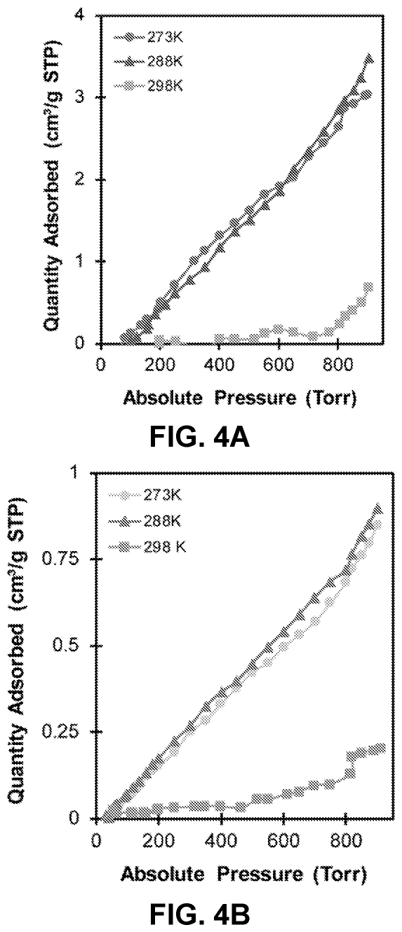

Owing to the functionalized surface of the SPM, we performed uptake studies of CO₂ and CH₄ to discern if SPM would be a good candidate for their storage and separation (FIGS. 3A-3D). Adsorption isotherms of CO₂ and CH₄ were recorded at 273, 283, and 298 K. The CO₂ uptake of the 5% Loaded SPM (FIG. 3A) was 35.5, 28.8, and 18.9 cm³/g at 273, 283, and 298 K, respectively. For the 25% Loaded SPM the CO₂ uptake (FIG. 3B) was 18.4, 15.8, and 12.2 cm³/g at 273, 283, and 298 K, respectively. The 5% Loaded SPM CH₄ uptake (FIG. 3C) was 11.0, 8.3, and 3.6 cm³/g, and for 25% Loaded SPM the uptake (FIG. 3D) was 4.2, 3.3, and 1.8 cm³/g at 273, 288, 298 K, respectively. The uptake values for both SPM particles for CO₂ and CH₄ decreased with increasing temperature indicating physisorption. However, the CH₄ uptake was much lower than the CO₂ uptake for both 5% and 25% SPM. Unlike CO₂, methane does not have a quadruple moment, so adsorption is directed by pore size rather than molecular interaction. The low methane adsorption suggests SPM could preferentially uptake CO₂ over CH₄. H₂ adsorption isotherms were also performed at 273, 283, and 298 K, but SPM showed negligible adsorption, which is not uncommon for a material with a large proportion of mesopores (FIGS. 4A-4B).

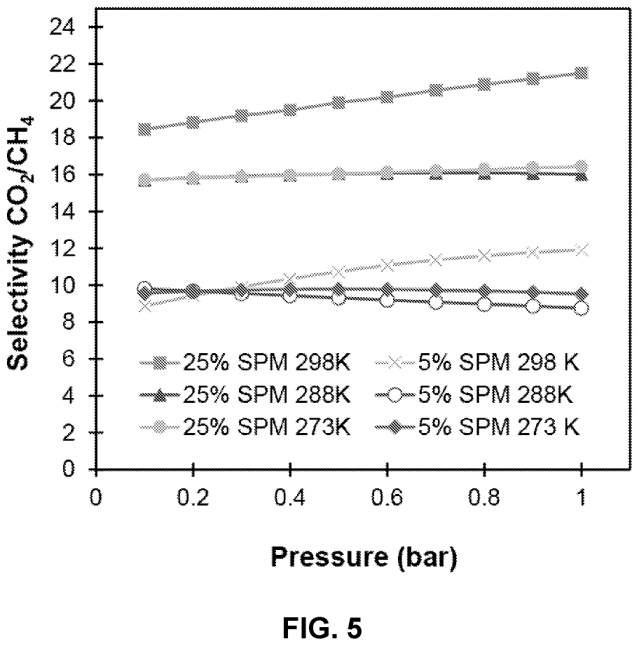

The higher adsorption of CO₂ compared to CH₄, which derives from the intermolecular interactions, as seen by CO₂ and CH₄ isotherms, led us to investigate the efficacy of this material for CO₂ capture in natural gas. Therefore, we calculated the of selectivities of CO₂ vs CH₄ in SPM and PDA nanoparticles using ideal adsorption solution theory (IAST). We probed gas phase mole fractions of 0.05 CO₂ and 0.95 CH₄, which is a typical composition found for natural gas purification. Isotherms were fit using a BET model with the Python package pyIAST. Both 5% and 25% Loaded SPM showed selectivity for CO₂ over CH₄ (FIG. 5). The 25% Loaded SPM showed higher selectivity (16-22 at 1 bar) than 5% Loaded SPM (9-12 at 1 bar).

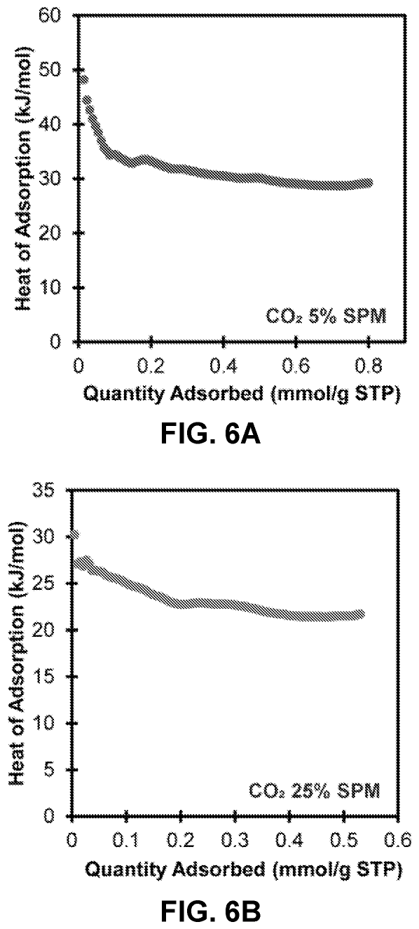

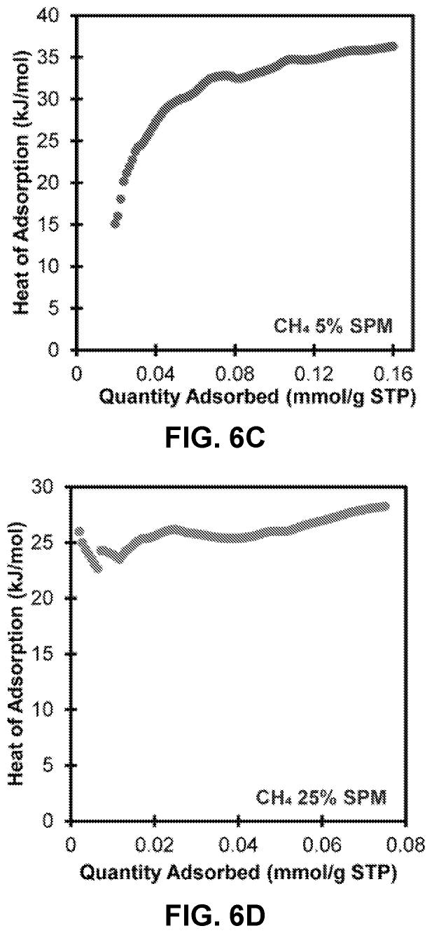

To further elucidate the interaction between CO₂ and CH₄ gases and SPM, we calculated isosteric heats of adsorption (Qst) using the Clausius-Clapeyron equation from the isotherms collected at 273, 288, and 298 K (FIGS. 6A-6D). The Qst of 5% Loaded SPM was 48.2 kJ/mol for CO₂ and 15.1 kJ/mol for CH₄ (FIGS. 6A and 6C), and the Qst of 25% Loaded SPM was 30.3 kJ/mol for CO₂ and 26.0 kJ/mol for CH₄ (FIGS. 6B and 6D). The higher Qst for CO₂ for both SPM particles corroborates the CO₂ over CH₄ selectivity.

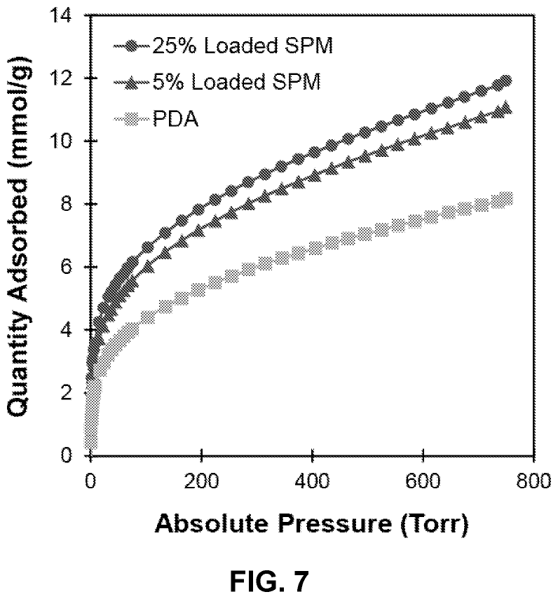

Given SPM's rich adsorption chemistry and abundance of catechol groups, ammonia adsorption isotherms were also performed at 298 K for 25% Loaded SPM, 5% Loaded SPM, and solid PDA (FIG. 7). Synthetic Porous Melanin had high uptake of ammonia of 11.1 and 11.9 mmol/g for 5% and 25% Loaded SPM at 750 Torr, or 1 bar, respectively. As all the polydopamine-derived particles studied herein possess similar surface chemistry, the higher ammonia uptake for SPM compared to the non-porous PDA (8.2 mmol/g at 750 Torr) was attributed to the increase in surface area. In contrast to this surface area trend, we believe that the 25% SPM outperformed the 5% SPM due to an increase in catechol concentration and adsorption sites present deriving from the increased polymer content. Notably, the sharp uptake at low pressures indicates a strong interaction between NH₃ molecules and the functionalized binding sites on these PDA-based materials.

Due to the high SPM's surface area and binding affinity, the uptake of chemical warfare agent (CWA) simulants was investigated (FIGS. 8A-8B, 9A-9N, 10 and 11). Adsorption of the organophosphate pesticides diazinon (FIG. 8A) and paraoxon (FIG. 8B) was performed with 5% and 25% SPM and PDA nanoparticles to simulate the adsorption of nerve gas agents. Target solutions at varied concentrations of paraozon and diazinon were prepared and the melanin materials were added and mixed for 2 hours before the solutions were filtered with a PTFE syringe filter. The remaining target in solution was analyzed using HPLC. The resulting data was fit using the Langmuir isotherm to generate the saturation loading for the materials in gram/gram and an affinity coefficient (1/M). For diazinon the saturation loading was 44.1, 59.9, and 51.1 g/g and the affinity was 66,200; 34,290; and 6,750 M⁻¹ for 5% Loaded SPM, 25% Loaded SPM, and PDA, respectively. For paraoxon the saturation loading was 12.9, 17.9, and 4.4 g/g and the affinity was 7,550, 3,630, and 6,589 M⁻¹ for 5% Loaded SPM, 25% Loaded SPM, and PDA, respectively. The saturation loading for both paraoxon and diazinon was highest for the 25% Loaded SPM particles and the affinity was highest for 5% Loaded SPM particles.

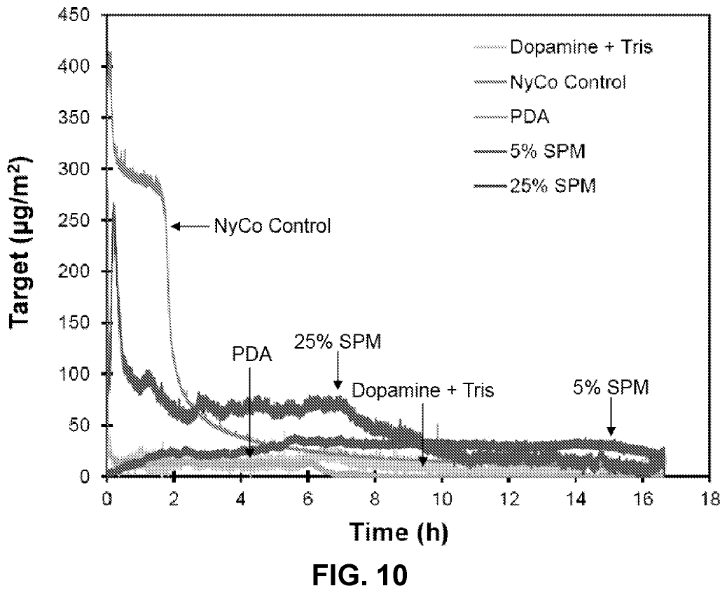

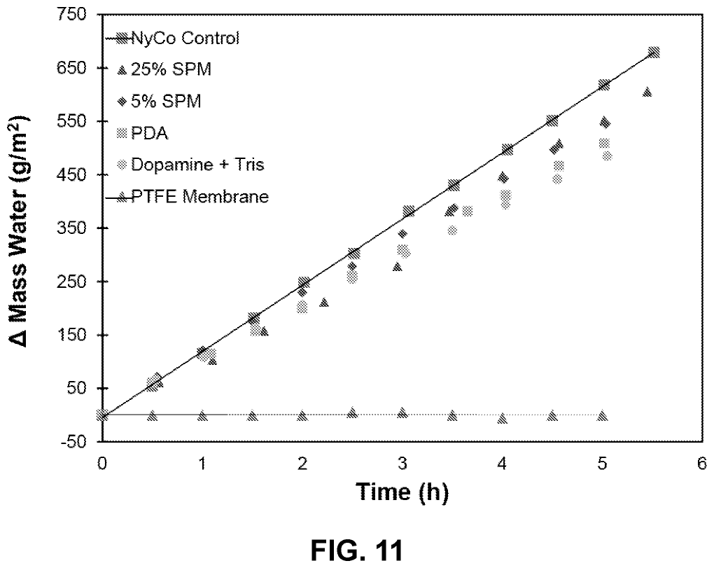

Additionally studies on the adsorption of dimethyl methylphosphonate (DMMP), a simulant for sarin, were initiated on SPM and PDA coated textiles (FIGS. 9A-9N and 10). A method to efficiently adsorb sarin is critical as it is difficult to detect because it is a colorless and odorless compound. DMMP breakthrough studies on PDA and SPM coated nylon-cotton (NyCo) blended fabric were completed toward the development of a filter system utilizing SPM (FIG. 9A). NyCo was evenly coated via two methods. One involved polymerizing dopamine in tris buffer (dopamine+tris buffer) in the presence of the fabric (FIGS. 9C-9E). The others involved the deposition of solid PDA, 5% Loaded SPM, or 25% Loaded SPM (FIGS. 9F-9N) onto the NyCo fabric. All of the coated fabrics had a high water vapor transport rate comparable to that of the unmodified NyCo, indicating the fabrics are still breathable after coating (FIG. 11). DMMP breakthrough experiments were conducted using a concentration of 5 mg/m³. The unmodified NyCo control, the dopamine+tris buffer treated fabric, and 5% SPM all exhibited a breakthrough of DMMP. However, the 5% SPM coated fabric was able to significantly extend the time to initial breakthrough compared to the control NyCo fabric. With these three samples, while DMMP passed through over 1,000 minutes, the composite materials were able to minimize the total amount of DMMP recovered (FIGS. 9B and 10). In contrast, 25% Loaded SPM and PDA nanoparticles were able to retain DMMP with no breakthrough above the 5 mg/m³ and minimal DMMP accumulating during the 1,000-minute experiment: 49 μg for 25% SPM and 82 μg for PDA. The different adsorption capabilities of 5% and 25% Loaded SPM reveal a tunable system that can be optimized based on the targeted material of adsorption.

### Gas and Toxin Adsorption in 1,8-Dihydroxynaphthalene (1,8-DHN)-Based Synthetic Allomelanin:

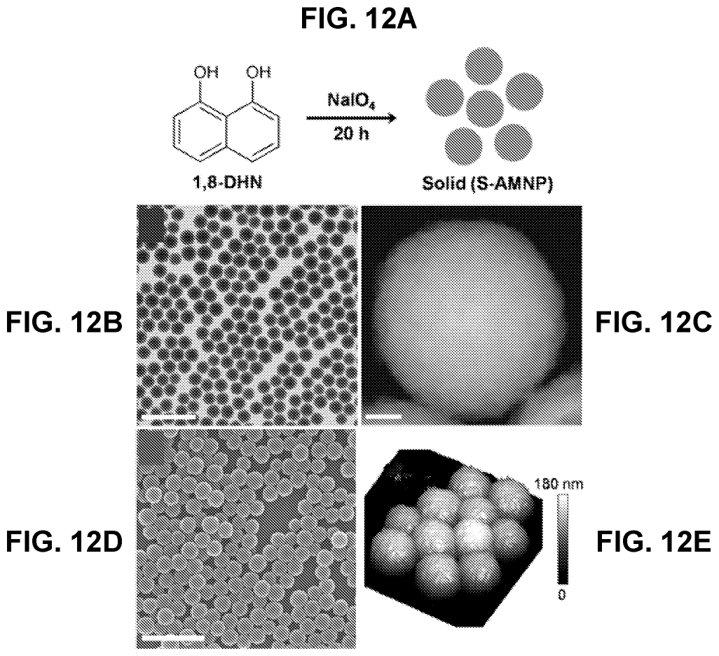

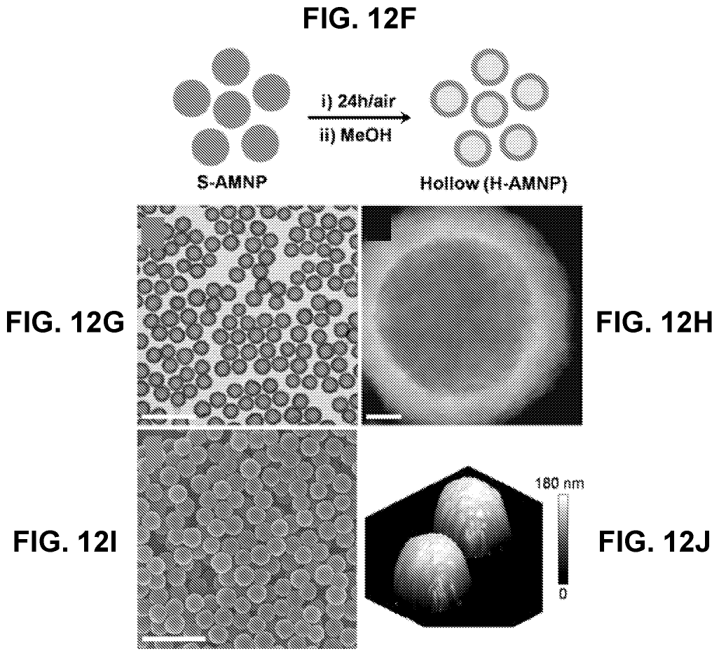

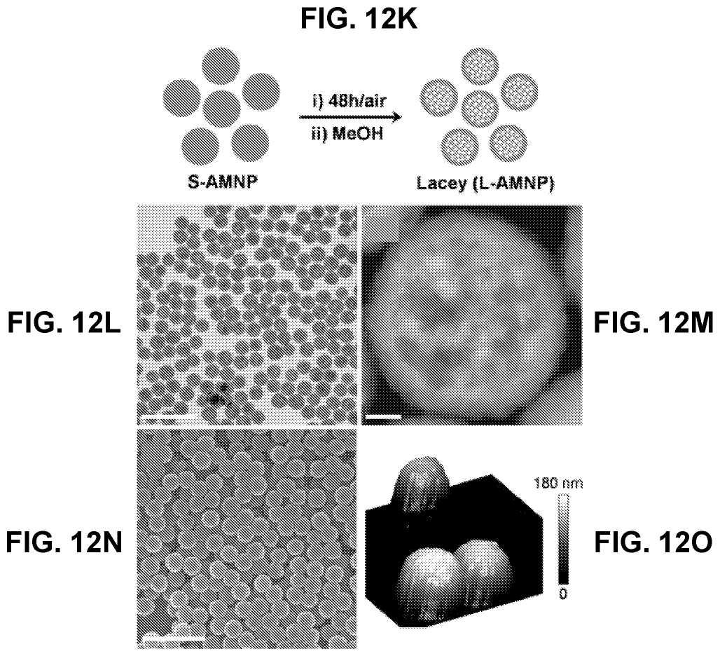

Three different types of allomelanin-mimicking particles were synthesized. These are termed Solid (or “S-AMNP”) (FIGS. 12A-12E), Hollow (or “H-AMNP”) (FIGS. 12F-12J), and Lacey (or “L-AMNP) (FIGS. 12K-12O) due to their morphological appearance via bright-field scanning transmission electron microscopy (BF-STEM) (FIG. 12B, FIG. 12G, and FIG. 12L, respectively). For example, the term “solid” in reference to melanin particles refers to melanin particles that appear substantially fully filled (substantially without holes or voids), non-hollow, and non-lacey, and optionally uniform, when viewed using BF-STEM—The particles were also characterized via high-angle annular dark-field STEM (HAADF-STEM) (FIG. 12C), scanning electron microscopy (SEM) (FIG. 12D) and atomic force microscopy (AFM) (FIG. 12E).

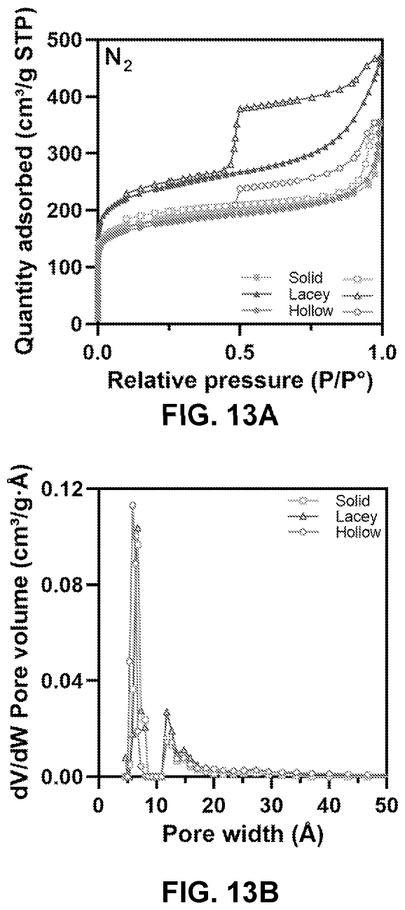

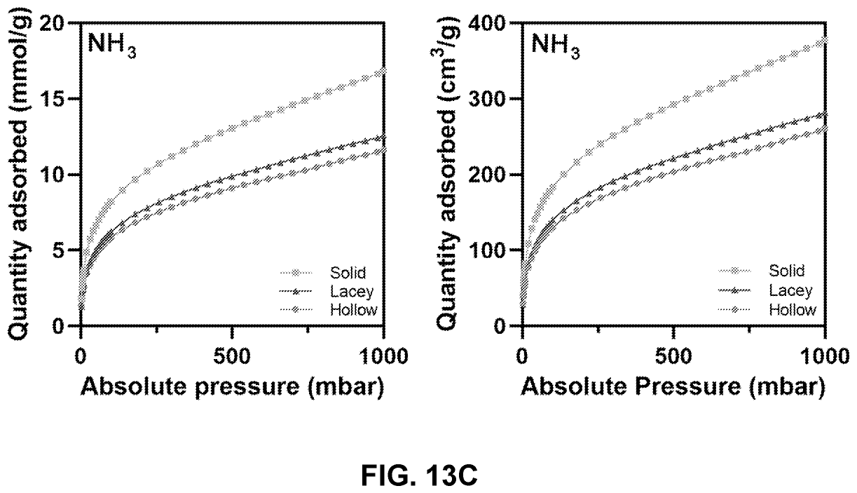

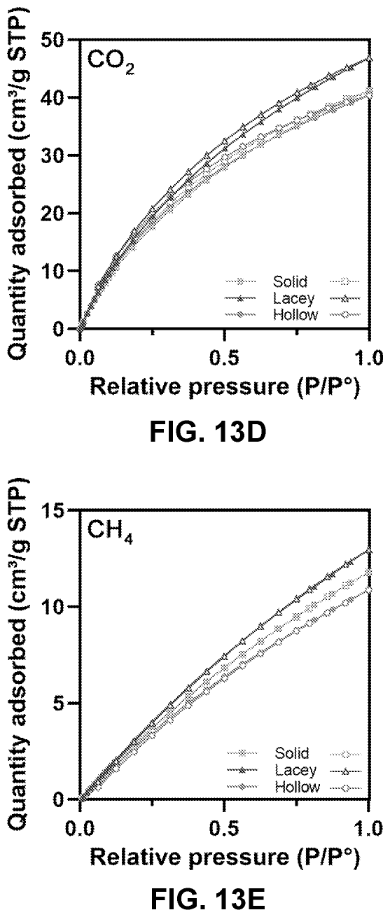

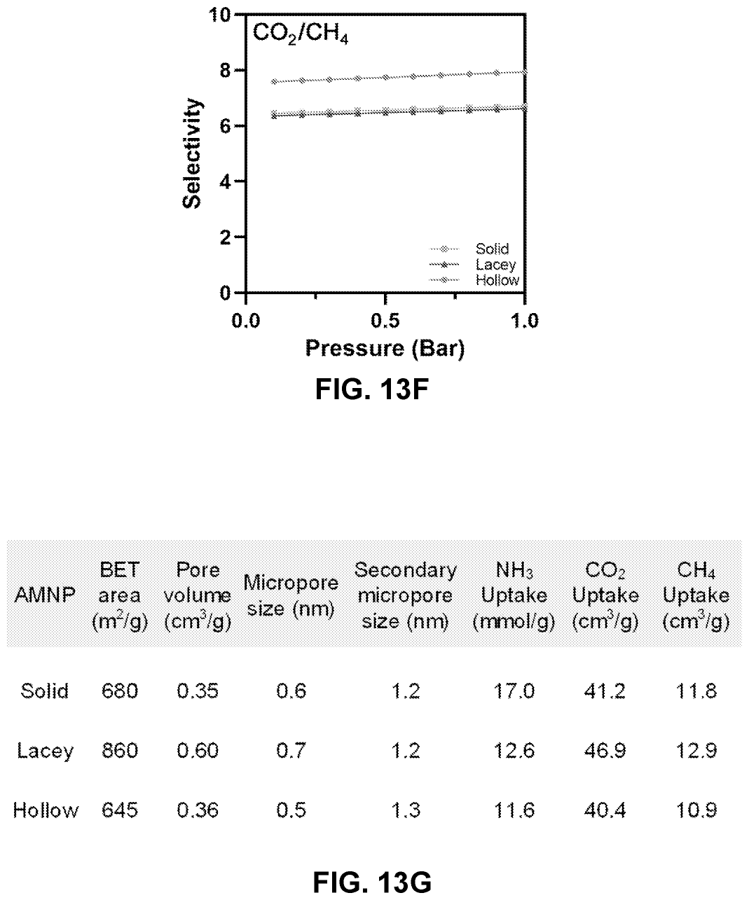

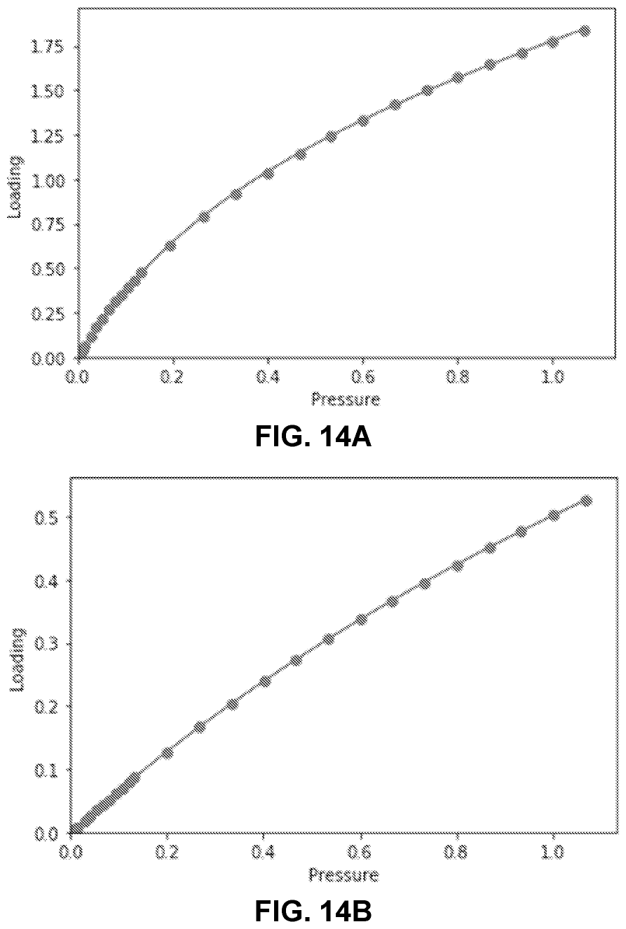

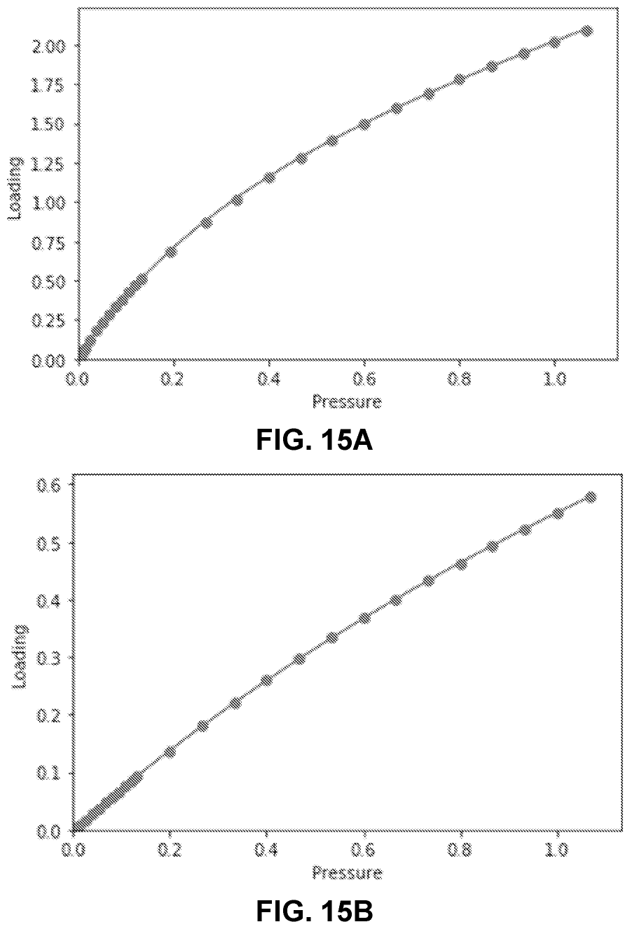

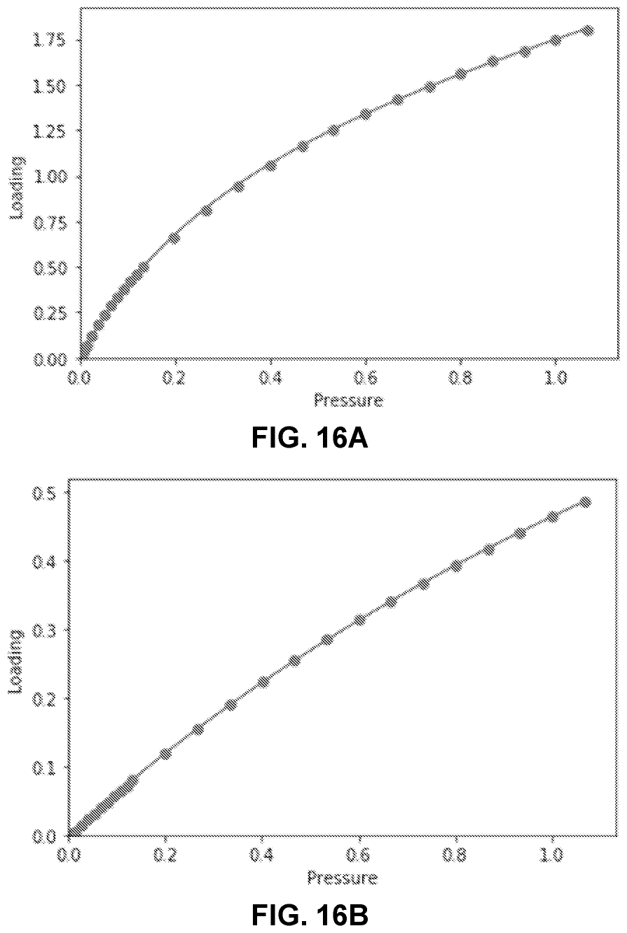

To assess the porosity of AMNPs, we performed several sorption and related measurements (FIGS. 13A-13G). Nitrogen physisorption measurements were performed at 77 K (FIG. 13A). The particles were first activated using supercritical CO₂, a milder method for solvent removal than thermal activation, before measurements and showed no visible morphological changes before and after measurements. Results show that AMNPs are not only inherently porous, but they can also be tuned to further increase the porosity Nitrogen isotherms revealed Brunauer-Emmett-Teller (BET) areas of 680 m²/g for S-AMNPs, 645 m²/g for H-AMNPs, and 860 m²/g for L-AMNPs. DFT calculations showed two major pores of around 6 Å and 12 Å for all AMNPs (FIG. 13B), although L-AMNP pore volume (0.60 cm³/g) was significantly higher than for S- (0.35 cm³/g) or H- (0.36 cm³/g) AMNPs which is consistent with the larger voids seen via HAADF-STEM. We hypothesized that due to the —OH groups present on the surface of the porous AMNPs, these materials would be promising for ammonia capture and/or storage. Therefore, we conducted ammonia isotherms at 298 K. The ammonia isotherms (FIG. 13C) showed steep and high uptakes at lower pressures arising from strong interactions between the AMNPs and NH₃, which indicates that these materials would be promising for air filtration applications. At 1 bar, NH₃ uptakes for the S-, L-, and H-AMNPs were 17 mmol/g, 12.6 mmol/g, and 11.6 mmol/g, respectively. The high capacity of AMNPs for NH3 suggests they could be utilized in ammonia storage applications. These porous materials have comparable performances in total uptake at 1 bar to metal-organic frameworks and porous organic polymers. To probe the efficacy of AMNPs for gas storage and separation applications, CO₂ (FIG. 13D) and CH₄ (FIG. 13E) isotherms were collected at 298 K. Total uptakes are higher overall for CO₂ (S-AMNP=41.2 cm³/g, L-AMNP=46.9 cm³/g, and H-AMNP=40.4 cm³/g) compared to CH₄ (S-AMNP=11.8 cm³/g, L-AMNP=12.9 cm³/g, and H-AMNP=10.9 cm³/g). To determine whether the AMNPs could be utilized for carbon dioxide separation from natural gas, having predominantly of methane, we quantified their selectivity through the application of ideal adsorbed solution theory (IAST) on the pure gas isotherms fitted using BET model (FIG. 13F, FIGS. 14A-14B, 15A-15B and 16A-16B). Using gas phase mole fractions of 0.05 for CO₂ and 0.95 for CH₄, which is a typical composition found for natural gas purification, IAST-predicted selectivities ranging from 6-8 were obtained. The high selectivities indicated that CO₂ was preferentially adsorbed over CH₄. Measurements are summarized in FIG. 13G.

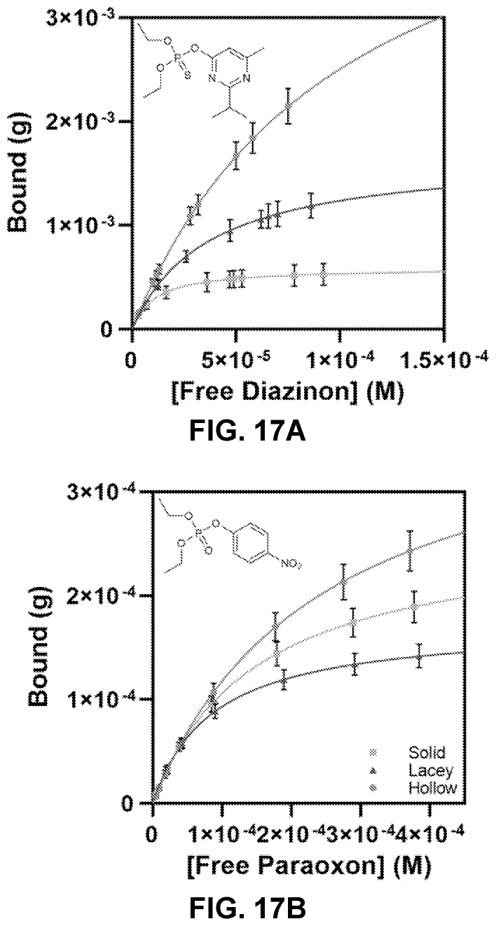

Given the high porosity of AMNPs and success with ammonia capture, we aimed to test whether they could serve as toxin remediation agents (FIGS. 17A-17B) upon exposure to diazinon (FIG. 17A) and paraoxon (FIG. 17B), which are common pesticides and are used as analogues for structurally similar chemical warfare agents. A known mass of AMNP (10, 20, or 40 μg±1 μg) was incubated with either diazinon or paraoxon for 2 h after which the solution was filtered using a 0.2 μm PTFE syringe filter. Analysis of the target remaining in the sample was performed by HPLC and the resulting data was fit using the Langmuir isotherm to generate the saturation loading for the materials in grams/gram and an affinity coefficient (1/M). Binding data suggests that L-AMNP are more efficient at binding diazinon than S-AMNP, but not paraoxon. Surprisingly, despite H-AMNPs having similar surface areas to S-AMNPs, they are capable of binding both diazinon and paraoxon better than S- or L-AMNPs. This suggests that surface area is not the only parameter important for toxin binding and corroborates the data seen in the ammonia isotherms. These measurements are summarized in Table 1.

TABLE 1
Saturation loading and affinity of S-, L-,
and H-AMNP for diazinon and paraoxon.

| | Diazinon | | Paraoxon | |
|---|---|---|---|---|
| | Saturation | Affinity | Saturation | Affinity |
| Nanoparticle | Loading (g/g) | (M⁻¹) | Loading (g/g) | (M⁻¹) |
| S-AMNP | 14.5 | 91,305 | 6.5 | 6,698 |
| L-AMNP | 41.4 | 27,310 | 4.2 | 11,658 |
| H-AMNP | 124 | 9,739 | 9.8 | 4,162 |

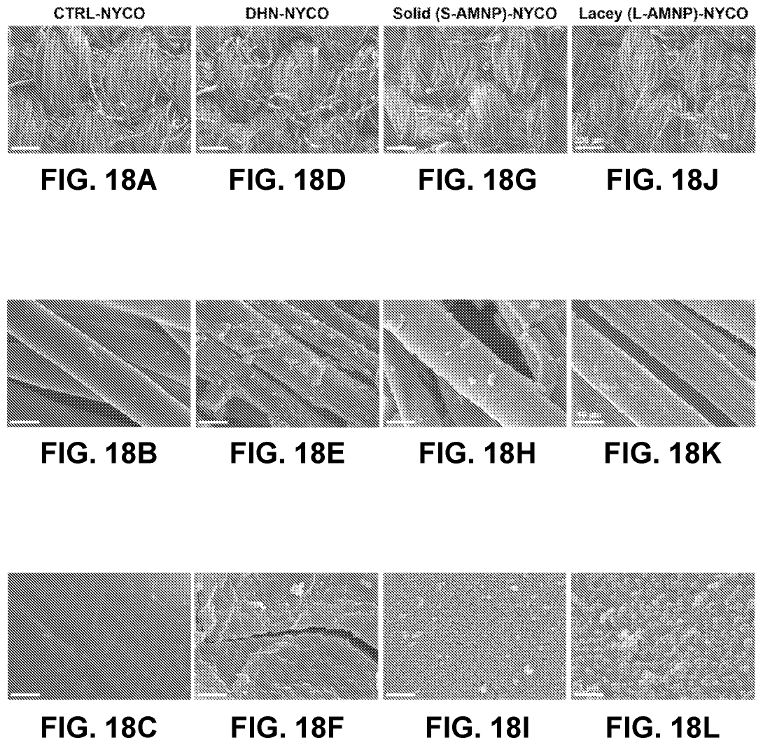

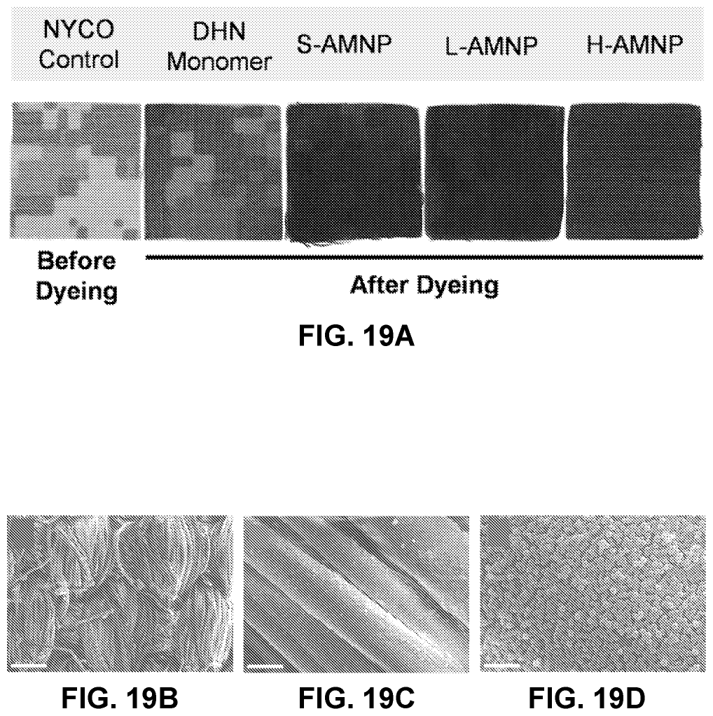

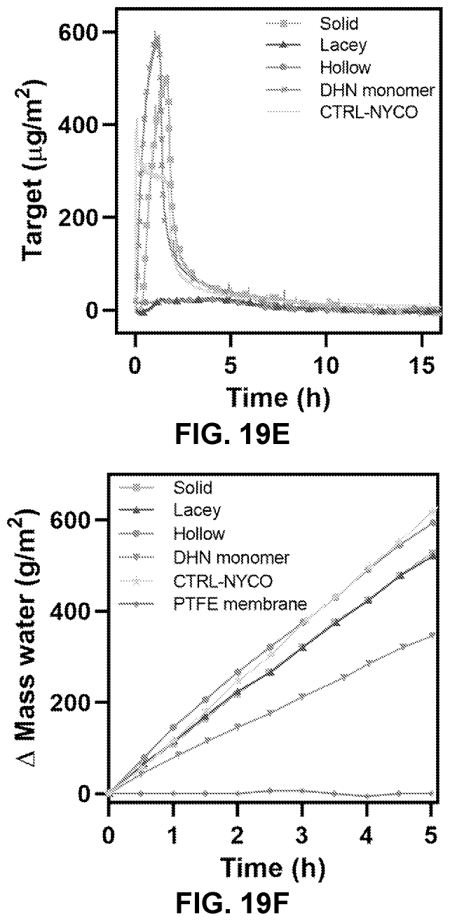

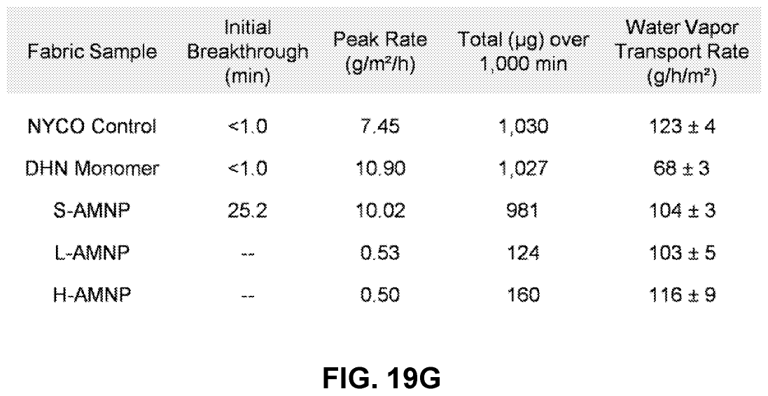

To probe the feasibility of AMNPs as coatings, we applied them to nylon-cotton (NYCO) fabric (FIGS. 18A-18L and 19A-19G), and tested their ability to withstand breakthrough following dimethyl methylphosphonate (DMMP) exposure (FIG. 19e). DMMP is an analogue of sarin gas, and a common simulant for phosphorous containing nerve agents and for permeation studies due to its stability in the gas phase at room temperature.

The excellent resistance to DMMP breakthrough of L-AMNP-NYCO and H-AMNP-NYCO drove us to consider their potential utility in an application. Although other fabric coatings exist that have exceptional DMMP resistance, they are not always practical. Fabrics which do not permit water vapor transport are uncomfortable for the wearer and suitable for short duration use only. We sought to examine all NYCO fabric swatches to see if they exhibited efficient water vapor transport, comparing these values to that of a polytetrafluoroethylene (PTFE) membrane control which is highly fluorinated and non-permeable to water vapor (FIG. 19f). AMNP-NYCO and CTRL-NYCO all showed similar water vapor transport, indicating that the coatings should have little impact on comfort, and the PTFE performed as expected, with essentially zero transport of water vapor. Interestingly, DHN-NYCO, which performed poorly in the DMMP breakthrough study, was less permeable to water vapor than AMNP-NYCO or CTRL-NYCO, although still much more permeable than PTFE.

The invention can be further understood by the following non-limiting examples.

### Example 1A: Allomelanin: A Biopolymer of Intrinsic Microporosity

This Example includes exemplary, non-limiting, materials or compositions, methods or steps, features, properties, and/or other embodiments useful in various aspects disclosed herein.

Abstract: Melanin is a ubiquitous natural pigment found in a diverse array of organisms. Allomelanin is a class of nitrogen-free melanin often found in fungi. Herein, we find artificial allomelanin analogues exhibit high intrinsic microporosity, and describe an approach for further increasing and tuning that porosity using a template-free synthesis method. The well-defined morphologies of these nanomaterials were elucidated by a combination of electron microscopy and scattering methods, with the high uniformity yielding to 3D reconstructions based on small angle x-ray scattering (SAXS) results. These materials exhibit surface areas up to 860 m²/g and capture ammonia up to 17.0 mmol/g at 1 bar. We demonstrate synthetic allomelanin can be used for capture of chemical warfare agent simulants both in solution and as a breathable fabric coating. These results point to a scalable, biomaterial capable of gas and toxin adsorption.

Melanin is a versatile pigment found in almost every type of organism on Earth.¹ It serves a variety of known functions in nature such as in radiation protection,² metal chelation,³ thermoregulation,⁴ and structural coloration.⁵ Melanins have also been shown to exhibit more exotic properties such as toxin adsorption in melanic seasnakes⁶ and butter clams.⁷ For the past decade, the interest in synthetic melanin, specifically human eumelanin, has grown significantly, with the vast majority of studies centered almost entirely around the oxidative polymerization of dopamine to form polydopamine (PDA).⁸⁻¹¹ This inspired us to explore the richer chemistry of melanin beyond PDA for access to new types of function. Specifically, here, we focus on allomelanin-derived 1,8-dihydroxynaphthalene (1,8-DHN), a monomer that is utilized in nature by fungi. Synthetic allomelanin mimics have only recently been synthesized, using chemoenzymatic and chemical synthetic methods to oligomerize and polymerize 1,8-DHN.¹²⁻¹⁴ The latter affords discrete, spherical particles with low dispersity and with excellent radical scavenging properties.¹⁴ We reasoned, based on the chemical structure of the oligomers and polymers generated from 1,8-DHN, that the materials could likely exhibit intrinsic microporosity. This would also suggest that this could be the case for allomelanin produced by organisms. Indeed, structural analogues in synthetic systems include polymers of intrinsic microporosity (PIMs) which have previously utilized naphthalene diol-type co-monomers to afford materials with surface areas of up to 440 m²/g-540 m²/g.¹⁵ For PIMs,^{16,17,18} the voids created by inefficient packing of the resulting macromolecules gives rise to microporosity and this property could very well provide organisms generating such materials in the form of melanin pigments an evolutionary advantage.

Herein, we report a biomimicry approach to develop synthetic porous materials. We show that amorphous, tunable, high porosity allomelanin nanoparticles can be readily synthesized in a facile manner with minimal reagents. The resulting materials can be used for gas and toxin adsorption, inspiring the intriguing possibility that organisms may very well use 1,8-DHN to generate porous functional materials.

### Results for Examples 1A and 1B:

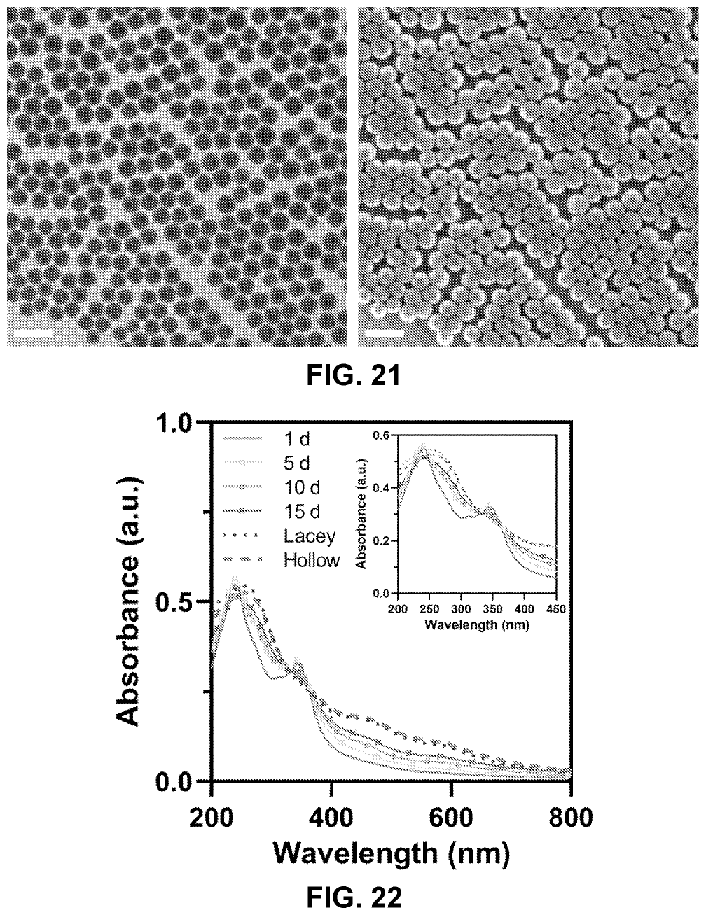

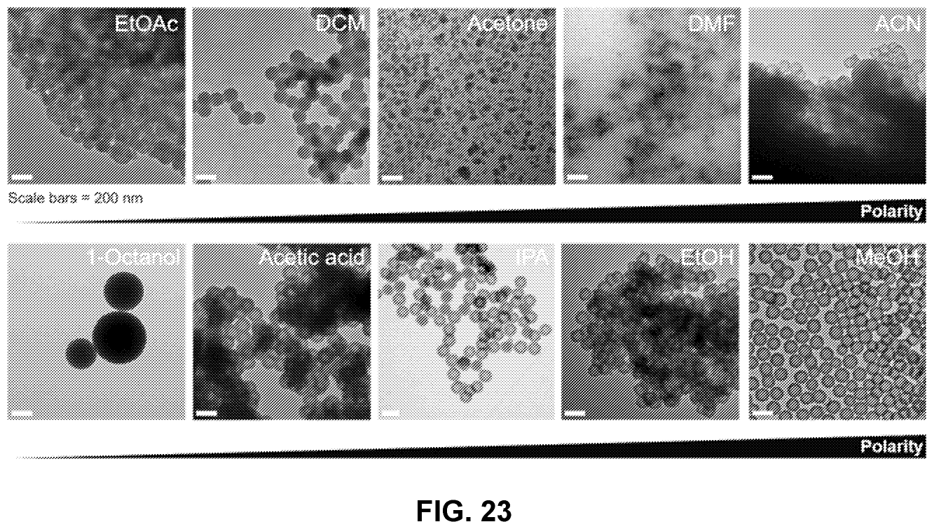

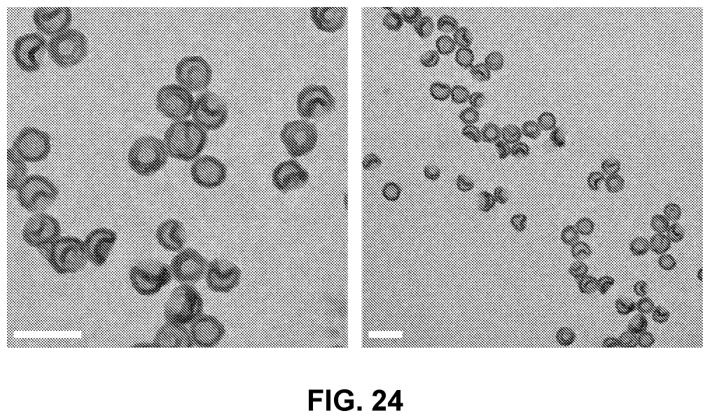

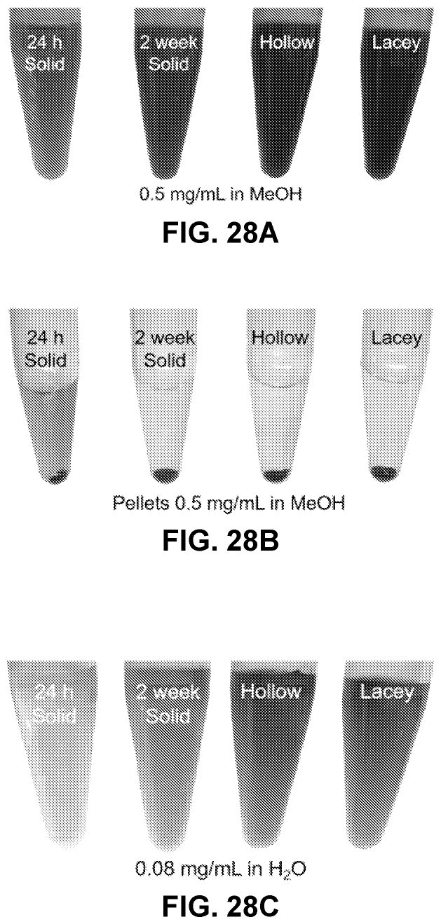

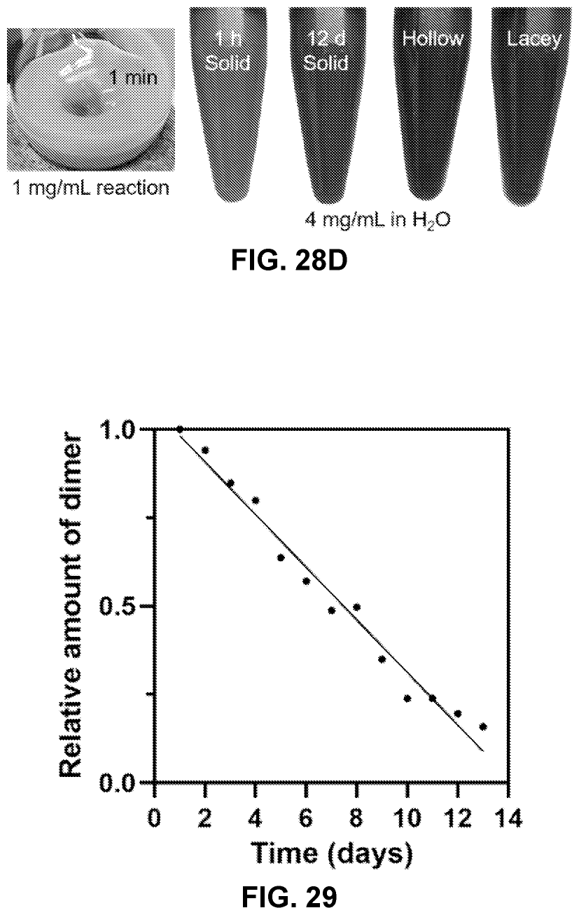

Preparation of Spherical Allomelanin Nanoparticles (S-AMNP), according to certain embodiments here: Artificial allomelanin was synthesized by oxidative polymerization using 1,8-dihydroxynapthalene (1,8-DHN) as a precursor (FIGS. 12A-12O). Synthetic allomelanin initially forms as a mixture of mainly dimers and low molecular weight oligomers as oxidative polymerization from 1,8-DHN proceeds over 20 hours. 13,14 This mixture of dimers, trimers and higher order oligomers assemble to form spherical (“Solid”) particles (S-AMNP) spontaneously in solution (FIGS. 12A-12E, FIG. 21). Bright-field, scanning transmission electron microscopy (BF-STEM) (FIG. 12B) reveals uniform, spherical structures, High-angle annular dark-field STEM (HAADF-STEM) was also performed to view the particles at higher resolution (FIG. 12C). Particle surfaces are visible by scanning electron microscopy (SEM) (FIG. 12D) and more clearly visible by atomic force microscopy (AFM) (FIG. 12E). Over time we observed a visible darkening of the particles in aqueous solution, from grey to black, correlated with polymerization and crosslinking. UV-Vis absorbance was monitored from 1 to 15 days after synthesis of the S-AMNPs revealing a broadening of the peak at ˜250 nm and a shift to longer wavelengths, indicative of expansion of the conjugated system. This is coupled with an increase in the visible region as particles further oxidize and become darker in color, consistent with previous observations of these types of systems (FIG. 22).¹⁹ Solvent stability was assessed in preparation for porosity measurements which necessitate the use of ethanol, or a solvent with low surface tension that is miscible with liquid CO₂, for storage prior to supercritical activation. We observed that the initially formed allomelanin nanoparticles partially dissolved in ethanol but became stable in solution after aging, polymerizing and darkening. Due to the initially observed instability, a solvent screen was performed using several organic solvents to determine the effects on the particles (FIG. 23). Methanol (MeOH) was discovered to have profound effects on the particle morphology in the first 3 days after synthesis, resulting in well-defined structures (FIGS. 24, 25, 26A-26D, 27A-27D and 28A-28D). Chemical changes in the dimer content were also observed up to two weeks following synthesis (FIG. 29).

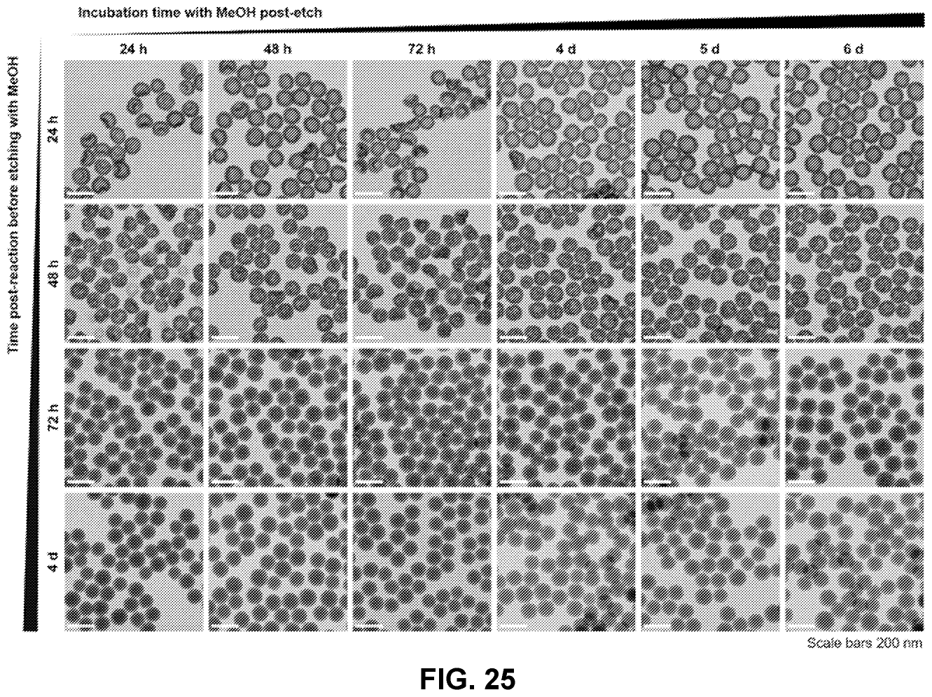

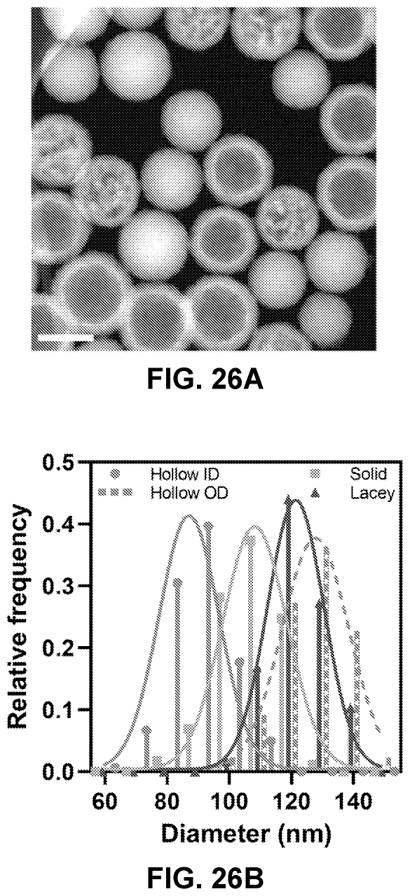

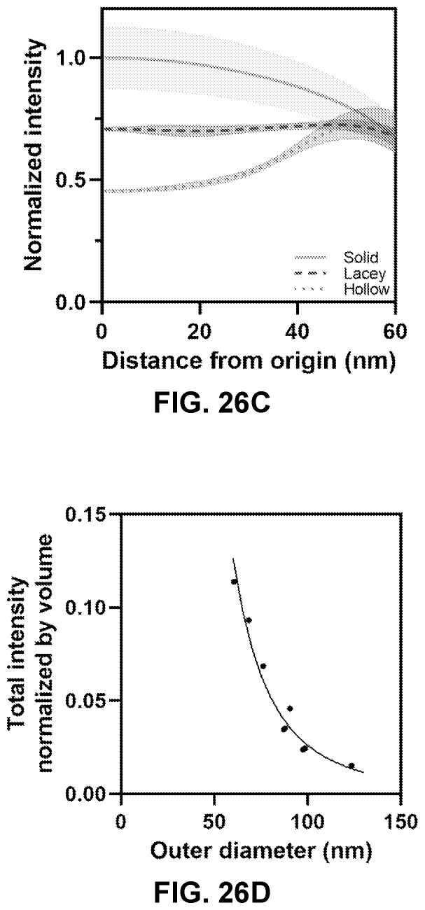

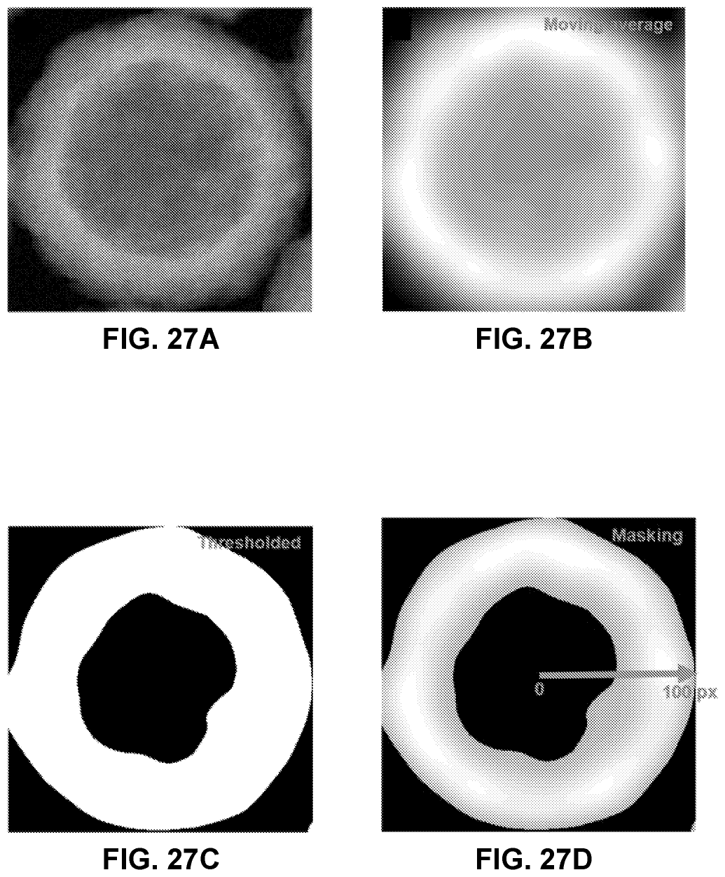

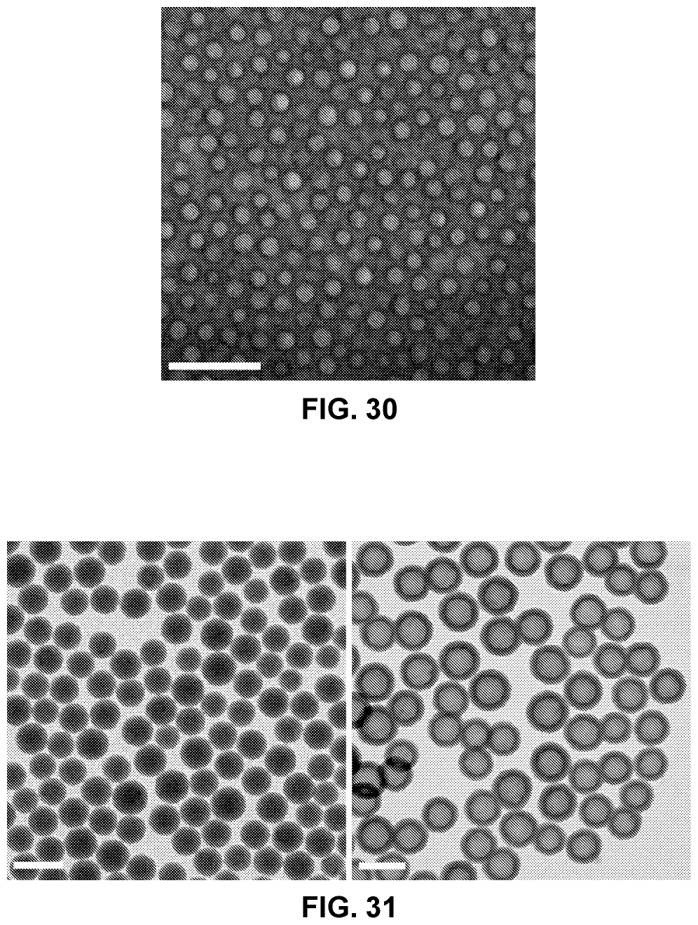

Preparation of Hollow Allomelanin Nanoparticles (H-AMNP), according to certain embodiments here: As observed by STEM, the aging process for generating AMNPs corresponds with an increase in solvent compatibility. The observations also resulted in the serendipitous discovery that particles aged for 24 h could be etched to well-defined, Hollow AMNPs (H-AMNP) (FIGS. 12F-12J, and FIG. 25). STEM micrographs show uniform, hollow structures (FIG. 12G) that are more clearly visible by HAADF-STEM, wherein there appears a clear distinction between the hollow core and the shell (FIG. 12H, FIGS. 26A-26D and 27A-27D). H-AMNPs were ultramicrotomed to 80 nm sections, and imaged via STEM, revealing a hollow core (FIG. 30). The particles persist as stable suspensions when stored in water at room temperature for at least 18 months (FIG. 31).

Preparation of Lacey Allomelanin Nanoparticles (L-AMNP), according to certain embodiments here: With a method for routinely generating hollow, spherical H-AMNPs, we reasoned that further aging followed by etching with methanol would lead to a higher surface area particle, with more internal structure (FIGS. 12K-12O, FIG. 25). STEM micrographs show structures which are an intermediate between S- and H-AMNP, with material density in the center having a lacey appearance (FIG. 12I).

HAADF-STEM imaging reveals the core of the particle with small voids throughout (FIG. 12M). We hypothesized that this was due to the re-deposition process of leached oligomers back onto the particle surface where they are further oxidized as a polymeric shell (FIGS. 26A-26D).

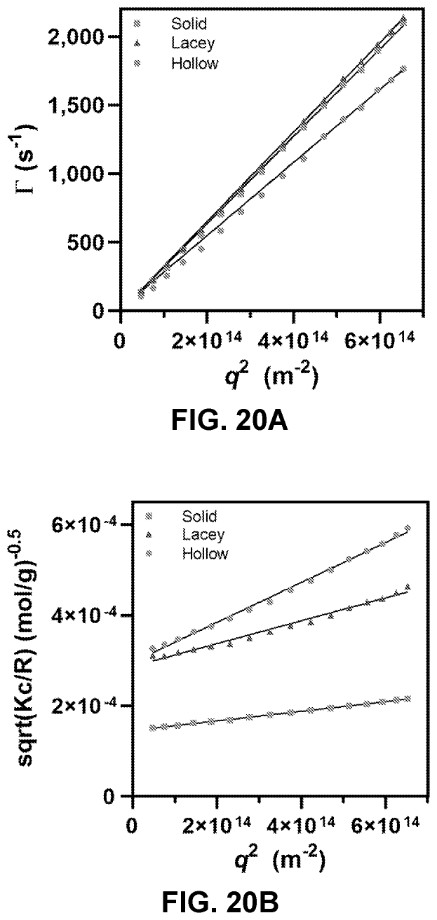

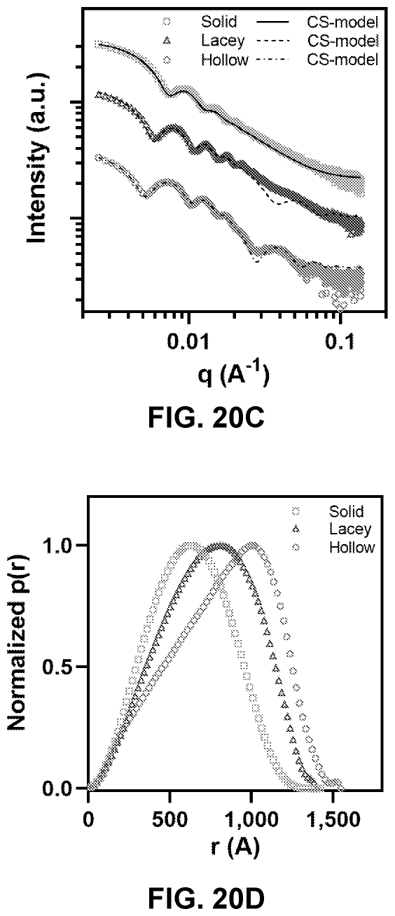

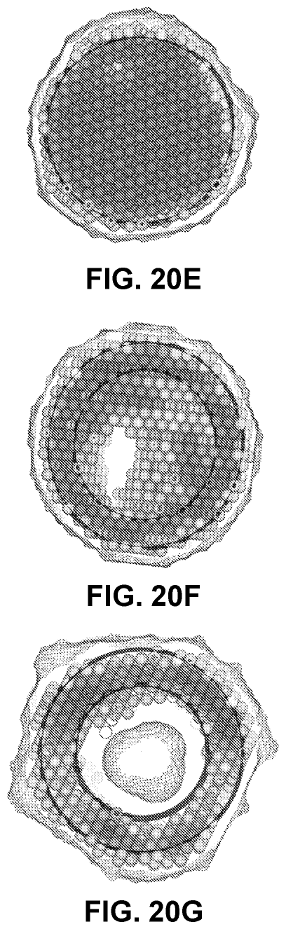

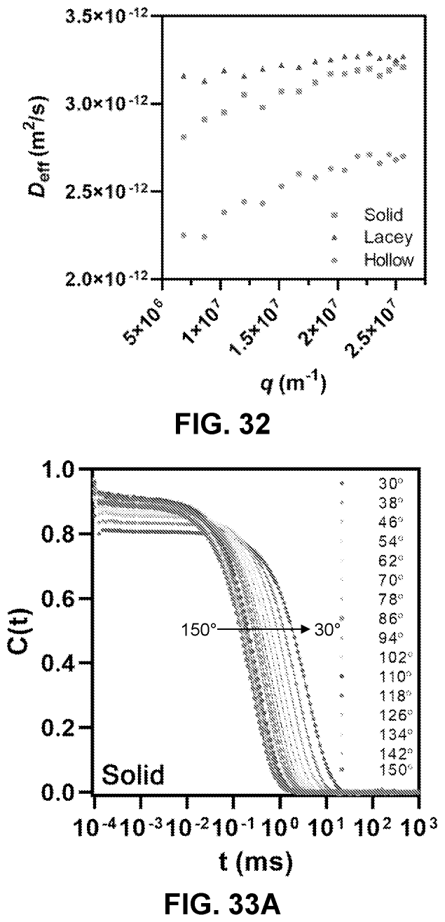

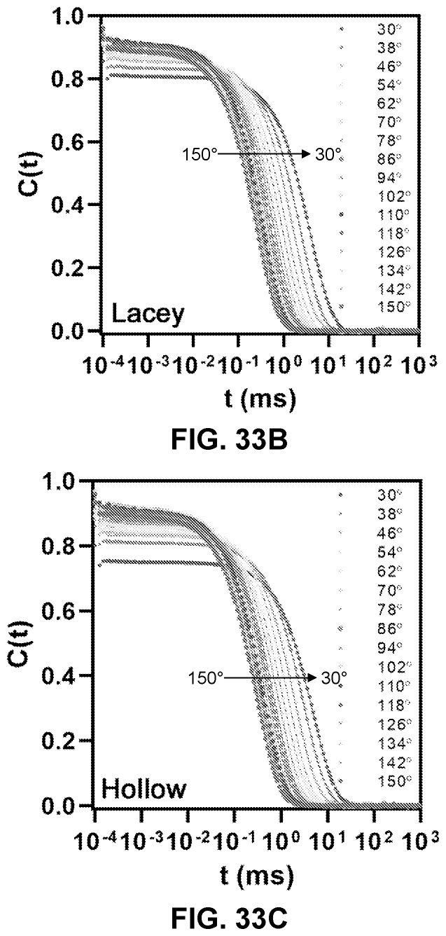

Bulk solution morphology characterization by light and x-ray scattering. We next conducted light and x-ray scattering studies to ascertain the dispersity, morphology, and fine structure of the materials in bulk solution (FIGS. 20A-20G). First, AMNPs were analyzed using multi-angle dynamic light scattering (DLS) and static light scattering (SLS) in water. The effective diffusion coefficient (D_{eff}) was primarily invariant with q² for all samples, with this angular independence indicative of their low dispersity (FIG. 32). Hydrodynamic diameters (Dₕ) of 154 nm (S-AMNP), 150 nm (L-AMNP), and 184 nm (H-AMNP) were determined by DLS (FIG. 20A, Equations 1.1 and 1.2, FIGS. 33A-33C). The effective radius of gyration (R_{g}) was obtained via multiangle SLS (FIG. 20B, Equation 1.3) with the parameter ρ=R_{g}/Rₕ giving an estimate of the compositional distribution of the particles. AMNP R_{g} values were determined to be 66 nm (S-AMNP), 73 nm (L-AMNP), and 94 nm (H-AMNP), with ρ values of 0.86 (S-AMNP), 0.97 (L-AMNP) and 1.02 (H-AMNP) corresponding to solid spheres in the case of S-AMNP, with an increasing distribution of mass towards the shell, commensurate with that observed by STEM, for L- and H-AMNP, respectively.

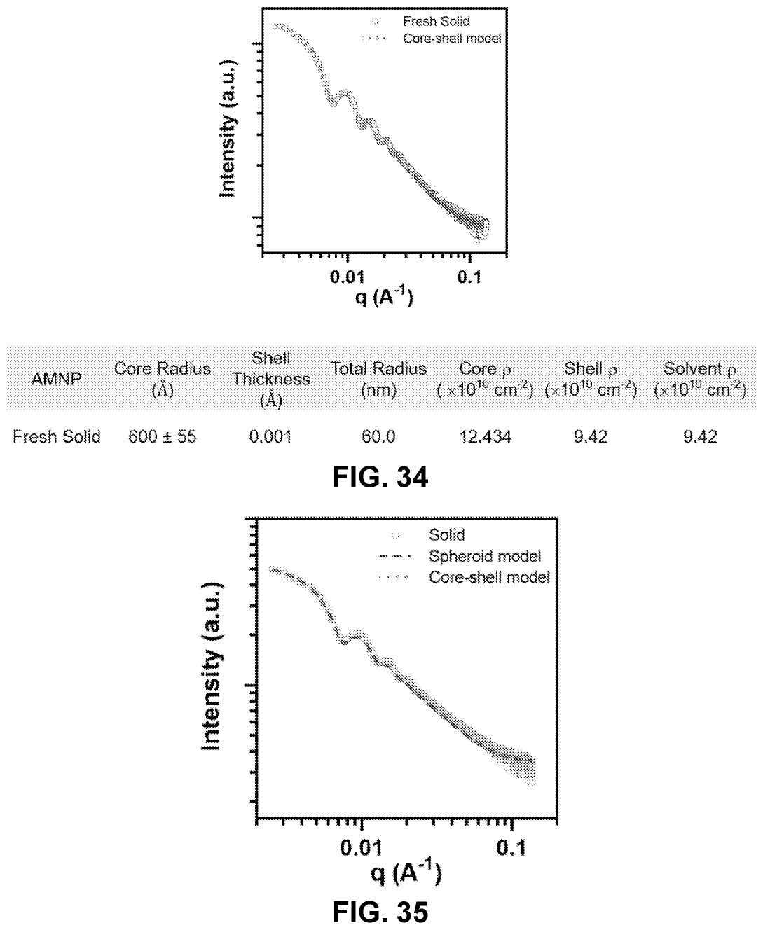

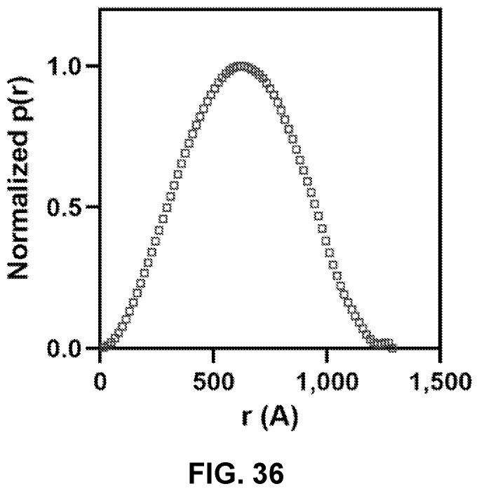

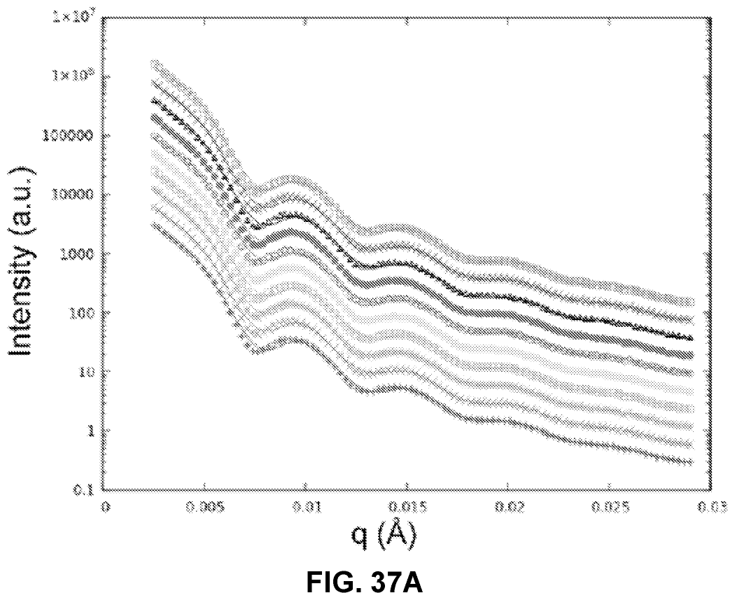

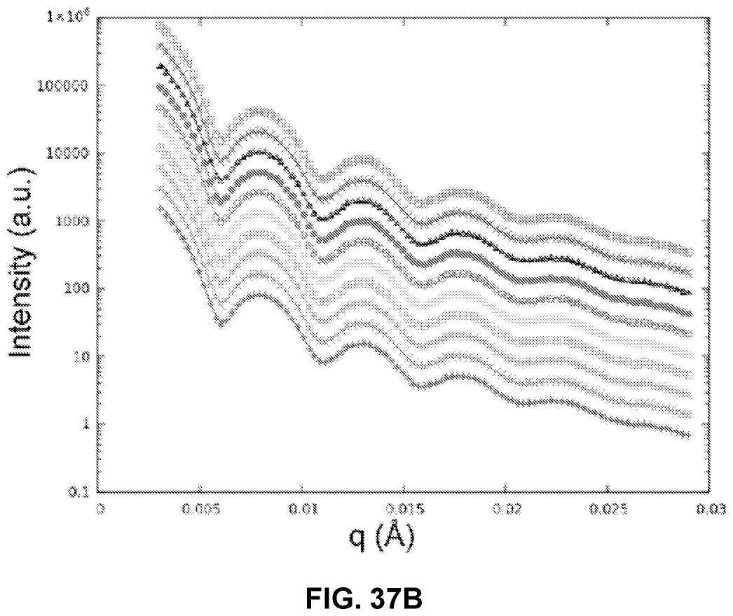

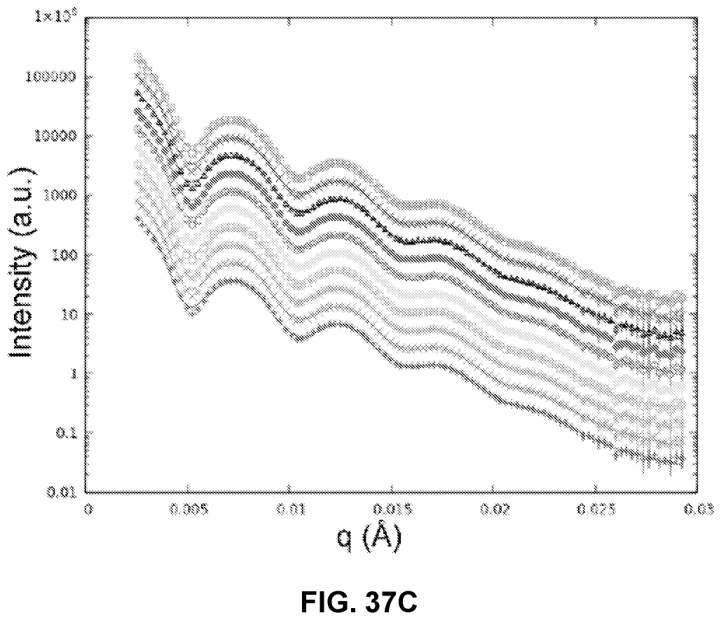

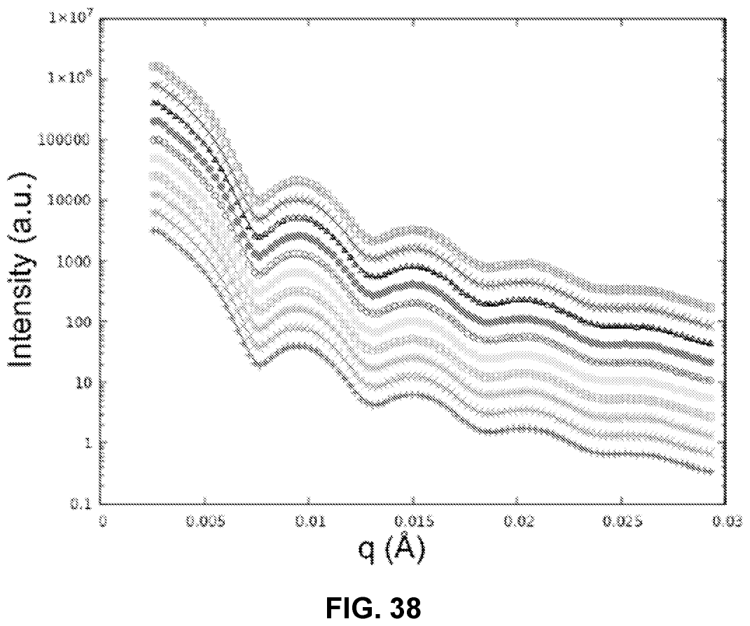

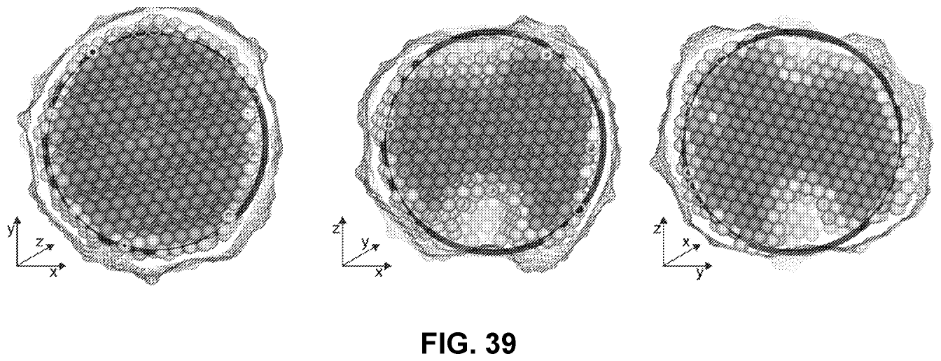

Small-angle X-ray Scattering (SAXS) was performed on AMNPs that were synthesized 1 month prior to measurement and compared to that of a “fresh” S-AMNP sample synthesized 48 hours prior (FIG. 34). The 1D SAXS patterns from each nanoparticle sample were fit with a spherical core-shell model using a Gaussian distribution (FIG. 20C, FIG. 35). This allowed for the direct comparison of parameters across the three melanin nanoparticles using the same geometrical model. We also analyzed the pair distance distribution function (p(r)) with Dₘₐₓ (the maximum diameter of the particle) determined (FIG. 20D, FIG. 36). S-AMNPs follow a normal distribution as expected for solid spherical nanoparticles of smooth surface and uniform density. H-AMNPs display skewed distribution in p(r) to higher r values as expected for a hollow interior and significant shell density. Finally, L-AMNPs demonstrate peak broadening and skewness suggesting inhomogeneity within the core. The Dₘₐₓ for S- (142.4 nm), L- (140.0 nm) and H- (155.0 nm) AMNPs is in strong agreement with values calculated from core-shell modeling of X-ray scattering and those observed also by light scattering experiments. Modeling demonstrates H-AMNP have the largest overall particle radius of 71 nm and greatest shell thickness of 23 nm. In comparison, S-AMNP exhibited the smallest total radius of 61 nm and L-AMNP a total radius of 69 nm with a shell contribution of 16 nm (Table 2, Table 3). 3D reconstructions (FIGS. 20E-20G) reveal structures in good agreement with STEM and light scattering data.

TABLE 2
Comparison of morphology and size using DLS, SLS, SAXS, STEM,
and AFM analyses. R_{g} and R_{g}/Rₕ were determined from SLS data.

| | D_{h, DLS} | R_{g} | | D_{h, SAXS} | D_{STEM} | D_{AFM} |
|---|---|---|---|---|---|---|
| AMNP | (nm) | (nm) | R_{g}/Rₕ | (nm) | (nm) | (nm) |
| Solid | 154 | 66 | 0.86 | 122 | 108 ± 9 | 124 ± 10 |
| Lacey | 150 | 73 | 0.97 | 138 | 123 ± 9 | 131 ± 9 |
| Hollow | 184 | 94 | 1.02 | 142 | 128 ± 10 | 141 ± 7 |

TABLE 3
Summary of experimental SAXS measurements
determined by the core-shell (CS) model.

| | Core | Shell | Total | | | |
|---|---|---|---|---|---|---|
| | radius | thickness | radius | Core ρ | Shell ρ | Solvent ρ |
| AMNP | (Å) | (Å) | (nm) | (×10¹⁰ cm⁻²) | (×10¹⁰ cm⁻²) | (×10¹⁰ cm⁻²) |
| Solid | 611 ± 65 | 0.001 | 61.1 | 13.553 | 9.42 | 9.42 |
| Lacey | 526 ± 56 | 162 | 68.8 | 11.220 | 13.545 | 9.42 |
| Hollow | 483 ± 61 | 227 | 71.0 | 9.281 | 12.245 | 9.42 |

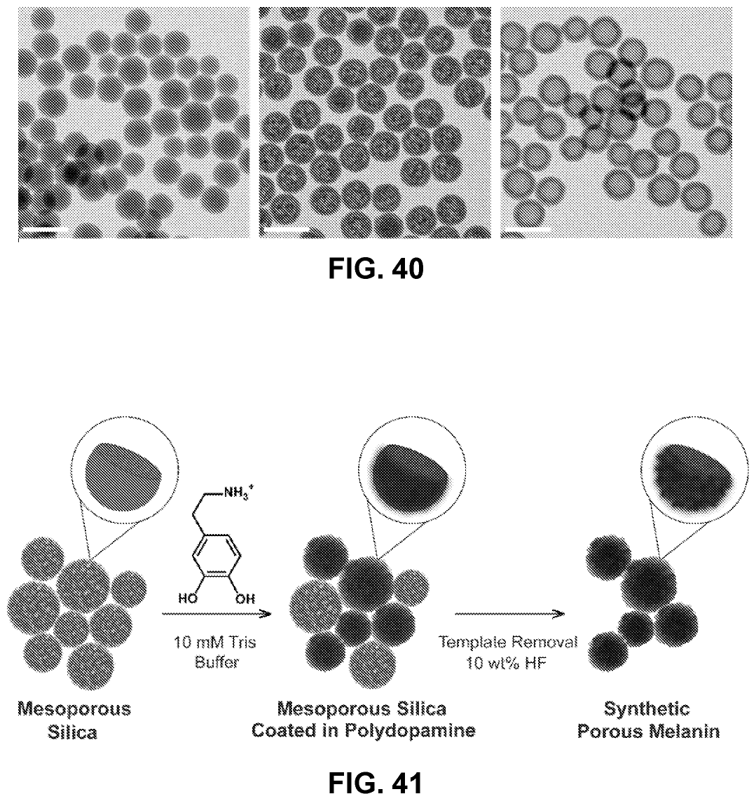

Sorption measurements. To assess the porosity of AMNPs, nitrogen physisorption measurements were performed at 77 K (FIGS. 13A-13G). The particles were first activated using supercritical CO₂ (FIG. 40). Nitrogen isotherms revealed Brunauer-Emmett-Teller (BET) areas of 680 m²/g for S-AMNPs, 645 m²/g for H-AMNPs, and 860 m²/g for L-AMNPs (FIG. 13A). DFT calculations showed two major pores around 6 Å and 12 Å for all AMNPs, although L-AMNP pore volume (0.60 cm³/g) was significantly higher than for S- (0.35 cm³/g) or H- (0.36 cm³/g) AMNPs (FIG. 13B) which is consistent with the larger voids seen via HAADF-STEM. We hypothesized that due to the —OH groups present on the surface of the porous AMNPs, these materials would be promising for ammonia capture and/or storage.²¹ Therefore, we conducted ammonia isotherms at 298 K (FIG. 13C). The ammonia isotherms showed steep and high uptakes at lower pressures arising from strong interactions between the AMNPs and NH₃, which indicates that these materials would be promising for air filtration applications. At 1 bar, NH₃ uptakes for the S-, L-, and H-AMNPs were 17 mmol/g, 12.6 mmol/g, and 11.6 mmol/g, respectively. The high capacity of AMNPs for NH₃ suggests they could be utilized in ammonia storage applications. The total uptakes at 1 bar did not follow surface area and pore volume trends, indicating slight differences in the composition and/or density of functional groups present in the particles. These porous materials have comparable performance in total uptake at 1 bar to metal-organic frameworks²¹⁻²⁴ and porous organic polymers.^{25,26}

To probe the efficacy of AMNPs for gas storage and separation applications, CO₂ and CH₄ isotherms were collected at 298 K (FIGS. 13D-13E). Total CO₂ uptake is similar to that seen in microporous organic polymers²⁷ (S-AMNP=41.2 cm³/g, L-AMNP=46.9 cm³/g, and H-AMNP=40.4 cm³/g), and is higher than observed for CH₄ (S-AMNP=11.8 cm³/g, L-AMNP=12.9 cm³/g, and H-AMNP=10.9 cm³/g). To determine whether the AMNPs could be utilized for carbon dioxide separation from natural gas, having predominantly of methane, we quantified their selectivity through the application of ideal adsorbed solution theory (IAST)²⁸ on the pure gas isotherms fitted using BET model (FIGS. 14A-14B, 15A-15B and 16A-16B). Using gas phase mole fractions of 0.05 for CO₂ and 0.95 for CH₄, which is a typical composition found for natural gas purification, IAST-predicted selectivities ranging from 6-8 were obtained (FIG. 13F). The high selectivities indicated that CO₂ was preferentially adsorbed over CH₄. The stronger interactions between AMNPs and CO₂ were attributed to the presence of hydroxyl moieties present on the surface. 29,30 Despite L-AMNPs having the highest storage capacity, the selectivity (6.5) was comparable to that of the S-AMNP. H-AMNP had the highest selectivity of around 7.5, perhaps arising to the higher density of functional groups present on the surface per unit volume, as indicated by the lower pore volume of 0.36 cm³/g. Beyond preferential adsorption due to surface functionalization, the microporous nature of these particles may have aided in increased uptake of CO₂, which has a smaller kinetic diameter of 3.3 Å compared to that of CH₄ (3.8 Å). AMNP selectivities were on the order of those of ZIF-8,³¹ glucose-derived porous carbon spheres,³² and close to those of mixed-ligand metal-organic frameworks.³³ Therefore, we predict that these particles could be useful for CO₂ removal from natural gas. The total uptake for CO₂ and CH₄ followed surface area trends, indicating that the total loadings of these molecules were less impacted by intermolecular interactions than for NH₃. The combined sorption measurements are compared in FIG. 3G.

Toxin adsorption measurements: Given the high porosity of AMNPs and success with ammonia capture, we next tested whether they could serve as toxin remediation agents upon exposure to diazinon and paraoxon, which are common pesticides and are used as analogues for structurally similar chemical warfare agents.^{34,35} A known mass of AMNP (10, 20, or 40 μg±1 μg) was incubated with either diazinon or paraoxon for 2 h after which the solution was filtered using a 0.2 μm PTFE syringe filter. Analysis of the target remaining in the sample was performed by HPLC and the resulting data was fit using the Langmuir isotherm to generate the saturation loading for the materials in grams/gram and an affinity coefficient (1/M) (FIGS. 17A-17B). Binding data suggests that L-AMNP (41.4 g/g) are more efficient at binding diazinon than S-AMNP (14.5 g/g), but not paraoxon (L-AMNP 4.2 g/g, and S-AMNP 6.5 g/g). Surprisingly, despite H-AMNPs having similar surface areas to S-AMNPs, they are capable of binding both diazinon (124 g/g) and paraoxon (9.8 g/g) better than S- or L-AMNPs. This suggests that surface area is not the only parameter important for diazinon binding, which corroborates the higher affinity for diazinon seen in S-AMNP (91,305 M⁻¹ vs 27,310 M⁻¹ for L-AMNP, and 9,739 M⁻¹ for H-AMNP). However, surface area trends are consistent with paraoxon affinities (4, 162 M⁻¹ for H-AMNP, 6,698 M⁻¹ for S-AMNP, and 11,658 for L-AMNP). Results from these studies can be found summarized in Table 1. The performance of these materials is on par with that of porous organosilicates.³⁶

Allomelanin deposition on nylon-cotton (NYCO) fabric for toxin adsorption analysis: We next applied AMNPs to nylon-cotton (NYCO) fabric, and tested their ability to withstand breakthrough following dimethyl methylphosphonate (DMMP) exposure (FIGS. 19A-19G). DMMP is an analogue of sarin gas, and a common simulant for phosphorous containing nerve agents and for permeation studies due to its stability in the gas phase at room temperature.³⁵ Despite the fact that production and stockpiling of sarin and similar nerve agents have been outlawed, they remain in use as chemical warfare agents.^{37,38} Antidotes are available but they must be administered very quickly after exposure and may not be widely accessible. Clothing with the ability to slow and/or impede the permeation of nerve agents may provide sufficiently increased protection and/or time necessary to obtain antidotes and treatment. To this end, NYCO swatches (2.5 cm²) were coated (dyed) by immersion in a suspension of AMNPs (4 mg/mL) or a 1,8-DHN monomer solution (4 mg/mL), stirred at 45° C. for 15 hours, and then washed and dried thoroughly (FIG. 5a). AMNP-coated fabric swatches (S-AMNP-NYCO, L-AMNP-NYCO, or H-AMNP-NYCO for S-AMNP, L-AMNP, and H-AMNP, respectively) were imaged via SEM to illustrate the distribution of material along the fibers, with individual nanoparticles visible for each sample, in comparison to 1,8-DHN-coated (DHN-NYCO) and uncoated (CTRL-NYCO) controls (FIGS. 19B-19D and FIGS. 18A-18L). Fabric swatches were then tested for permeability to DMMP using a stainless-steel aerosol-vapor-liquid-assessment group (AVLAG) cell which holds the sample horizontally with O-ring seals, supported with solid disks. Liquid droplets of DMMP were applied to the top of the fabric using a repeating dispenser and a flame ionization detector (FID) continuously monitored DMMP concentration on the bottom of the fabric over 16 hours. Typically, the threshold used for initial target breakthrough is based on the military exposure guideline (MEG) of 1 h of marginal exposure level in air. A “marginal” hazard level is defined as causing degraded mission capability or unit readiness. This is based on the proportion of the unit likely to exhibit effects, the nature of those effects, and confidence in the available data. The 1 h marginal air exposure limit for DMMP is 500 mg/m³.³⁹ None of the materials evaluated permitted target breakthrough at this rate (FIG. 19E). To provide a point of comparison, 5.0 mg/m³ was used as the threshold value for DMMP analysis. The peak DMMP rate through CTRL-NYCO was 7.5 g/m²/h with initial breakthrough at <1 min and 1,030 μg recovered over the 1,000 min experiment duration. DHN-NYCO swatches had no impact on initial breakthrough (<1.0 min) but resulted in a higher peak transport rate of 10.9 g/m²/h, with a similar final recovery of 1,027 μg. S-AMNP-NYCO delayed DMMP breakthrough to 25.2 minutes and resulted in a recovery of 981 μg with a peak rate of 10.02 g/m²/h. Both L-AMNP-NYCO and H-AMNP-NYCO had significantly improved performance over S-AMNP-NYCO, DHN-NYCO, and CTRL-NYCO. DMMP permeation through L-AMNP-NYCO and H-AMNP-NYCO remained below the 5.0 mg/m³ peak rate threshold, and their peak rates were low, at 0.53 and 0.50 g/m²/h, respectively. The total transport was 124 μg for L-AMNP-NYCO and 160 μg for H-AMNP-NYCO; an order of magnitude lower than CTRL-NYCO and DHN-NYCO controls.

Although other fabric coatings exist that have exceptional DMMP resistance, they are not always practical. StedCarb, for example, exhibits complete resistance to DMMP, however, the material also impedes permeation of water vapor, a proxy for breathability in fabrics.⁴⁰ Fabrics which do not permit water vapor transport are uncomfortable for the wearer and suitable for short duration use only. We sought to examine all NYCO fabric swatches to see if they exhibited efficient water vapor transport, comparing these values to that of a polytetrafluoroethylene (PTFE) membrane control which is highly fluorinated and non-permeable to water vapor (FIG. 19F). AMNP-NYCO and CTRL-NYCO all showed similar water vapor transport, indicating that the coatings should have little impact on comfort, and the PTFE performed as expected, with essentially zero transport of water vapor. Interestingly, DHN-NYCO, which performed poorly in the DMMP breakthrough study, was less permeable to water vapor than AMNP-NYCO or CTRL-NYCO, although still much more permeable than PTFE. These results are promising for the application of AMNPs as active dyes for uniforms or other fabrics where the wearer is in need of additional protection (FIG. 19G). The black color of the dyes may additionally be useful for certain applications, and for others, they can potentially be used to coat inner layers of multi-layer, composite fabrics.

### Discussion for Examples 1A and 1B:

We found that the initially formed allomelanin nanoparticles, assembled from low molecular weight oligomers, undergo further oxidation and chemical crosslinking on a timescale that allows for partial dissolution resulting in tunable morphology and porosity. The formation of these types of structures has an analogue in nature, as it mimics the process of melanosomal maturation seen in some bird species. In those animals, solid melanosomes are formed, followed by a biochemical “etching” of the core to afford hollow structures, wherein a pheomelanin@eumelanin core-shell structure exploits chemical differences in the bulk and particle surface for the selective etching process.⁴¹ Similar structures can be made biosynthetically by etching melanized bacterial or fungal cells to afford hollow structures called melanin ghosts.⁴² Here, we show that the synthesis of these porous AMNP structures is facile, template-free, and requires few starting materials, all of which are commercially available with the principle component, 1,8-DHN, being naturally occurring. In addition, the synthesis can easily be adjusted with a simple alcohol treatment to enable tunable morphology and increased porosity, while retaining high uniformity.

The observed solvent instability and visible color change over time in AMNPs allowed us to consider the possibility of chemical tunability. A solvent screen and timeseries of MeOH treatment revealed a structure that, when first synthesized, contains a loosely associated core of oligomers which are disrupted by organic solvent and can leach out of the particle and be redeposited onto the surface over several days. This is consistent with a general increase in size from S- to L- to H-AMNP, as revealed by STEM, AFM, and SAXS analyses. To clarify whether there was a conservation of material between AMNPs, the total intensity of the radial profile was normalized by volume of the particle and plotted as a function of their outer diameter. Here, irrespective of their morphology, normalized intensity scales with diameter, indicating negligible loss of material between the particles; therefore, all three AMNPs contain approximately the same amount of material for a given diameter (FIGS. 26A-26D). This is consistent with the mechanism of formation of L- and H-AMNPs leaching oligomers from their cores and redepositing them onto the particle surface, growing the outer diameters of the particles using material leached from the core. Further, the high uniformity of the three AMNPs enabled 3D modeling from well-formed SAXS scattering curves (FIGS. 20E-20G), often reserved for highly ordered, crystalline systems.

BET measurements revealed AMNPs to have high surface areas with tunable micropores capable of adsorbing N₂, CH₄, and CO₂. The functionalized surface of these materials also proved to be advantageous for ammonia capture, with results on par or surpassing capabilities of highly ordered, crystalline structures such as MOFs.²¹⁻²⁴ AMNPs were also capable of adsorbing the toxin simulants diazinon and paraoxon in solution and were highly efficient at preventing the permeation of DMMP across AMNP-coated NYCO fabric while allowing the transport of water vapor. This breathable yet absorbent material could be generated in a straightforward manner with a simple deposition method from materials that are stable at room temperature in water for at least 18 months prior to use.

These results demonstrate how materials generated from biological building blocks may provide a route to scalable, biocompatible materials for applications such as toxin remediation and gas storage. Indeed, these results beg the question whether allomelanin-containing organisms in nature might have high porosities. Some suggestion of this has been evidenced by NMR cryoporometry studies probing fungal eumelanin ghosts.⁴³ However, chemical changes in the melanin monomer have been shown to induce structural changes on the nano- and micro-scale,^{44,45} so the correlations are not necessarily straightforward and may vary widely depending on the composition of the melanin. In fact, fungal melanin does not exist in a pure state in the cell wall, rather, incorporated with other cell wall components such as polysaccharides and/or chitin.^{46,47} Synthesis provides an approach to access and probe the performance of pure DHN-melanin devoid of confounding biological structures/molecules from the natural system. Moreover, this synthetic allomelanin may inspire investigation of microporosity of this type in natural biopolymers originating with fungi and extending to other organisms. Finally, in synthetic systems, this kind of bioinspired approach to porous materials could complement the sophisticated designed materials that have become of increasing interest in the form of metal-organic frameworks (MOFs),^{48,49} covalent organic frameworks (COFs),^{50,51} and mixed matrix membranes.^{52,53}

Exemplary methods or procedures for Example 1A and 1B, according to various aspects disclosed herein:

### Synthesis of Allomelanin Nanoparticles:

Solid (S-AMNPs) were synthesized largely based on the protocol for “AMNP-1” from previous work. 14 Briefly, 150 mg of 1,8-DHN was dissolved in 7.5 m1 of acetonitrile (ACN) and then 142.5 mL of Milli-Q water was added. The mixture was stirred for 5 min at room temperature, and then 1 mL of 1 N NaIO₄ was quickly injected into the solution while stirring vigorously. After 20 hours, the solution was washed three times in Milli-Q water by centrifugation at 11,500 rpm for 10 minutes.

Hollow (H-AMNPs) were synthesized from a fresh batch of purified, S-AMNP which were left in a closed tube (containing ambient air) on the benchtop for 24 hours. They were centrifuged at 11,500 rpm for 10 minutes to remove water, and then resuspended in MeOH at 0.5 mg/mL. The suspension was agitated for 2-6 days and then dialyzed into Milli-Q water.

Lacey (L-AMNPs) were synthesized from a fresh batch of purified, S-AMNP which were left in a closed tube (containing ambient air) on the benchtop for 48 hours. They were centrifuged at 11,500 rpm for 10 minutes to remove water, and then resuspended in MeOH at 0.5 mg/mL. The suspension was agitated for 6 days and then dialyzed into Milli-Q water.

Small Angle X-Ray Scattering (SAXS) Studies. Experiments were performed at beamline 5-ID-D of the DuPont-Northwestern-Dow Collaborative Access Team (DND-CAT) Synchrotron Research Center at the Advanced Photon Source (APS), Argonne National Laboratory. AMNPs were prepared at 10 mg/mL in Milli-Q water and during measurements flowed through a 1.5 mm glass capillary at 1 mm/sec for consistent background subtraction. Data was collected with X-Ray energy at 17 keV (λ0.73 Å) with samples exposed for 10 frames of 0.2 seconds each. Modeling of the scattering data with a spherical core-shell geometrical model was conducted in the Irena software package running on IgorPro software.⁵⁴ Scattering data were also assessed using ab initio dummy atom modeling (DAM) methods using the ATSAS analysis software.²⁰

Sorption Measurements. AMNPs were solvent switched into EtOH and critically activated prior to measurements. Nitrogen physisorption measurements were collected using a Micromeritics ASAP 2020 instrument at 77 K. Pore-size distributions were obtained using DFT calculations with a carbon slit geometry and an N₂ DFT model. CO₂ and CH₄ isotherms were measured using a Micromeritics ASAP 2020 instrument at 298 K. NH₃ isotherms were collected using a Micromeritics 3Flex Physisorption instrument at 298 K. Ideal adsorbed solution theory (IAST) calculations and isotherm fittings using a BET model for CO₂/CH₄ were performed using the Python package pyIAST.²⁸

Toxin Binding Studies. Paraoxon and diazinon solutions were prepared in Milli-Q water at varied concentration (1 to 100 ppm). AMNPs were added to the target solution in a scintillation vial (total volume 20 mL using masses of 40, 20, and 10 μg±1 μg). Samples were mixed on a rotisserie mixer for 2 h in the dark at room temperature; they were then filtered using 0.2 mm PTFE syringe filters. Analysis of the target remaining in the sample was completed by HPLC. The resulting data was fit using the Langmuir isotherm to generate the saturation loading for the materials in grams/gram and an affinity coefficient (1/M).

Nylon-cotton (NYCO) Fabric Studies. Fabric swatches (2.5 cm²) were immersed in 4 mg/mL AMNPs in water or 4 mg/mL 1,8-DHN monomer in water, stirred at 45° C. for 15 hours, and then dried. Permeation of dimethyl methylphosphonate (DMMP) was assessed as described by Test Operations Procedure (TOP) 8-2-501, Permeation Testing of Materials with Chemical Agents or Simulants (Swatch Testing). 39,55 The target was placed in the headspace above the fabric swatch, supported between two discs. This assembly was then placed in a stainless-steel aerosol-vapor-liquid-assessment group (AVLAG) cell, and humidity equilibrated for 2 h. DMMP was applied as liquid droplets using a repeating dispenser, and the concentration monitored using a dedicated flame ionization detector (FID). The water vapor transport (WVT) rate for the treated fabrics was evaluated using a circular fabric sample with a total exposed area of 1.65 cm².^{39,56,57} This method follows the guidance provided by ASTM E96, Water Vapor Transport: Upright Open Cup Method to characterize water vapor transport through the fabric samples. The fabric sample was sealed over a pre-weighed vial. A desiccant was used to drive a humidity differential in the incubator, with a dry nitrogen stream flowing across the surface of the sample (0.25 L/min). The weight of the vial was measured at 30 to 45 min intervals using an analytical balance.

### REFERENCES CITED IN OR RELEVANT TO EXAMPLE 1A

1 D'Alba, L. & Shawkey, M. D. Melanosomes: Biogenesis, Properties, and Evolution of an Ancient Organelle. Physiol Rev 99, 1-19, doi:10.1152/physrev.00059.2017 (2019).
2 Pacelli, C. et al. Melanin is effective in protecting fast and slow growing fungi from various types of ionizing radiation. Environ Microbiol 19, 1612-1624, doi: 10.1111/1462-2920.13681 (2017).
3 Hong, L. & Simon, J. D. Current understanding of the binding sites, capacity, affinity, and biological significance of metals in melanin. J Phys Chem B 111, 7938-7947, doi:10.1021/jp071439h (2007).
4 Rogalla, S., D'Alba, L., Verdoodt, A. & Shawkey, M. D. Hot wings: thermal impacts of wing coloration on surface temperature during bird flight. Journal of the Royal Society Interface 16, doi:ARTN 20190032 10.1098/rsif.2019.0032 (2019).
5 Stoddard, M. C. & Prum, R. O. How colorful are birds? Evolution of the avian plumage color gamut. Behav Ecol 22, 1042-1052, doi: 10.1093/beheco/arr088 (2011).
6 Goiran, C., Bustamante, P. & Shine, R. Industrial Melanism in the Seasnake Emydocephalus annulatus. Curr Biol 27, 2510-2513, doi: 10.1016/j.cub.2017.06.073 (2017).
7 Price, R. J. & Lee, J. S. Paralytic Shellfish Poison and Melanin Distribution in Fractions of Toxic Butter Clam (Saxidomus-Giganteus) Siphon. J Fish Res Board Can 29, 1657-1658, doi: 10.1139/f72-260 (1972).
8 Lee, B. P., Messersmith, P. B., Israelachvili, J. N. & Waite, J. H. Mussel-Inspired Adhesives and Coatings. Annu Rev Mater Res 41, 99-132, doi: 10.1146/annurev-matsci-062910-100429 (2011).
9 Liu, Y. L., Ai, K. L. & Lu, L. H. Polydopamine and Its Derivative Materials: Synthesis and Promising Applications in Energy, Environmental, and Biomedical Fields. Chemical Reviews 114, 5057-5115, doi: 10.1021/cr400407a (2014).
10 Lynge, M. E., van der Westen, R., Postma, A. & Stadler, B. Polydopamine—a nature-inspired polymer coating for biomedical science. Nanoscale 3, 4916-4928, doi: 10.1039/c1nr10969c (2011).
11 Ju, K.-Y., Lee, Y., Lee, S., Park, S. B. & Lee, J.-K. Bioinspired Polymerization of Dopamine to Generate Melanin-Like Nanoparticles Having an Excellent Free-Radical-Scavenging Property. Biomacromolecules 12, 625-632, doi: 10.1021/bm101281b (2011).
12 Manini, P. et al. A Robust Fungal Allomelanin Mimic: An Antioxidant and Potent pi-Electron Donor with Free-Radical Properties that can be Tuned by Ionic Liquids. Chempluschem 84, 1331-1337, doi: 10.1002/cplu.201900195 (2019).
13 Cecchini, M. M., Reale, S., Manini, P., d'Ischia, M. & De Angelis, F. Modeling Fungal Melanin Buildup: Biomimetic Polymerization of 1,8-Dihydroxynaphthalene Mapped by Mass Spectrometry. Chem-Eur J 23, 8092-8098, doi:10.1002/chem.201701951 (2017).
14 Zhou, X. H. et al. Artificial Allomelanin Nanoparticles. Acs Nano 13, 10980-10990, doi: 10.1021/acsnano.9b02160 (2019).
15 Budd, P. M. et al. Polymers of intrinsic microporosity (PIMs): robust, solution-processable, organic nanoporous materials. Chem Commun (Camb), 230-231, doi: 10.1039/b311764b (2004).
16 Li, C. Y. et al. Polysulfide-Blocking Microporous Polymer Membrane Tailored for Hybrid Li-Sulfur Flow Batteries. Nano Lett 15, 5724-5729, doi: 10.1021/acs.nanolett.5b02078 (2015).
17 Weng, X. L. et al. Chiral Polymers of Intrinsic Microporosity: Selective Membrane Permeation of Enantiomers. Angew Chem Int Edit 54, 11214-11218, doi: 10.1002/anie.201504934 (2015).
18 Wang, L. N. et al. Polymer of intrinsic microporosity (PIM) films and membranes in electrochemical energy storage and conversion: A mini-review. Electrochem Commun 118, doi:ARTN 106798 10.1016/j.elecom.2020.106798 (2020).
19 Manini, P. et al. “Blackness” is an index of redox complexity in melanin polymers. Polym Chem-Uk 11, 5005-5010, doi:10.1039/d0py00700e (2020).
20 Franke, D. et al. ATSAS 2.8: a comprehensive data analysis suite for small-angle scattering from macromolecular solutions. J Appl Crystallogr 50, 1212-1225, doi: 10.1107/S1600576717007786 (2017).
21 Moribe, S. et al. Ammonia Capture within Isoreticular Metal-Organic Frameworks with Rod Secondary Building Units. Acs Mater Lett 1, 476-480, doi: 10.1021/acsmaterialslett.9b00307 (2019).
22 Rieth, A. J. & Dinca, M. Controlled Gas Uptake in Metal-Organic Frameworks with Record Ammonia Sorption. J Am Chem Soc 140, 3461-3466, doi:10.1021/jacs.8b00313 (2018).
23 Chen, Y. W. et al. Zirconium-Based Metal-Organic Framework with 9-Connected Nodes for Ammonia Capture. Acs Appl Nano Mater 2, 6098-6102, doi: 10.1021/acsanm.9b01534 (2019).
24 Chen, Z. et al. Water-Based Synthesis of a Stable Iron-Based Metal-Organic Framework for Capturing Toxic Gases. Acs Mater Lett 2, 1129-1134, doi: 10.1021/acsmaterialslett.0c00264 (2020).
25 Van Humbeck, J. F. et al. Ammonia capture in porous organic polymers densely functionalized with Bronsted acid groups. J Am Chem Soc 136, 2432-2440, doi: 10.1021/ja4105478 (2014).
26 Barin, G. et al. Highly effective ammonia removal in a series of Bronsted acidic porous polymers: investigation of chemical and structural variations. Chem Sci 8, 4399-4409, doi:10.1039/c6sc05079d (2017).
27 Dawson, R., Stockel, E., Holst, J. R., Adams, D. J. & Cooper, A. I. Microporous organic polymers for carbon dioxide capture. Energ Environ Sci 4, 4239-4245, doi:10.1039/c1ee01971f (2011).
28 Simon, C. M., Smit, B. & Haranczyk, M. pyIAST: Ideal adsorbed solution theory (IAST) Python package. Comput Phys Commun 200, 364-380, doi:10.1016/j.cpc.2015.11.016 (2016).
29 Spanopoulos, I., Xydias, P., Malliakas, C. D. & Trikalitis, P. N. A Straight Forward Route for the Development of Metal-Organic Frameworks Functionalized with Aromatic —OH Groups: Synthesis, Characterization, and Gas (N-2, Ar, H-2, CO2, CH4, NH3) Sorption Properties. Inorg Chem 52, 855-862, doi:10.1021/ic302010e (2013).
30 Chen, Z. X. et al. Significantly Enhanced CO2/CH4 Separation Selectivity within a 3D Prototype Metal-Organic Framework Functionalized with OH Groups on Pore Surfaces at Room Temperature. Eur J Inorg Chem, 2227-2231, doi:10.1002/ejic.201100034 (2011).
31 Venna, S. R. & Carreon, M. A. Highly permeable zeolite imidazolate framework-8 membranes for CO2/CH4 separation. J Am Chem Soc 132, 76-78, doi: 10.1021/ja909263x (2010).
32 Li, Y., Wang, S., Wang, B., Wang, Y. & Wei, J. Sustainable Biomass Glucose-Derived Porous Carbon Spheres with High Nitrogen Doping: As a Promising Adsorbent for CO2/CH4/N2 Adsorptive Separation. Nanomaterials (Basel) 10, 1-17, doi:10.3390/nano10010174 (2020).
33 Bae, Y. S. et al. Separation of CO2 from CH4 using mixed-ligand metal-organic frameworks. Langmuir 24, 8592-8598, doi: 10.1021/la800555x (2008).
34 Bartelt-Hunt, S. L., Knappe, D. R. U. & Barlaz, M. A. A review of chemical warfare agent simulants for the study of environmental behavior. Crit Rev Env Sci Tec 38, 112-136, doi:10.1080/10643380701643650 (2008).
35 Kim, K., Tsay, O. G., Atwood, D. A. & Churchill, D. G. Destruction and Detection of Chemical Warfare Agents. Chemical Reviews 111, 5345-5403, doi: 10.1021/cr100193y (2011).
36 Johnson, B. J. et al. Adsorption of organophosphates from solution by porous organosilicates: Capillary phase-separation. Micropor Mesopor Mat 195, 154-160, doi: 10.1016/j.micromeso.2014.04.031 (2014).
37 Dolgin, E. Syrian gas attack reinforces need for better anti-sarin drugs. Nat Med 19, 1194-1195, doi: 10.1038/nm1013-1194 (2013).
38 John, H. et al. Fatal sarin poisoning in Syria 2013: forensic verification within an international laboratory network. Forensic Toxicol 36, 61-71, doi: 10.1007/s11419-017-0376-7 (2018).
39 Martin, B. D. et al. An Elastomeric Poly(Thiophene-EDOT) Composite with a Dynamically Variable Permeability Towards Organic and Water Vapors. Adv Funct Mater 22, 3116-3127, doi: 10.1002/adfm.201102237 (2012).
40 Wang, S. et al. Polymer of intrinsic microporosity (PIM) based fibrous mat: combining particle filtration and rapid catalytic hydrolysis of chemical warfare agent simulants into a highly sorptive, breathable, and mechanically robust fiber matrix. Materials Today Advances 8, doi: 10.1016/j.mtadv.2020.100085 (2020).
41 Shawkey, M. D., D'Alba, L., Xiao, M., Schutte, M. & Buchholz, R. Ontogeny of an Iridescent Nanostructure Composed of Hollow Melanosomes. J Morphol 276, 378-384, doi:10.1002/jmor.20347 (2015).
42 Wang, Z. et al. Melanin Produced by the Fast-Growing Marine Bacterium Vibrio natriegens through Heterologous Biosynthesis: Characterization and Application. Appl Environ Microb 86, 1-18, doi: 10.1128/aem.02749-19 (2019).
43 Eisenman, H. C. et al. Microstructure of cell wall-associated melanin in the human pathogenic fungus Cryptococcus neoformans. Biochemistry-Us 44, 3683-3693, doi: 10.1021/bi047731m (2005).
44 Chatterjee, S. et al. Using Solid-State NMR To Monitor the Molecular Consequences of Cryptococcus neoformans Melanization with Different Catecholamine Precursors. Biochemistry-Us 51, 6080-6088, doi: 10.1021/bi300325m (2012).
45 Garcia-Rivera, J. et al. Comparative analysis of Cryptococcus neoformans acid-resistant particles generated from pigmented cells grown in different laccase substrates. Fungal Genet Biol 42, 989-998, doi: 10.1016/j.fgb.2005.09.003 (2005).
46 Chatterjee, S., Prados-Rosales, R., Itin, B., Casadevall, A. & Stark, R. E. Solid-state NMR Reveals the Carbon-based Molecular Architecture of Cryptococcus neoformans Fungal Eumelanins in the Cell Wall. J Biol Chem 290, 13779-13790, doi: 10.1074/jbc.M114.618389 (2015).
47 Zhong, J. Y., Frases, S., Wang, H., Casadevall, A. & Stark, R. E. Following fungal melanin biosynthesis with solid-state NMR: Biopolymer molecular structures and possible connections to cell-wall polysaccharides. Biochemistry-Us 47, 4701-4710, doi: 10.1021/bi702093r (2008).
48 Vikrant, K., Kumar, V., Kim, K. H. & Kukkar, D. Metal-organic frameworks (MOFs): potential and challenges for capture and abatement of ammonia. J Mater Chem A 5, 22877-22896, doi: 10.1039/c7ta07847a (2017).
49 DeCoste, J. B. & Peterson, G. W. Metal-Organic Frameworks for Air Purification of Toxic Chemicals. Chemical Reviews 114, 5695-5727, doi: 10.1021/cr4006473 (2014).
50 Yang, Y. J. et al. Surface Pore Engineering of Covalent Organic Frameworks for Ammonia Capture through Synergistic Multivariate and Open Metal Site Approaches. Acs Central Sci 4, 748-754, doi: 10.1021/acscentsci.8b00232 (2018).
51 Romero, V. et al. Recyclable magnetic covalent organic framework for the extraction of marine biotoxins. Nanoscale 11, 6072-6079, doi: 10.1039/c9nr00388f (2019).
52 Kanehashi, S. et al. Enhancing gas permeability in mixed matrix membranes through tuning the nanoparticle properties. J Membrane Sci 482, 49-55, doi: 10.1016/j.memsci.2015.01.046 (2015).
53 Sabetghadam, A. et al. Influence of Filler Pore Structure and Polymer on the Performance of MOF-Based Mixed-Matrix Membranes for CO2 Capture. Chem-Eur J 24, 7949-7956, doi: 10.1002/chem.201800253 (2018).
54 Ilavsky, J. & Jemian, P. R. Irena: tool suite for modeling and analysis of small-angle scattering. J Appl Crystallogr 42, 347-353, doi: 10.1107/S0021889809002222 (2009).
55 D'Onofrio, T. G. Development of a Contact Permeation Test Fixture and Method. Report No. ECBC-TR-1141, (U.S. Army Research, Development and Engineering Command, 2013).
56 Kar, F., Fan, J. T. & Yu, W. Comparison of different test methods for the measurement of fabric or garment moisture transfer properties. Meas Sci Technol 18, 2033-2038, doi:10.1088/0957-0233/18/7/032 (2007).
57 Pushpadass, H. A., Marx, D. B. & Hanna, M. A. Effects of Extrusion Temperature and Plasticizers on the Physical and Functional Properties of Starch Films. Starch-Starke 60, 527-538, doi: 10.1002/star.200800713 (2008).

### Example 1B: Supplementary Information to Example 1A: Allomelanin: A Biopolymer of Intrinsic Microporosity

This Example includes exemplary, non-limiting, materials or compositions, methods or steps, features, properties, and/or other embodiments useful in various aspects disclosed herein.

Reagents. 1,8-Dihydroxynaphthalene (1,8-DHN) (95+%) was purchased from Matrix Scientific. Ethanol (200 proof) was purchased from Sigma-Aldrich. Sodium periodate (NaIO₄) (99.8%), HPLC-grade acetonitrile (ACN) (≥99.99%), methanol (MeOH) (≥99.8%), ethyl acetate (EtOAc) (≥99.5%), dichloromethane (DCM) (99.6%), acetone (≥99.5%), N,N-dimethylformamide (DMF) (99.5%), 1-octanol (99%), acetic acid (≥99.7% w/w), 2-propanol (IPA) (≥99.5%), and all other chemical reagents were purchased from Fisher Scientific unless otherwise noted. All chemicals were used as received except for 1,8-DHN, which was re-dissolved in 200 proof ethanol, filtered, and vacuum dried prior to use. Milli-Q water was used in all experiments, purified using a Branstead GenPure xCAD Plus system from ThermoFisher Scientific. Transmission electron microscopy (TEM) grids were purchased from Electron Microscopy Sciences.

Instrumentation. UV-Vis spectra were recorded using an Agilent Cary 100 UV-Vis spectrophotometer. Scanning transmission electron microscopy (STEM) images were acquired on a Hitachi HD2300 or JEOL 200 ARM at an accelerating voltage of 200 KV. Transmission electron microscopy (TEM) images were obtained on a JEOL 1230 TEM. TEM/STEM grids were surface plasma treated using a PELCO easiGlow glow discharge cleaning system prior to use. Scanning electron microscopy (SEM) images were acquired on a Hitachi SU8030 at an accelerating voltage of 10 kV and an emission current of 15 uA. AFM images were acquired on a Bruker Icon using peak force QNM, and ScanAsyst A cantilevers. Analytical high-performance liquid chromatography (HPLC) analysis for the AMNP aging study was performed on a Jupiter 4u Proteo 90A Phenomenex column (150×4.60 mm) using a Hitachi-Elite LaChrom L-2130 pump equipped with UV-Vis detector (Hitachi-Elite LaChrom L-2420). Multi-angle static and dynamic light scattering (SLS, and DLS, respectively) measurements were performed on an ALV/CGS-3 four-angle, compact goniometer system. Samples were activated using a tousimis SAMDRI-PVT-3D Advanced Manual Critical Point Dryer and a Micromeritics Smart VacPrep. Sorption measurements were taken on a Micromeritics ASAP 2020 and a Micromeritics 3Flex Physisorption instrument. Diazinon and paraoxon toxin adsorption was analyzed by HPLC using a Shimadzu HPLC system. Dimethyl methylphosphonate (DMMP) permeation studies were performed using a stainless-steel aerosol-vapor-liquid-assessment group (AVLAG) cell, with detection via a flame ionization detector (FID).

Solid AMNP (S-AMNP) synthesis. S-AMNPs were synthesized in much the same manner as AMNP-1 in previous work.¹ Briefly, 1,8-DHN (150 mg) was dissolved in 7.5 mL acetonitrile in a round bottom flask. To this solution, 142.5 mL Milli-Q water was added, and the mixture was stirred for 5 minutes before quickly injecting 1 mL of 1N sodium periodate solution. The reaction quickly turned yellow and then grey upon injection of the oxidant. The reaction was stirred for 20 hours and then purified by centrifugation at 11,500 rpm for 10 minutes, with three cycles of washing by redispersion in Milli-Q water. Samples were stored in Milli-Q water at room temperature. The concentration (mg/mL) was determined by lyophilizing a known volume of S-AMNP suspension in a pre-weighed vial.

Hollow AMNP (H-AMNP) synthesis. H-AMNPs were synthesized from a fresh batch of purified S-AMNPs. S-AMNPs were stored in Milli-Q water, under ambient conditions, in a capped, plastic tube for 24 hours after synthesis. At this 24 hour mark, they were pelletized by centrifugation at 11,500 rpm for 12 minutes. The water was removed and replaced with MeOH to a final concentration of 0.5 mg/mL. The pellet was vortexed until full mixing was achieved (approximately 30 seconds), and the solution/suspension was then placed onto a horizontal shaker at 90 rpm for 6 days. This mixture was then dialyzed into Milli-Q water using 10 k molecular weight cutoff snakeskin dialysis tubing (Thermo Scientific), with the water changed 3 times over 2 days. If necessary, the particles were then re-concentrated to the desired amount by centrifuging at 11,500 rpm for 12 minutes and removing excess water.

Lacey AMNP (L-AMNP) synthesis. L-AMNPs were synthesized from a fresh batch of purified S-AMNPs. S-AMNPs were stored in Milli-Q water, under ambient conditions, in a capped, plastic tube for 48 hours after synthesis. At this 48 hour mark, they were pelletized by centrifugation at 11,500 rpm for 12 minutes. The water was removed and replaced with MeOH to a final concentration of 0.5 mg/mL. The pellet was vortexed until full mixing was achieved (approximately 30 seconds), and the solution/suspension was then placed onto a horizontal shaker at 90 rpm for 6 days. This mixture was then dialyzed into Milli-Q water using 10 k molecular weight cutoff snakeskin dialysis tubing, with the water changed 3 times over 2 days. If necessary, the particles were then re-concentrated to the desired amount by centrifuging at 11,500 rpm for 12 minutes and removing excess water.

SEM sample preparation. AMNPs were dropcasted onto a silicon wafer, air dried, and coated with 10 nm osmium before imaging with a Hitachi SU 8030 SEM operating at an accelerating voltage of 10 kV and an emission current of 15 μA.

AFM sample preparation. Samples were prepared by depositing 20 to 40 μL of AMNP in Milli-Q water onto 1 cm² freshly cleaved mica, letting it sit for 1 minute, and then blotting dry.

Embedding of H-AMNPs in resin for STEM imaging. AMNPs were pelletized in an Eppendorf tube. Dehydration occurred with a graded series of ethanol and acetone prior to infiltration with EMBed812 epoxy resin and the resin polymerized at 60° C. for 48 hours prior to ultramicrotomy using a Leica EM UC7 Ultramicrotome to obtain ultra-thin sections (80 nm). Micrographs were obtained on a Hitachi HD2300 STEM operating at 200 kV.

Light scattering measurements. Multi-angle DLS measurements were performed at 0.0001 wt % in Milli-Q water on an ALV/CGS-3 four-angle, compact goniometer system, which had a 22 mW HeNe linear polarized laser operating at a wavelength of λ=632.8 nm and scattering angles from θ=30-150°. Fluctuations in the scattering intensity were measured via an ALV/LSE-5004 multiple tau digital correlator, and analyzed via the intensity autocorrelation function (g⁽²⁾(T)). A cumulant analysis was used to fit the data, and the mutual diffusion coefficient was calculated through the relation:

$$Γ = {q}^{2} {D}_{m} \qquad ( Equation 1.1 )$$

where Γ is the average decay rate of the autocorrelation function and q is the scalar magnitude of the scattering vector. The hydrodynamic radius (Rₕ) was calculated through the Stokes-Einstein equation:

$${D}_{m} \approx {D}_{t} = \frac{{k}_{B} T}{6 π {η}_{s} {R}_{h}} \qquad ( Equation 1.2 )$$

where Dₘ is the mutual diffusion coefficient, Dₜ is the tracer diffusion coefficient, k_{B} is the Boltzmann constant, T is the absolute temperature, and ηₛ is the solvent viscosity. Samples were filtered through a 0.45 μm PVDF filter (Millipore) directly into pre-cleaned scattering cells prior to measurement.

The effective radius of gyration (R_{g}) was obtained from the SLS data through a Berry equation, which relates the inverse scattering intensity as a function of the scattering angle:

$${( \frac{Kc}{{R}_{θ}} )}^{1 {/}_{2}} = {[ ( \frac{1}{{M}_{w}} ) ( 1 + \frac{{q}^{2} {R}_{g}}{3} ) ]}^{1 {/}_{2}} \qquad ( Equation 1.3 )$$

where K is the optical constant and R_{θ} is the Rayleigh ratio. The assembly M_{w} can be extracted from the inverse y-intercept, while the R_{g} can be extracted from the slope of the linear relationship. The parameter ρ=R_{g}/Rₕ is an estimate of the compositional distribution of the particles, where ρ values of 0.775, 1.0, and >1 correspond to spherical micelles, vesicles, or elongated structures, respectively.

X-Ray scattering studies. Experiments were performed at beamline 5-ID-D of the DuPont-Northwestern-Dow Collaborative Access Team (DND-CAT) Synchrotron Research Center at the Advanced Photon Source (APS), Argonne National Laboratory. AMNPs were prepared at 10 mg/mL in Milli-Q water and during measurements flowed through a 1.5 mm glass capillary at 1 mm/sec for consistent background subtraction. Data was collected with X-Ray energy at 17 keV (λ=0.73 Å) with samples exposed for 10 frames of 0.2 seconds each. Sample to detector distances were as follows: 201.25 mm for SAXS (small-angle X-Ray scattering), 1014.2 mm for MAXS (mid-angle X-Ray scattering), and 8508.4 mm for WAXS (wide-angle X-Ray scattering). The scattering intensity was recorded in the interval 0.002390<q<4.4578 Å⁻¹. The scattering vector q is defined as:

$$q = ( \frac{4 π}{λ} ) sin ( \frac{θ}{2} ) \qquad ( Equation 1.4 )$$

where θ is the scattering angle. Azimuthal integration of the SAXS pattern to achieve 1D data was achieved using GSAS-II software (UChicago Argonne, LLC) developed at the APS. Samples were oscillated with a syringe pump during exposure to prevent beam damage. Background scattering patterns were obtained from samples containing Milli-Q water. This background data was then subtracted from experimental data. Modeling of the scattering data with a spherical core-shell geometrical model was conducted in the Irena software package running on IgorPro software.²

Scattering data were also assessed using ab initio dummy atom modeling (DAM) methods using the ATSAS analysis software.³ Pair distance distribution functions p(r) were calculated from the background subtracted scattering data (0.003 Å⁻¹ to 0.029 Å⁻¹) for each nanoparticle using the indirect Fourier transform method DATGNOM.⁴ The ab initio shape determination program DAMMIF was used to conduct ten separately refined models for each nanoparticle containing 10,000 beads each of approximately 40 Å.⁵ Similar models were obtained with either an emphasized Porod or logarithmic curve weighting function. The program DAMAVER was used to align the models and select the most probable; creating an average DAM where the occupancies of the atoms are proportional to the probability of the atom existing in all models.⁶ The normalized dummy atom occupancy for each averaged DAM was used to calculate a weighted R_{g} for each averaged DAM as well as shell to core bead probability ratios. The program SASRES was used to apply a Fourier shell correlation approach as an estimate of DAM resolution.

STEM imaging of AMNPs. AMNPs were imaged via bright-field STEM (BF-STEM) (FIGS. 12A-12O) using a Hitachi HD2300 STEM operating at 200 kV. 200 mesh copper TEM grids with formvar were surface plasma treated using a PELCO easiGlow glow discharge cleaning system. 2 μL of AMNP suspension was dropcasted and left to dry before imaging.

STEM size and density measurements. BF-STEM and high-angle annular dark-field STEM (HAADF-STEM) imaging for size and density measurements was performed on a JEOL 200 ARM operating at 200 kV. 200 mesh copper TEM grids with lacey carbon support layer were surface plasma treated using a PELCO easiGlow glow discharge cleaning system. Subsequently, 4 μL of AMNP suspension was dropcasted onto the TEM grid and allowed to dry. Images were collected in HAADF-STEM mode with a probe semiconvergence angle of 10 mrad and at a camera length of 20 cm. A beam current of 0.3 nA and pixel dwell times between 1 and 5 μs were used. For the radial average intensity measurements, individual melanin nanoparticles were cropped and a moving average filter of 5 px was applied to remove noise. Next, the radial averaged intensity from the center of the particle to the periphery was measured and normalized. The average and standard deviation of minimum 4 individual nanoparticles of each type were determined. The pixel size is 0.6 nm.

Gas sorption measurements. AMNPs, stored in Milli-Q water, were centrifuged at 11,500 rpm for 12 minutes, and the water was removed and replaced with EtOH. This process was repeated twice more with addition of fresh EtOH each time to ensure effective removal of water. Samples were activated using a tousimis SAMDRI-PVT-3D Advanced Manual Critical Point Dryer. Using the supercritical dryer, particles were added to the sample chamber, cooled to 0-10° C., and pressurized to 800 psi. Ethanol was exchanged with liquid CO₂ over a 10 hour period, purging the system for five minutes every two hours. After the fifth purge, the temperature was raised to 40° C. and the system was pressurized to 1200-1400 psi to obtain supercritical CO₂. Pressure was released slowly overnight at a rate of 0.5 cc/min. Samples were immediately transferred onto a Micromeritics Smart VacPrep and were placed under vacuum for two hours at 25° C. prior to sorption measurements. Nitrogen physisorption measurements were collected using a Micromeritics ASAP 2020 instrument at 77 K. Pore-size distributions were obtained using DFT calculations with a carbon slit geometry and an N₂ DFT model. CO₂ and CH₄ isotherms were measured using a Micromeritics ASAP 2020 instrument at 298 K. NH₃ isotherms were collected using a Micromeritics 3Flex Physisorption instrument at 298 K. Ideal adsorbed solution theory (IAST) calculations and isotherm fittings using a BET model for CO₂/CH₄ were performed using the Python package pyIAST.⁷

Diazinon and paraoxon toxin adsorption studies. Solutions of paraoxon and diazinon were prepared in Milli-Q water at concentrations varying from 1 to 100 ppm in 20 mL scintillation vials, and then 10, 20, or 40 μg (±1 μg) of AMNPs were added to the solution. Three replicates were performed for each concentration. The samples were mixed on a rotisserie mixer at room temperature for 2 h, in the dark, and then filtered with 0.2 mm PTFE syringe filters. Analysis of the target remaining in the sample was performed by HPLC. A Shimadzu High Performance Liquid Chromatography (HPLC) system with dual-plunger parallel flow solvent delivery modules (LC-20AD) and an auto-sampler (SIL-20AC; 40 μL injection volume) coupled to a photodiode array detector (SPD-M20A; 277 nm) was used for data collection. The stationary phase was a C18 stainless steel analytical column (Luna, 150 mm×4.6 mm, 3 μm diameter; Phenomenex, Torrance, CA) with an isocratic 45:55 acetonitrile: 1% aqueous acetic acid mobile phase (1.2 mL/min).⁸ The amount of target bound was determined based on the difference between the amount in the sample and the amount in the original target preparation using the same HPLC method. The resulting data was fit using the Langmuir isotherm to generate the saturation loading for the materials in gram/gram and an affinity coefficient (1/M) using the equation:

$$q = \frac{m {q}_{sat} k [ free ]}{1 + k [ Free ]} \qquad ( Equation 1.5 )$$

where q is the amount bound, m is the mass, qₛₐₜ is the capacity, and k is the affinity. The phenomenological Langmuir expression provides a reasonably good fit for the data collected and has been used previously for determination of parameters related to binding of energetics and pesticides by porous adsorbent materials.⁹⁻¹²

Deposition of AMNPs onto NYCO fabric. Deposition onto nylon-cotton (NYCO) fabric swatches (2.5 cm²) was developed through optimization of a previously reported protocol.¹³ Swatches were weighed using a microbalance and subsequently washed with Milli-Q water. The fabrics were then immersed in 8 mL of a 4 mg/mL AMNP suspension in water or into 8 mL of 4 mg/mL monomer solution in water. The solutions were stirred at 45° C. for 15 hours. The samples were then placed into centrifuge tubes containing 10 mL water and washed by vortexing the tubes for approximately 30 seconds. The washing process was repeated three times with fresh water. The samples were then sonicated in 10 mL water for 2 minutes to remove any unbound AMNPs from the fabric, and the process repeated 6 times. Finally, the samples were dried in an incubator at 40° C. for 30 minutes. Dried fabrics were weighed again and the amount of deposited melanin was calculated. The amount of material deposited onto each sample was as follows: 12.4 mg (S-AMNP), 12.7 mg (L-AMNP), 14.0 mg (H-AMNP), and 2.1 mg from the DHN monomer.

DMMP breakthrough studies on AMNP-coated NYCO fabric. The permeation of dimethyl methylphosphonate (DMMP) through NYCO fabric samples was assessed as described by Test Operations Procedure (TOP) 8-2-501, Permeation Testing of Materials with Chemical Agents or Simulants (Swatch Testing).^{14,15} An internal, probe driven heater was used to control the temperature within a custom environment. The ratio of humid to dry air entering this chamber was addressed using probe-driven mass flow controllers. The stainless-steel aerosol-vapor-liquid-assessment group (AVLAG) cell held the sample horizontally with O-ring seals. Diffusive permeation testing used a nitrogen stream. The target was placed in the headspace above the fabric swatch, which was stagnant, with no pressure difference above and below the swatch. The sample was supported between two solid support discs with aligned 0.64 cm² circular openings. This assembly was then placed in the AVLAG cell, and humidity equilibrated for 2 h. DMMP was introduced as liquid droplets using a repeating dispenser, and the concentration was monitored using a dedicated flame ionization detector (FID).

Water vapor transport studies on AMNP-coated NYCO fabric. The water vapor transport (WVT) rate for the treated fabrics was evaluated using a circular fabric sample with a total exposed area of 1.65 cm².¹⁵⁻¹⁷ The protocol is derived from guidance suggested by ASTM E96, Water Vapor Transport: Upright Open Cup Method to characterize water vapor transport through the fabric samples and uses an incubator modified to provide an enclosure at 25° C. A 20 mL scintillation vial was loaded with 16.9 mL deionized water. The fabric sample was sealed over this vial, and vial was weighed. A desiccant was used to drive a humidity differential in the incubator, with a dry nitrogen stream flowing across the surface of the sample (0.25 L/min). The weight of the vial was measured at 30 to 45 min intervals using an analytical balance.

TABLE 4
Modeling parameters derived from ab initio dummy atom modeling of AMNPs. R_{g, real} =
radius of gyration from real space, R_{g, recirocal} = radius of gyration calculated from
reciprocal space, R_{g, aDAM} = radius of gyration from the average dummy atom model,
Dₘₐₓ = maximum dimension, NSD = normalized spatial discrepancy, FSC resolution =
Fourier shell correlation resolution. R_{g, real}, NSD, and FSC resolution data all displayed
as mean ± standard deviation. For each particle, the real and reciprocal space radius of
gyration fitted by DATGNOM agree with each other, as does the final R_{g} as calculated from
the averaged DAM. Additionally the normalized spatial discrepancy of all ten separately
refined aligned models of a particle are below 1, indicative of the individual models
sharing a high degree of similarity for each nanoparticle.³ The variability
of the aligned models as analyzed by FSC suggests a true resolution of these models
is around 180 to 250 Å. This knowledge is used to guard against over interpretation
of small features in the averaged DAMs.

| | | | | | | FSC |
|---|---|---|---|---|---|---|
| | R_{g, real} | R_{g, reciprocal} | R_{g, aDAM} | Dₘₐₓ | | resolution |
| AMNP | (Å) | (Å) | (Å) | (Å) | NSD | (Å) |
| Solid | 474.3 ± 1.3 | 476.1 | 476.3 | 14235 | 0543 ± 0.012 | 180 ± 13 |
| Lacey | 558.2 ± 0.2 | 561.8 | 560.3 | 1400 | 0.672 ± 0.006 | 227 ± 16 |
| Hollow | 621.0 ± 0.6 | 626.3 | 624.4 | 1550.1 | 0.768 ± 0.013 | 249 ± 17 |
| Fresh Solid | 470.9 ± 0.3 | 473.4 | 472.9 | 1289.5 | 0.567 ± 0.013 | 193 ± 14 |

### REFERENCES CITED IN OR RELEVANT TO EXAMPLE 1B

1 Zhou, X. H. et al. Artificial Allomelanin Nanoparticles. Acs Nano 13, 10980-10990, doi: 10.1021/acsnano.9b02160 (2019).
2 Ilavsky, J. & Jemian, P. R. Irena: tool suite for modeling and analysis of small-angle scattering. J Appl Crystallogr 42, 347-353, doi: 10.1107/S0021889809002222 (2009).
3 Franke, D. et al. ATSAS 2.8: a comprehensive data analysis suite for small-angle scattering from macromolecular solutions. J Appl Crystallogr 50, 1212-1225, doi: 10.1107/S1600576717007786 (2017).
4 Petoukhov, M. V., Konarev, P. V., Kikhney, A. G. & Svergun, D. I. ATSAS 2.1—towards automated and web-supported small-angle scattering data analysis. J Appl Crystallogr 40, S223-S228, doi: 10.1107/S0021889807002853 (2007).
5 Franke, D. & Svergun, D. I. DAMMIF, a program for rapid ab-initio shape determination in small-angle scattering. J Appl Crystallogr 42, 342-346, doi: 10.1107/S0021889809000338 (2009).
6 Volkov, V. V. & Svergun, D. I. Uniqueness of ab initio shape determination in small-angle scattering. J Appl Crystallogr 36, 860-864, doi: 10.1107/S0021889803000268 (2003).
7 Simon, C. M., Smit, B. & Haranczyk, M. pyIAST: Ideal adsorbed solution theory (IAST) Python package. Comput Phys Commun 200, 364-380, doi:10.1016/j.cpc.2015.11.016 (2016).
8 Gebreegzi, Y. T., Foster, G. D. & Khan, S. U. Simultaneous determination of carbaryl, malathion, fenitrothion, and diazinon residues in sesame seeds (Sesamum indicum L.). Journal of Agricultural and Food Chemistry 48, 5165-5168, doi:10.1021/jf0004863 (2000).
9 Johnson, B. J. et al. Imprinted nanoporous organosilicas for selective adsorption, of nitroenergetic targets. Langmuir 24, 9024-9029, doi: 10.1021/la800615y (2008).
10 Johnson, B. J. et al. Macroporous silica for concentration of nitroenergetic targets. Talanta 81, 1454-1460, doi:10.1016/j.talanta.2010.02.050 (2010).
11 Johnson, B. J., Melde, B. J., Moore, M. H., Malanoski, A. P. & Taft, J. R. Improving Sorbents for Glycerol Capture in Biodiesel Refinement. Materials 10, doi:ARTN 68210.3390/ma10060682 (2017).
12 Johnson, B. J. et al. Adsorption of organophosphates from solution by porous organosilicates: Capillary phase-separation. Micropor Mesopor Mat 195, 154-160, doi:10.1016/j.micromeso.2014.04.031 (2014).
13 Battistella, C. et al. Mimicking Natural Human Hair Pigmentation with Synthetic Melanin. Acs Central Sci 6, 1179-1188, doi: 10.1021/acscentsci.0c00068 (2020).
14 D'Onofrio, T. G. Development of a Contact Permeation Test Fixture and Method. Report No. ECBC-TR-1141, (U.S. Army Research, Development and Engineering Command, 2013).
15 Martin, B. D. et al. An Elastomeric Poly(Thiophene-EDOT) Composite with a Dynamically Variable Permeability Towards Organic and Water Vapors. Adv Funct Mater 22, 3116-3127, doi: 10.1002/adfm.201102237 (2012).
16 Kar, F., Fan, J. T. & Yu, W. Comparison of different test methods for the measurement of fabric or garment moisture transfer properties. Meas Sci Technol 18, 2033-2038, doi:10.1088/0957-0233/18/7/032 (2007).
17 Pushpadass, H. A., Marx, D. B. & Hanna, M. A. Effects of Extrusion Temperature and Plasticizers on the Physical and Functional Properties of Starch Films. Starch-Starke 60, 527-538, doi: 10.1002/star.200800713 (2008).

### Example 2A: Synthetic Porous Melanin

This Example includes exemplary, non-limiting, materials or compositions, methods or steps, features, properties, and/or other embodiments useful in various aspects disclosed herein.

Commonly known as a skin pigment, melanin has a vital role in UV radiation protection, primarily acting as a radical scavenger. However, a lesser known natural property of melanin, observed in some melanized organisms, is its capacity to adsorb toxins, including metals and organic molecules. Inspired by this, we set out to generate a synthetic porous melanin, that would pave the way to enhancing the natural adsorbent properties of melanin and melanin-like materials. Here, we have developed a method for synthesis of porous polydopamine-based melanin utilizing a mesoporous silica (MS) nanoparticle template and characterized its physical properties. Through the oxidative polymerization of dopamine, followed by the etching of silica, we generated synthetic porous melanin (SPM) with the highest measured surface area of any known polydopamine-based material. The prepared SPM was effective for the uptake of various gases and organophosphate toxins, with the material exhibiting high selectivity for CO₂ over CH₄, and high potential for ammonia capture. This demonstrates advantages provided by synthetic porous melanin and melanin's capabilities as an adsorbent.

Melanin is a natural biomaterial that is found in microorganisms, animals, and plants.¹ It has a myriad of functions in biology, with the most well-known being a dark brown pigment for coloration and UV radiation protection in skin.²⁻⁴ Of interest here, is the fact that melanin, within living organisms, advantageously adsorbs small organic molecules from the environment. For example, turtleheaded seasnakes, which have dark melanized stripes and are found in industrial and urban areas, uptake and subsequently shed toxic molecules, such as arsenic and other metals.⁵ There is evidence that some organisms generate melanin as an adsorbent to defend against self-poisoning, as seen with paralytic shellfish poison, an alkaloid neurotoxin, produced by butter clams.⁶ Melanin has also been shown to uptake herbicides such as paraquat and diquat,⁷ the malarial prophylactic drug chloroquine,⁸ and the addictive toxin nicotine.⁹ Intriguingly, while melanin is clearly widely deployed as an adsorbent in living organisms, a porous melanin has not been found in nature.

Polydopamine (PDA), synthesized through the oxidative polymerization of dopamine, has been studied extensively in chemical, biological, medical, and engineering applications as a mimic of eumelanin, one of the three main classes of known, naturally occurring melanins (eumelanin, allomelanin, and pheomelanin).¹⁰⁻¹³ Most commonly, PDA is used as an adhesive layer and for the functionalization of the surface or internal structures of materials. The functional groups (catechols and amines) present in PDA engenders PDA-based materials with rich surface chemistry that can be taken advantage of for numerous applications. Such composite materials have been used as films or membranes to reject nerve and blister agent simulant vapors,¹⁴ to adsorb proteins,¹⁵⁻¹⁷ and for heavy metal binding^{18, 19} and removal.²⁰⁻²³ Inspired by this demonstrated ability of PDA and its composites to adsorb small organic molecules and metals, and by the fact that natural melanin is known to do the same, we set out to develop a synthetic route to microporous melanin. Accessing a porous synthetic melanin would allow us to optimize and capitalize on PDA adsorption characteristics by increasing surface area and thereby exposed binding sites for possible adsorption, which is advantageous in a range of applications including gas adsorption and toxin remediation.

### Results and Discussion for Example 2A and 2B:

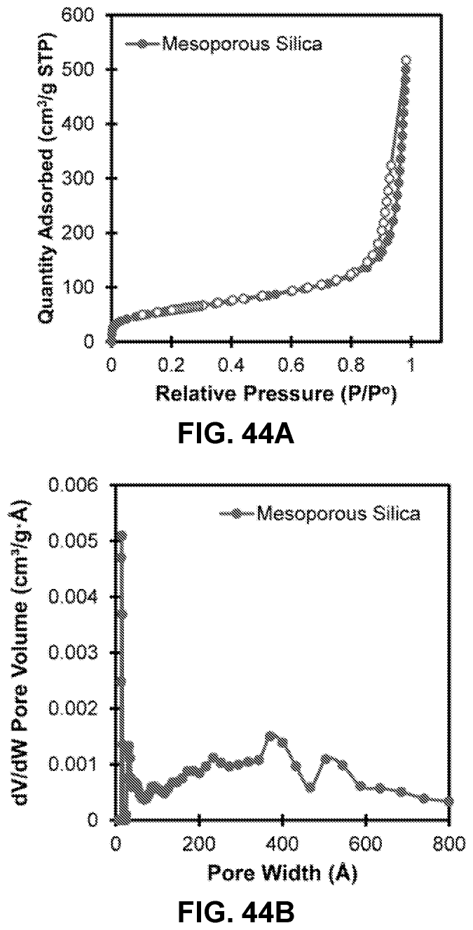

In these Examples, we used a templating strategy to introduce micro- and mesoporosity into synthetic melanin (FIG. 41). We chose mesoporous silica (MS) for its bimodal interconnected pore structure, which we hypothesized would allow for dopamine to enter the particle, polymerize both inside and outside of the MS template, and remain interconnected upon MS template removal via etching with hydrofluoric acid (HF). With this strategy, there is no need to functionalize the surface of the MS particles or modify dopamine, as dopamine readily adheres to silica through covalent and non-covalent interactions such as Van der Waals interactions and hydrogen bonding.^{24, 25} Therefore, MS was made as previously reported (FIGS. 44A-44D).²⁶ Briefly, cetyltrimethylammonium bromide (0.55 g) and poly(acrylic acid) (3.00 g) were stirred together in water at room temperature until dissolved. Ammonium hydroxide (2.0 g) was added to the solution and stirred for 20 minutes. Finally, tetraethyl orthosilicate (2.08 g) was added and the solution was heated at 120° C. for 48 h and then calcined at 550° C. for 6 h. The synthesized MS possess approximately 3 Å and 25 Å pores and a surface area of 200 m²/g, as characterized by N₂ sorption (FIGS. 44A-44B). There is a clear bimodal particle size distribution, as seen in scanning electron microscopy (SEM) images, with smaller sized particles of 210±50 nm and larger sized particles of 650±70 nm (FIGS. 44C-44D), which is also supported by dynamic light scattering (DLS) analysis (Table 5).

TABLE 5
Uncoated and Coated Mesoporous Silica (MS)
Characterization and Porosity Parameters

| | Diameter | Zeta | BET | Pore | | |
|---|---|---|---|---|---|---|
| | by DLS | Potential | area | Volume | Microporous | Mesoporous |
| Particles | (nm) | (mV) | (m²/g) | (cm³/g) | Size (Å) | Size (Å) |
| MS | 170 ± 15 | −54 ± 13 | 200 | 0.80 | 14 | ~380 |
| | 650 ± 35 | | | | | |
| MS@5% SPM | 340 ± 9 | −32 ± 5 | 140 | 0.74 | 14 | ~340 |
| MS@25% SPM | 460 ± 6 | −26 ± 5 | 100 | 0.52 | 14 | ~300 |

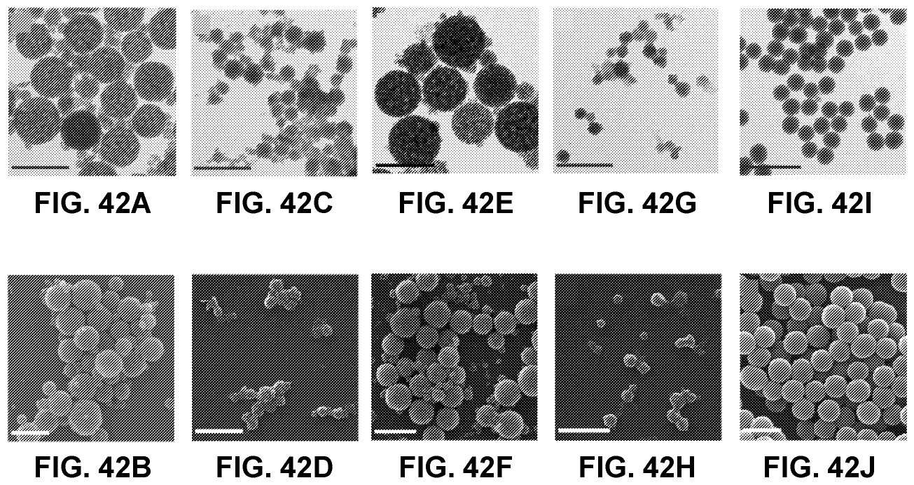

We fabricated the synthetic porous melanin (SPM) by combining dopamine and MS in a 1:9 solution of ethanol: tris buffer (10 mM in ultrapure water, pH 8.5) and oxidatively polymerizing. The resulting coated MS was then subjected to a 10 wt % HF etch to recover the SPM (FIGS. 41 and 42A-42J). To compare to the hard-templated SPM, we synthesized PDA particles through an oxidative polymerization using sodium hydroxide (FIGS. 42I-42J).

Different MS loadings were achieved depending on the dopamine polymerization time utilized. Longer polymerization times led to higher quantities of polydopamine coated onto and in the silica template, which was evident by the mass of polydopamine remaining after etching as well as the nitrogen isotherms of the coated particles before etching, which decreased after coating (FIGS. 1A-1B, Table 5). Two types of synthetic porous melanin were made in this manner: a four-hour polymerized, 5% Loaded SPM (FIGS. 42C-42D) and a 21-hour polymerized, 25% Loaded SPM (FIGS. 42G-42H). For the pre-etched 5% Loaded SPM (MS@5% SPM), the BET area decreased by 60 m²/g (FIG. 42A), while for the pre-etched 25% Loaded SPM (MS@25% SPM), the BET area decreased by 100 m²/g (FIG. 42B). The larger BET area difference between MS and MS@25% SPM indicates that a longer polymerization time led to more polydopamine coating the template. Polymerization times shorter than four hours resulted in a fragile polydopamine coating that disintegrated during the etching process. To ensure solid particles of PDA were not forming independently during the coating process, we chose Trizma@base (tris buffer) as a catalyst to alter the polymerization growth mechanism. Researchers have proposed that the amine group on tris is covalently incorporated into the polydopamine structure by binding to the catechol ring blocking a reactive position on the aromatic ring and limiting the degree of polymerization and aggregation.²⁷ Additionally, we used ethanol during the polymerization to serve as a radical-trapping agent and decrease the rate of polymerization, allowing for a more controllable polymerization at the silica interface.²⁸

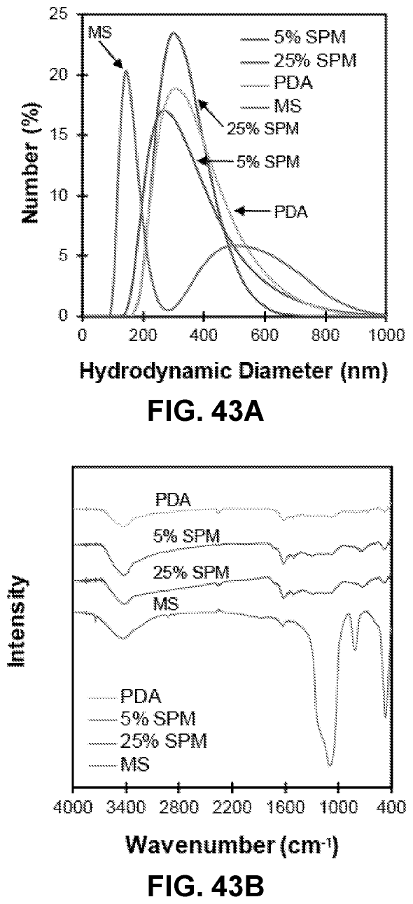

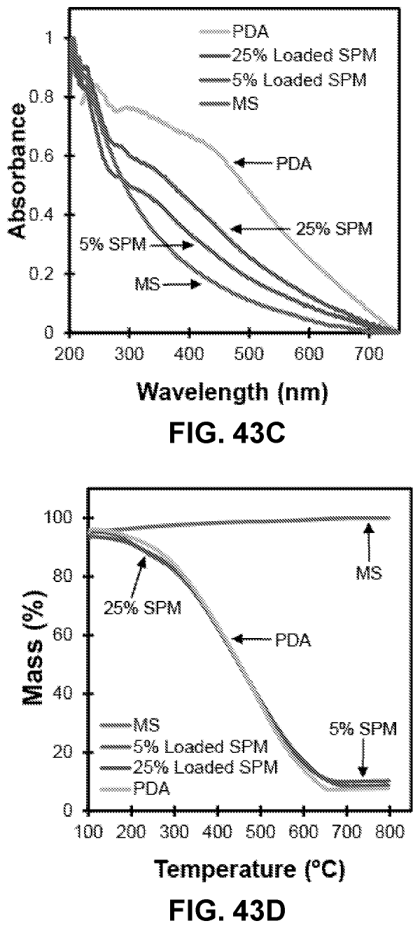

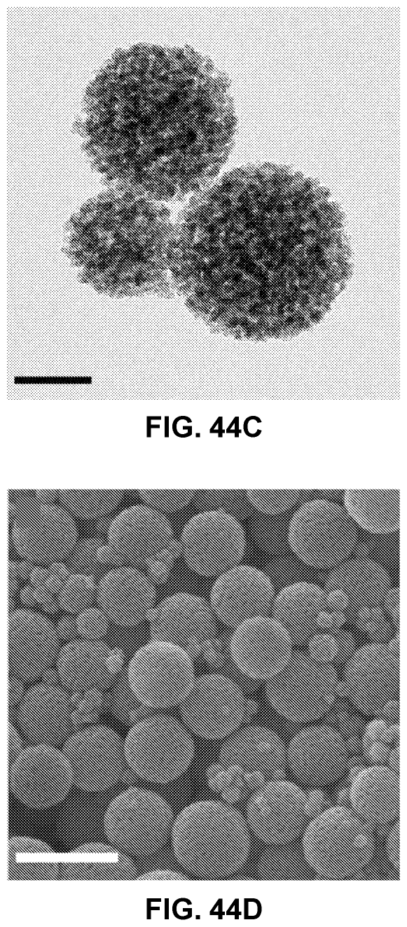

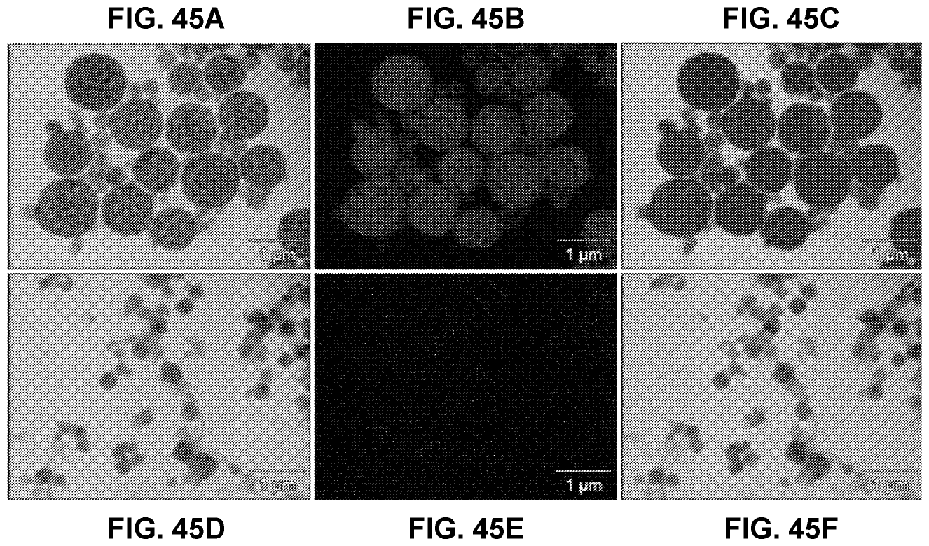

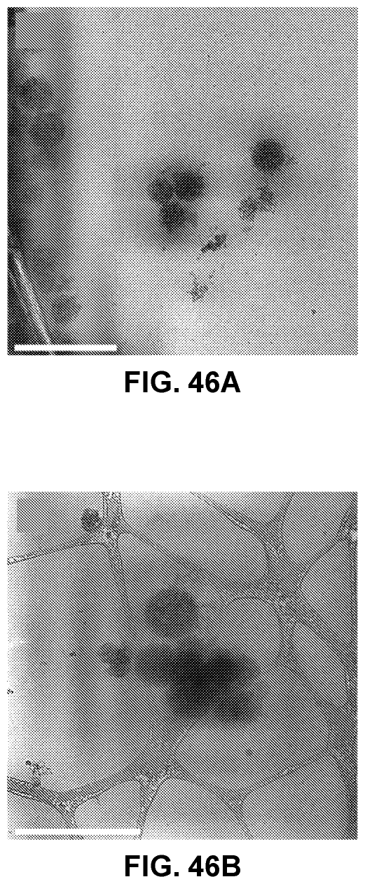

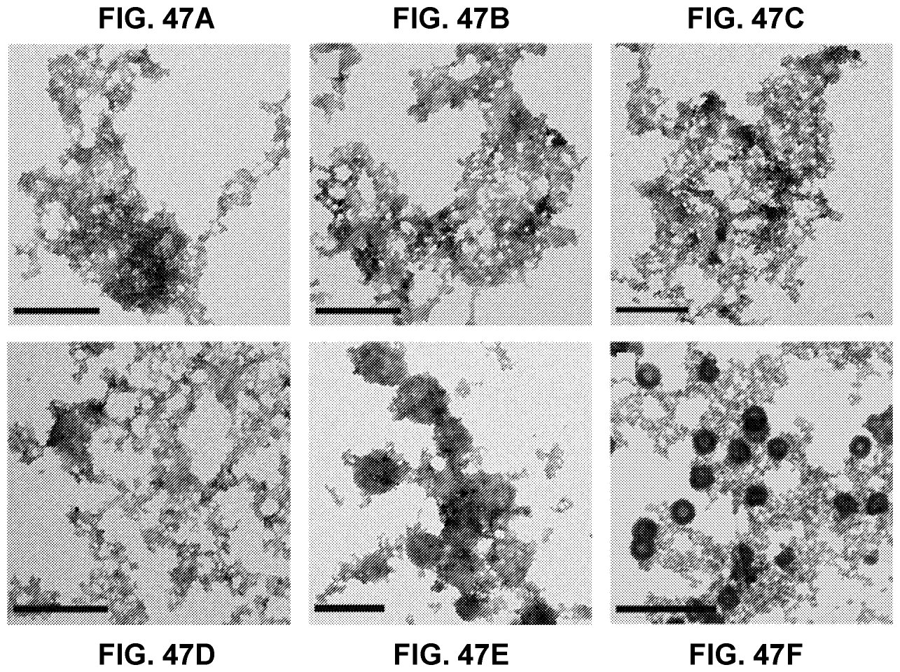

We characterized the morphology of the SPM nanoparticles before and after etching (FIGS. 42A-42J and 43A-43D). Transmission electron microscopy (TEM) (FIGS. 42C and 42G) and SEM (FIGS. 42D and 42H) provided insight into the size of the particles, and the silica content was measured using energy-dispersive X-ray spectroscopy (EDS) (FIGS. 45A-45F). The PDA nanoparticles had an average diameter of 290±20 nm as calculated from TEM micrographs (FIG. 42I). Both 5% and 25% Loaded SPM had similar average diameters of 280±60 nm and 230±50 nm respectively, based on TEM images (FIGS. 42C and 42G). Similarly, using DLS, the average hydrodynamic diameter was measured to be 330±20 nm for 5% Loaded SPM and 330±10 nm for 25% Loaded SPM and a dispersity of 0.62 and 0.66, respectively, with diameters between 150 and 800 nm (FIG. 43A, Table 6). These hydrodynamic diameters were comparable to PDA nanoparticles, which had a diameter of 360±2 nm with a dispersity of 0.66 and diameter range between 160 and 800 nm. Based on the TEM and SEM micrographs, the SPM nanoparticles tended to aggregate together and did not have a well-defined morphology. This was corroborated by cryogenic TEM, indicating that the aggregation was not an artifact of dry state TEM (FIGS. 46A-46B). This likely accounts for the dispersity evident from DLS measurements of the hydrodynamic diameter. Based on TEM images and DLS data, the etched SPM had a smaller diameter compared to the MS template, indicating the PDA structures collapse on themselves upon removal of the silica during the HF etch. In addition to the nanoparticles synthesized through hard templating methods, there were some unstructured polydopamine aggregates that formed free in solution, not associated with MS or SPM. Different ratios of dopamine monomer to mesoporous silica were evaluated to optimize the process, and the resulting 9 mg/ml:10 mg/ml of dopamine:MS had the fewest PDA aggregates and the most MS coated particles as seen by TEM (FIGS. 47A-47F). EDS showed that little silicon remained after the etching process (FIGS. 45A-45F).

TABLE 6
Synthetic Porous Melanin Characterization and Porosity Parameters

| | | Zeta | | Pore | | |
|---|---|---|---|---|---|---|
| | Diameter by | Potential | BET area | Volume | Micropore | Mesopore |
| Particles | DLS (nm) | (mV) | (m²/g) | (cm³/g) | Size (Å) | Size (Å) |
| 5% Loaded | 330 ± 20 | −34 ± 4 | 215 | 0.33 | ~13 | 150 |
| SPM | | | | | | |
| 25% Loaded | 330 ± 10 | −24 ± 4 | 140 | 0.30 | ~14 | 130 |
| SPM | | | | | | |
| PDA | 360 ± 2 | −30 ± 5 | 20 | 0.02 | — | — |

To probe the colloidal stability of the materials, we performed zeta potential measurements of the SPM and PDA nanoparticles (Table 6, Table 5). Sodium hydroxide was used to adjust the solutions of all the particles to a pH of 7 to compare all particles at a similar pH. The 5% and 25% Loaded SPM had zeta-potentials of −24±4 and −34±4 mV, respectively. Both SPM particles are moderately stable in solution based on their zeta potentials, but have some aggregation, which is also corroborated in TEM and SEM images (FIGS. 42C, 42D, 42G and 42H). As compared to MS, the absolute zeta potential value decreased after the template was coated and stayed the same after etching (Table 5). The 5% Loaded SPM was the most stable in solution. Similarly, the PDA nanoparticles have a zeta potential of −30±5 mV.

Fourier-transform infrared spectroscopy (FT-IR) showed no spectroscopic differences between PDA and SPM (FIG. 43B). All three particles had broad peaks between 3300 and 3700 cm⁻¹ region attributed to catechol stretching vibration of O—H on the benzene ring and stretching vibration of N—H. Additionally, all spectra showed a peak at 1620 cm⁻¹ can be assigned to stretching vibration of C═C on the benzene ring or bending vibration of OH groups of adsorbed water, and the peak at 1510 cm⁻¹ can be attributed to C═N vibrational stretching on the pyrrole.²⁹ For the MS template, the FT-IR was similar to those found in literature.³⁰ There is a broad peak from 3300 to 3700 cm⁻¹ in all materials, which can be attributed to stretching vibration of O—H, and a peak at 1620 cm⁻¹ attributed to bending vibration of OH groups of adsorbed water. The peaks at 390, 770, and 1210 cm⁻¹ are due to the asymmetric stretching vibration or vibrational bending of Si—O—Si bonds. The lack of Si—O—Si peaks in the SPM spectra additionally corroborated the complete removal of silica after etching.

To further illustrate the similarities between SPM and PDA and to confirm that polydopamine was not affected by the etching, UV-Vis spectroscopy was performed. 5% and 25% Loaded SPM showed the same UV-Vis absorption spectra as the solid PDA nanoparticles (FIG. 43C). All three particles had maxima at approximately 200 nm with a broad absorption tail.

The thermal stability of the 5% Loaded SPM was similar to what has been reported previously for PDA.^{31, 32} The thermogravimetric analysis (TGA) showed an initial weight loss around 100° C., attributed to adsorbed water, and a steady weight-loss of material until around 300° C., where there was a steep decrease, with most of the material decomposing at approx. 650° C. (FIG. 43D). Since the TGA was performed in air, the remaining 5-10% mass can be attributed to remaining silica.

Nitrogen sorption at 77K was measured to probe the porosity and elucidate differences between the 5% and 25% SPM and PDA nanoparticles (FIGS. 2A-2B, Table 6). The PDA nanoparticle sorption isotherm remained relatively flat throughout the measurement and showed little nitrogen uptake, indicating a non-porous material, which was corroborated by the low Brunauer-Emmett-Teller (BET) area of 20 m²/g and total pore volume of 0.02 cm³/g. In contrast, 5% and 25% Loaded SPM isotherms have an initial steep increase in the N₂ adsorption indicating the presence of micropores (FIG. 2A). The BET areas of 5% and 25% Loaded SPM were 215 and 140 m²/g, respectively. Importantly, this is the highest BET area that has been reported thus far for a particle having only of polydopamine. Previous soft templating methods have produced porous polydopamine particles with a BET area of 45 m²/g.³³

The total pore volume of 5% Loaded SPM was 0.33 cm³/g and 0.30 cm³/g for 25% Loaded SPM. The lower total pore volume and surface area of the 25% Loaded SPM suggested that longer polymerization times lead to more dopamine polymerization within and on the mesoporous silica template. Both SPM nanoparticles have similar pore size distributions with micropore sizes of about 13 Å and a broad distribution of mesopore sizes between 50 and 300 Å with peaks around 150 Å, as determined by Density Functional Theory (DFT) calculations (FIG. 2B). In addition to the synthetic melanins, we measured a N₂ isotherm for natural melanin from Sepia officinalis (squid ink), which proved to be non-porous relative to our synthetic materials with a BET area of only 6 m²/g. While there continues to be a paucity of evidence of porous natural melanin, the porosity that was achievable in our materials alludes to systems existing in nature that have yet to be discovered. The micro- and mesopore sizes and increased surface area along with polydopamine's strong covalent and non-covalent interactions with other molecules made these materials particularly interesting for toxin adsorption studies.

The efficient removal and capture of greenhouse gases, such as carbon dioxide and methane, is of growing interest.³⁴ Carbon dioxide is considered a contaminant in natural gas; as the use of natural gas increases as a source of fuel, the need to efficiently remove and store carbon dioxide has become even more crucial.³⁵ Owing to the functionalized surface of the SPM, we performed uptake studies of CO₂ and CH₄ to discern if SPM would be a good candidate for their storage and separation (FIGS. 3A-3D). Adsorption isotherms of CO₂ were recorded at 273, 283, and 298 K (FIGS. 3A-3B, Table 7). The CO₂ uptake of the 5% Loaded SPM was 35.5, 28.8, and 18.9 cm³/g at 273, 283, and 298 K, respectively. For the 25% Loaded SPM the CO₂ uptake was 18.4, 15.8, and 12.2 cm³/g at 273, 283, and 298 K, respectively. For both SPM, the uptake values decrease with increasing temperature suggesting that the adsorption process is exothermic and CO₂ and SPM were interacting through physisorption.^{36, 37} 5% Loaded SPM had slightly higher CO₂ uptake than 25% Loaded SPM, most likely due to its higher BET area and pore volume. The CO₂ uptake was similar and even superior to some other hard templated polymeric porous polymers, as well as other porous polymers.³⁷-42 Initially, the adsorption curve of CO₂ was steep, indicating that SPM was able to adsorb well at lower pressures. CO₂ has a large quadruple moment of 4.30×10²⁶/esu cm² and is electrophilic.⁴³ Therefore, having electron rich elements such as oxygen and nitrogen promotes interfacial interaction with CO₂.³⁶ SPM has many catechol and amine groups, which serve as adsorption sites, so it has an affinity adsorb CO₂. The lower CO₂ loadings compared to other reported amine-containing polymers^{36, 44} were ascribed to the large percentage of mesopores in the SPM particles, as adsorption of small gases is facilitated by having ultramicroporous structures.³⁸

TABLE 7
Gas Adsorption of CO2 and CH4 by Synthetic Porous Melanin

| | | | | Qst | | | | Qst |
|---|---|---|---|---|---|---|---|---|
| | CO₂ Uptake (cm³/g STP) | | | CO₂ | CH₄ Uptake (cm³/g STP) | | | CH₄ |
| Particles | 273 K | 288 K | 298 K | (kJ/mol) | 273 K | 288 K | 298 K | (kJ/mol) |
| 5% Loaded | 35.5 | 28.8 | 18.9 | 48.2 | 11.0 | 8.3 | 3.6 | 15.1 |
| SPM | | | | | | | | |
| 25% Loaded | 18.4 | 15.8 | 12.2 | 20.3 | 4.2 | 3.3 | 1.8 | 26.0 |
| SPM | | | | | | | | |

CH₄ adsorption isotherms for SPM were also taken at 273, 283, and 298 K (FIGS. 3C-3D, Table 7). The 5% Loaded SPM CH₄ uptake was 11.0, 8.3, and 3.6 cm³/g, and for 25% Loaded SPM the uptake was 4.2, 3.3, and 1.8 cm³/g at 273, 288, 298 K, respectively. Analogous to the CO₂ adsorption study, the uptake values for both SPM particles decreased with increasing temperature indicating physisorption. However, the CH₄ uptake was much lower than the CO₂ uptake for both 5% and 25% SPM. Unlike CO₂, methane does not have a quadruple moment, so adsorption is directed by pore size rather than molecular interaction. The low methane adsorption suggests SPM could preferentially uptake CO₂ over CH₄. H₂ adsorption isotherms were also performed at 273, 283, and 298 K, but SPM showed negligible adsorption, which is not uncommon for a material with a large proportion of mesopores (FIGS. 4A-4B, Table 8).⁴⁵

TABLE 8
H₂ Adsorption by Synthetic Porous Melanin

| | H₂ Uptake (cm³/g STP) | | |
|---|---|---|---|
| Particles | 273 K | 288 K | 298 K |
| 5% Loaded SPM | 3.03 | 3.48 | 0.68 |
| 25% Loaded SPM | 0.85 | 0.90 | 0.21 |

The higher adsorption of CO₂ compared to CH₄, which derives from the intermolecular interactions, as seen by CO₂ and CH₄ isotherms, led us to investigate the efficacy of this material for CO₂ capture in natural gas. Therefore, we calculated the of selectivities of CO₂ vs CH₄ in SPM and PDA nanoparticles using ideal adsorption solution theory (IAST).46 We probed gas phase mole fractions of 0.05 CO₂ and 0.95 CH₄, which is a typical composition found for natural gas purification.⁴⁷ Isotherms were fit using a BET model with the Python package pyIAST.⁴⁶ Both 5% and 25% Loaded SPM showed selectivity for CO₂ over CH₄ (FIG. 6). The 25% Loaded SPM showed higher selectivity (16-22 at 1 bar) than 5% Loaded SPM (9-12 at 1 bar). The highest selectivity was observed for 25% Loaded SPM at 298 K at very low pressures (19) and 1 bar (22), which is higher selectivity than for some metal-organic frameworks (MOFs).⁴⁸⁻⁵¹ To further elucidate the interaction between CO₂ and CH₄ gases and SPM, we calculated isosteric heats of adsorption (Qst) using the Clausius-Clapeyron equation from the isotherms collected at 273, 288, and 298 K (FIGS. 6A-6D). The Qst of 5% Loaded SPM was 48.2 kJ/mol for CO₂ and 15.1 kJ/mol for CH₄, and the Qst of 25% Loaded SPM was 30.3 kJ/mol for CO₂ and 26.0 kJ/mol for CH₄. The higher Qst for CO₂ for both SPM particles corroborates the CO₂ over CH₄ selectivity. Given the differences seen between 5% and 25% Loaded SPM in terms of uptake, we wanted to further examine the surface chemistry of these materials through ammonia and chemical warfare agent (CWA) simulant adsorption. The adsorption of such compounds would be driven by porosity as well as intermolecular interactions. As increasing the porosity also increases the available surface area and binding sites, the adsorption of ammonia and CWAs would elucidate the role of surface chemistry in 5% and 25% SPM.

Ammonia adsorption is crucial both environmentally and industrially as it is one of the most produced chemicals worldwide.⁵² Given SPM's rich adsorption chemistry and abundance of catechol groups, ammonia adsorption isotherms were also performed at 298 K for 25% Loaded SPM, 5% Loaded SPM, and solid PDA (FIG. 7). Synthetic Porous Melanin had high uptake of ammonia of 11.1 and 11.9 mmol/g for 5% and 25% Loaded SPM at 750 Torr, or 1 bar, respectively. As all the polydopamine-derived particles studied herein possess similar surface chemistry, the higher ammonia uptake for SPM compared to the non-porous PDA (8.2 mmol/g at 750 Torr) was attributed to the increase in surface area. In contrast to this surface area trend, we believe that the 25% SPM outperformed the 5% SPM due to an increase in catechol concentration and adsorption sites present deriving from the increased polymer content. Notably, the sharp uptake at low pressures indicates a strong interaction between NH₃ molecules and the functionalized binding sites on these PDA-based materials. SPM's large capacity for ammonia is comparable to and even exceeds the performance of other materials, such as MOFs,⁵³ zeolites,⁵⁴ activated carbon,⁵⁵ and mesoporous silica.⁵⁶

Due to the high SPM surface area and binding affinity, the uptake of chemical warfare agent (CWA) simulants was investigated (FIGS. 8A-8B). CWAs are highly toxic substances that have devastating and even lethal effects on humans.⁵⁷ They were developed as a modern weapon during World War I, and although they have been internationally banned,⁵⁸ CWAs continue to be used in attacks on both civilians and military personnel.^{59, 60} Adsorption of the organophosphate pesticides diazinon (FIG. 8A) and paraoxon (FIG. 8B) was performed with 5% and 25% SPM and PDA nanoparticles to simulate the adsorption of nerve gas agents. As shown in Table 9, for diazinon the saturation loading was 44.1, 59.9, and 51.1 g/g and the affinity was 66,200; 34,290; and 6,750 M⁻¹ for 5% Loaded SPM, 25% Loaded SPM, and PDA, respectively. For paraoxon the saturation loading was 12.9, 17.9, and 4.4 g/g and the affinity was 7,550, 3,630, and 6,589 M⁻¹ for 5% Loaded SPM, 25% Loaded SPM, and PDA, respectively. The saturation loading for both paraoxon and diazinon was highest for the 25% Loaded SPM particles and the affinity was highest for 5% Loaded SPM particles. Diazinon and paraoxon bind to polydopamine through aromatic interactions and hydrogen bonding; the increase in adsorption of the organophosphates by SPM is most likely due to the increase in available surface area. The differences in saturation loading and affinity between 5% and 25% loaded SPM can be attributed to their surface chemistry, which is also evident in the NH₃ adsorption. The 25% Loaded SPM had a higher concentration of polydopamine due to the longer polymerization time, giving a higher density of binding sites per volume, despite its lower surface area. The functionalization of SPM plays a crucial role in adsorption; along with their surface areas, the 5% and 25% Loaded SPM also differ in the density of functional groups available for binding.

TABLE 9
Diazinon and paraoxon saturation and affinity

| | Diazinon | | Paraoxon | |
|---|---|---|---|---|
| | Saturation | Affinity | Saturation | Affinity |
| Particles | Loading (g/g) | (M⁻¹) | Loading (g/g) | (M⁻¹) |
| 5% Loaded | 44.1 | 66,200 | 12.9 | 7,550 |
| SPM | | | | |
| 25% Loaded | 59.9 | 34,290 | 17.9 | 3,630 |
| SPM | | | | |
| PDA | 51.1 | 6,750 | 4.4 | 6,589 |

Due to the promising ammonia and organophosphate adsorption observed for SPM, we initiated studies on the adsorption of dimethyl methylphosphonate (DMMP), a simulant for sarin, on SPM and PDA coated textiles (FIGS. 9A-9N). Sarin is an extremely toxic and potent nerve gas agent.⁶¹ A method to efficiently adsorb sarin is critical as it is difficult to detect because it is a colorless and odorless compound. DMMP breakthrough studies on PDA and SPM coated nylon-cotton (NyCo) blended fabric⁶² were completed toward the development of a filter system utilizing SPM (FIG. 9A). NyCo was evenly coated via two methods. One involved polymerizing dopamine in tris buffer (dopamine+tris buffer) in the presence of the fabric (FIGS. 9C-9E). The others involved the deposition of solid PDA, 5% Loaded SPM, or 25% Loaded SPM (FIGS. 9F-9N) onto the NyCo fabric. All of the coated fabrics had a high water vapor transport rate comparable to that of the unmodified NyCo, indicating the fabrics are still breathable after coating (FIG. 9B and FIG. 11). DMMP breakthrough experiments were conducted using a concentration of 5 mg/m³. The unmodified NyCo control, the dopamine+tris buffer treated fabric, and 5% SPM all exhibited a breakthrough of DMMP. However, the 5% SPM coated fabric was able to significantly extend the time to initial breakthrough compared to the control NyCo fabric. With these three samples, while DMMP passed through over 1,000 minutes, the composite materials were able to minimize the total amount of DMMP recovered (FIG. 9B and FIG. 10). In contrast, 25% Loaded SPM and PDA nanoparticles were able to retain DMMP with no breakthrough above the 5 mg/m³ and minimal DMMP accumulating during the 1,000-minute experiment: 49 μg for 25% SPM and 82 μg for PDA. The different adsorption capabilities of 5% and 25% Loaded SPM reveal a tunable system that can be optimized based on the targeted material of adsorption.

In summary, synthetic porous melanin (SPM) was prepared using a mesoporous silica nanoparticle template and characterized by FT-IR, TGA, UV-Vis,

DLS, SEM, TEM, and EDS, confirming the formation of polydopamine and removal of the mesoporous silica template. N₂ sorption analysis revealed the micro- and mesoporosity of SPM and the highest S_{BET} of synthetic melanin of 215 m²/g and 140 m²/g for 5% and 25% Loaded SPM, respectively. CO₂ adsorption revealed an uptake comparable to other templated and non-templated porous polymers, with an uptake of 26.6 and 18.4 cm³/g at 273 K for 5% and 25% Loaded SPM, and a high selectivity of carbon dioxide over methane. The 5% and 25% Loaded SPM were also able to uptake more ammonia and bind a larger quantity of diazinon and paraoxon than PDA nanoparticles. Additionally, 25% SPM embedded in fabric showed promise as an absorber of DMMP.

A porous biocompatible material providing capture of gases and toxic compounds may be of interest in a range of applications. Additionally, it is widely appreciated that melanin can chelate copper,⁶³ iron,^{64, 65} and heavy metals such as lead (II) and cadmium (II)⁶⁶ and the coordination chemistry of synthetic melanins is rich.¹⁸ Increasing and tuning the porosity of melanin could lead to better metal uptake in terms of capacity or kinetics and could enhance a number of melanin's other wide-ranging properties, such as radical quenching, redox, and radiolysis protection. Finally, the successful synthesis of porous synthetic melanin raises the question of the diversity of porosity that may be found in natural melanin systems. These studies point at the potential advantages that could be obtained by living organisms through the production of porous melanin. Indeed, such materials may already exist, yet remain undiscovered.

### REFERENCES CITED IN OR RELEVANT TO EXAMPLE 2A

1. D'Alba, L.; Shawkey, M. D. Melanosomes: Biogenesis, Properties, and Evolution of an Ancient Organelle. Physiol. Rev. 2019, 99 (1), 1-19.
2. Simon, J. D.; Peels, D. N. The Red and the Black. Acc. Chem. Res. 2010, 43 (11), 1452-1460.
3. Huang, Y.; Li, Y.; Hu, Z.; Yue, X.; Proetto, M. T.; Jones, Y.; Gianneschi, N. C. Mimicking Melanosomes: Polydopamine Nanoparticles as Artificial Microparasols. ACS Cent. Sci. 2017, 3 (6), 564-569.
4. Solano, F. Melanins: Skin Pigments and Much More—Types, Structural Models, Biological Functions, and Formation Routes. New Sci. J. 2014, 2014, 1-28.
5. Goiran, C.; Bustamante, P.; Shine, R. Industrial Melanism in the Seasnake Emydocephalus annulatus. Curr. Biol. 2017, 27 (16), 2510-2513.
6. Price, R. J.; Lee, J. S. Paralytic Shellfish Poison and Melanin Distribution in Fractions of Toxic Butter Clam (Saxidomus giganteus) Siphon. Can. J. Fish. Aquat. Sci. 1972, 29 (11), 1657-1658.
7. Larsson, B.; Oskarsson, A.; Tjalve, H. Binding of paraquat and diquat on melanin. Exp. Eye Res. 1977, 25 (4), 353-359.
8. Schroeder, R. L.; Gerber, J. P. Chloroquine and Hydroxychloroquine Binding to Melanin: Some Possible Consequences for Pathologies. Toxicol. Rep. 2014, 1, 963-968.
9. Yerger, V. B.; Malone, R. E. Melanin and Nicotine: A Review of the Literature. Nicotine Tob. Res. 2006, 8 (4), 487-98.
10. Liu, Y.; Ai, K.; Lu, L. Polydopamine and its Derivative Materials: Synthesis and Promising Applications in Energy, Environmental, and Biomedical Fields. Chem. Rev. 2014, 114 (9), 5057-115.
11. Mrowczynski, R. Polydopamine-Based Multifunctional (Nano)materials for Cancer Therapy. ACS Appl. Mater. Interfaces 2018, 10 (9), 7541-7561.
12. Ryu, J. H.; Messersmith, P. B.; Lee, H. Polydopamine Surface Chemistry: A Decade of Discovery. ACS Appl. Mater. Interfaces 2018, 10 (9), 7523-7540.
13. Cheng, W.; Zeng, X.; Chen, H.; Li, Z.; Zeng, W.; Mei, L.; Zhao, Y. Versatile Polydopamine Platforms: Synthesis and Promising Applications for Surface Modification and Advanced Nanomedicine. ACS Nano 2019, 13 (8), 8537-8565.
14. Dwulet, G. E.; Dischinger, S. M.; McGrath, M. J.; Basalla, A. J.; Malecha, J. J.; Noble, R. D.; Gin, D. L. Breathable, Polydopamine-Coated Nanoporous Membranes that Selectively Reject Nerve and Blister Agent Simulant Vapors. Ind. Eng. Chem. Res. 2019, 58 (47), 21890-21893.
15. Bernsmann, F.; Frisch, B.; Ringwald, C.; Ball, V. Protein Adsorption on Dopamine-Melanin Films: Role of Electrostatic Interactions Inferred from Zeta-Potential Measurements Versus Chemisorption. J. Colloid Interf. Sci. 2010, 344 (1), 54-60.
16. Gao, R.; Zhang, L.; Hao, Y.; Cui, X.; Tang, Y. Specific Removal of Protein Using Protein Imprinted Polydopamine Shells on Modified Amino-Functionalized Magnetic Nanoparticles. RSC Adv. 2014, 4 (110), 64514-64524.
17. Jia, X.; Xu, M.; Wang, Y.; Ran, D.; Yang, S.; Zhang, M. Polydopamine-Based Molecular Imprinting on Silica-Modified Magnetic Nanoparticles for Recognition and Separation of Bovine Hemoglobin. Analyst 2013, 138 (2), 651-8.
18. Li, Y.; Xie, Y.; Wang, Z.; Zang, N.; Carniato, F.; Huang, Y.; Andolina, C. M.; Parent, L. R.; Ditri, T. B.; Walter, E. D.; Botta, M.; Rinehart, J. D.; Gianneschi, N. C. Structure and Function of Iron-Loaded Synthetic Melanin. ACS Nano 2016, 10 (11), 10186-10194.
19. Wang, Z.; Xie, Y.; Li, Y.; Huang, Y.; Parent, L. R.; Ditri, T. B.; Zang, N.; Rinehart, J. D.; Gianneschi, N. C. Tunable, Metal-Loaded Polydopamine Nanoparticles Analyzed by Magnetometry. Chem. Mater. 2017, 29 (19), 8195-8201.
20. Hebbar, R. S.; Isloor, A. M.; Ananda, K.; Ismail, A. F. Fabrication of Polydopamine Functionalized Halloysite Nanotube/Polyetherimide Membranes for Heavy Metal Removal. J. Mater. Chem. A 2016, 4 (3), 764-774.
21. Dong, Z.; Zhang, F.; Wang, D.; Liu, X.; Jin, J. Polydopamine-Mediated Surface-Functionalization of Graphene Oxide for Heavy Metal Ions Removal. J. Solid. State. Chem. 2015, 224, 88-93.
22. Sun, D. T.; Peng, L.; Reeder, W. S.; Moosavi, S. M.; Tiana, D.; Britt, D. K.; Oveisi, E.; Queen, W. L. Rapid, Selective Heavy Metal Removal from Water by a Metal-Organic Framework/Polydopamine Composite. ACS Cent. Sci. 2018, 4 (3), 349-356.
23. Fang, X.; Li, J.; Li, X.; Pan, S.; Zhang, X.; Sun, X.; Shen, J.; Han, W.; Wang, L. Internal Pore Decoration with Polydopamine Nanoparticle on Polymeric Ultrafiltration Membrane for Enhanced Heavy Metal Removal. Chem. Eng. J. 2017, 314, 38-49.
24. Cheng, W.; Liang, C.; Xu, L.; Liu, G.; Gao, N.; Tao, W.; Luo, L.; Zuo, Y.; Wang, X.; Zhang, X.; Zeng, X.; Mei, L. TPGS-Functionalized Polydopamine-Modified Mesoporous Silica as Drug Nanocarriers for Enhanced Lung Cancer Chemotherapy Against Multidrug Resistance. Small 2017, 13 (29).
25. Liu, C.; Yao, W.; Tian, M.; Wei, J.; Song, Q.; Qiao, W. Mussel-Inspired Degradable Antibacterial Polydopamine/Silica Nanoparticle for Rapid Hemostasis. Biomaterials 2018, 179, 83-95.
26. Wang, J.-G.; Zhou, H.-J.; Sun, P.-C.; Ding, D.-T.; Chen, T.-H. Hollow Carved Single-Crystal Mesoporous Silica Templated by Mesomorphous Polyelectrolyte-Surfactant Complexes. Chem. Mater. 2010, 22 (13), 3829-3831.
27. Della Vecchia, N. F.; Luchini, A.; Napolitano, A.; D'Errico, G.; Vitiello, G.; Szekely, N.; d'Ischia, M.; Paduano, L. Tris Buffer Modulates Polydopamine Growth, Aggregation, and Paramagnetic Properties. Langmuir 2014, 30 (32), 9811-9818.
28. Yue, Q.; Wang, M.; Sun, Z.; Wang, C.; Wang, C.; Deng, Y.; Zhao, D. A Versatile Ethanol-Mediated Polymerization of Dopamine for Efficient Surface Modification and the Construction of Functional Core-Shell Nanostructures. J. Mater. Chem. B 2013, 1 (44), 6085-6093.
29. Zangmeister, R. A.; Morris, T. A.; Tarlov, M. J. Characterization of Polydopamine Thin Films Deposited at Short Times by Autoxidation of Dopamine. Langmuir 2013, 29 (27), 8619-28.
30. Li, K.-M.; Jiang, J.-G.; Tian, S.-C.; Chen, X.-J.; Yan, F. Influence of Silica Types on Synthesis and Performance of Amine-Silica Hybrid Materials Used for CO₂ Capture. J. Phys. Chem. C 2014, 118 (5), 2454-2462.
31. Xiong, S.; Wang, Y.; Yu, J.; Chen, L.; Zhu, J.; Hu, Z. Polydopamine Particles for Next-Generation Multifunctional Biocomposites. J. Mater. Chem. A 2014, 2 (20), 7578-7587.
32. Shanmuganathan, K.; Cho, J. H.; Iyer, P.; Baranowitz, S.; Ellison, C. J. Thermooxidative Stabilization of Polymers Using Natural and Synthetic Melanins. Macromolecules 2011, 44 (24), 9499-9507.
33. Chen, F.; Xing, Y.; Wang, Z.; Zheng, X.; Zhang, J.; Cai, K. Nanoscale Polydopamine (PDA) Meets Pi-Pi Interactions: An Interface-Directed Coassembly Approach for Mesoporous Nanoparticles. Langmuir 2016, 32 (46), 12119-12128.
34. Nandi, M.; Uyama, H. Exceptional CO2 Adsorbing Materials Under Different Conditions. Chem. Rec. 2014, 14 (6), 1134-1148.
35. Xu, X.; Zhao, X.; Sun, L.; Xiaoqin, L. Adsorption Separation of Carbon Dioxide, Methane, and Nitrogen on HB and Na-Exchanged β-Zeolite. J. Nat. Gas Chem. 2008, 17 (4), 391-396.
36. Xu, C.; Yu, G.; Yuan, J.; Strømme, M.; Hedin, N. Microporous Organic Polymers as CO₂ Adsorbents: Advances and Challenges. Mater. Today Adv. 2020, 6.
37. Senthilkumaran, M.; Saravanan, C.; Sethuraman, V.; Puthiaraj, P.; Muthu Mareeswaran, P. Nitrogen-Rich Polyaminal Porous Network for CO₂ Uptake Studies and Preparation of Carbonized Materials. Eur. Polym. J. 2020, 124.
38. Li, G.; Zhou, X.; Wang, Z. Highly Nitrogen-Rich Microporous Polyaminals using N, N-Dimethylformamide and Formamide as the Starting Monomers for CO2 Adsorption and Separation. J. Phys. Chem. C 2020, 124 (5), 3087-3094.
39. Yuan, Y.; Huang, H.; Chen, L.; Chen, Y. N, N′-Bicarbazole: A Versatile Building Block toward the Construction of Conjugated Porous Polymers for CO2Capture and Dyes Adsorption. Macromolecules 2017, 50 (13), 4993-5003.
40. Manoranjan, N.; Won, D. H.; Kim, J.; Woo, S. I. Amide Linked Conjugated Porous Polymers for Effective CO2 Capture and Separation. J. CO2 Util. 2016, 16, 486-491.
41. Liu, F.; Huang, K.; Wu, Q.; Dai, S. Solvent-Free Self-Assembly to the Synthesis of Nitrogen-Doped Ordered Mesoporous Polymers for Highly Selective Capture and Conversion of CO2. Adv. Mater. 2017, 29 (27).
42. Lee, H.; Yavuz, C. T. Increasing Mesoporosity by a Silica Hard Template in a Covalent Organic Polymer for Enhanced Amine Loading and CO2 Capture Capacity. Micropor. Mesopor. Mat. 2016, 229, 44-50.
43. Li, J. R.; Kuppler, R. J.; Zhou, H. C. Selective Gas Adsorption and Separation in Metal-Organic Frameworks. Chem. Soc. Rev. 2009, 38 (5), 1477-504.
44. Omer, R. M.; Al-Tikrity, E. T. B.; El-Hiti, G. A.; Alotibi, M. F.; Ahmed, D. S.; Yousif, E. Porous Aromatic Melamine Schiff Bases as Highly Efficient Media for Carbon Dioxide Storage. Processes 2019, 8 (1).
45. Thomas, K. M. Hydrogen Adsorption and Storage on Porous Materials. Catal. Today 2007, 120 (3-4), 389-398.
46. Simon, C. M.; Smit, B.; Haranczyk, M. pyIAST: Ideal Adsorbed Solution Theory (IAST) Python Package. Comput. Phys. Commun. 2016, 200, 364-380.
47. Rios, R. B.; Stragliotto, F. M.; Peixoto, H. R.; Torres, A. E. B.; Bastos-Neto, M.; Azevedo, D. C. S.; Cavalcante Jr, C. L. Studies on the adsorption behavior of CO-2-CH₄ mixtures using activated carbon. Braz. J. Chem. Eng. 2013, 30 (4), 939-951.
48. Bae, Y.-S.; Mulfort, K. L.; Frost, H.; Ryan, P.; Punnathanam, S.; Broadbelt, L. J.; Hupp, J. T.; Snurr, R. Q. Separation of CO2 from CH4 Using Mixed-Ligand Metal-Organic Frameworks. Langmuir 2008, 24 (16), 8592-8598.
49. Hamon, L.; Jolimaitre, E.; Pirngruber, G. D. CO2 and CH4 Separation by Adsorption Using Cu-BTC Metal-Organic Framework. Ind. Eng. Chem. Res. 2010, 49 (16), 7497-7503.
50. Zhou, X.; Huang, W.; Miao, J.; Xia, Q.; Zhang, Z.; Wang, H.; Li, Z. Enhanced Separation Performance of a Novel Composite Material GrO@MIL-101 for CO2/CH4 Binary Mixture. Chem. Eng. J. 2015, 266, 339-344.
51. Liu, J.; Keskin, S.; Sholl, D. S.; Johnson, J. K. Molecular Simulations and Theoretical Predictions for Adsorption and Diffusion of CH4/H2 and CO2/CH4 Mixtures in ZIFs. J. Phys. Chem. C 2011, 115 (25), 12560-12566.
52. Erisman, J. W.; Sutton, M. A.; Galloway, J.; Klimont, Z.; Winiwarter, W. How a Century of Ammonia Synthesis Changed the World. Nat. Geosci. 2008, 1, 636-639.
53. Saha, D.; Deng, S. Ammonia Adsorption and its Effects on Framework Stability of MOF-5 and MOF-177. J. Colloid Interf. Sci. 2010, 348 (2), 615-20.
54. Helminen, J.; Helenius, J.; Paatero, E.; Turunen, I. Adsorption Equilibria of Ammonia Gas on Inorganic and Organic Sorbents at 298.15 K. J. Chem. Eng. Data 2001, 46 (2), 391-399.
55. Helminen, J.; Helenius, J.; Paatero, E.; Turunen, I. Comparison of Sorbents and Isotherm Models for NH₃-Gas Separation by Adsorption. AICHE J. 2004, 46 (8), 1541-1555.
56. Doonan, C. J.; Tranchemontagne, D. J.; Glover, T. G.; Hunt, J. R.; Yaghi, O. M. Exceptional Ammonia Uptake by a Covalent Organic Framework. Nat. Chem. 2010, 2 (3), 235-8.
57. Kim, K.; Tsay, O. G.; Atwood, D. A.; Churchill, D. G. Destruction and Detection of Chemical Warfare Agents. Chem. Rev. 2011, 111 (9), 5345-403.
58. Smart, J. K., Medical Aspects of Chemical and Biological Warfare Office of the Surgeon General: Washington, D C, 1997.
59. Tu, A. T., Natural and Selected Synthetic Toxins. American Chemical Society Symposium Series: 2000; Vol. 745.
60. Makarovsky, I.; Markel, G.; Hoffman, A.; Schein, O.; Finkelstien, A.; Brosh-Nissimov, T.; Tashma, Z.; Dushnitsky, T.; Eisenkraft, A. Osmium Tetroxide: A New Kind of Weapon. Isr. Med. Assoc. J. 2007, 9 (10), 750-752.
61. Okudera, H. Clinical Features on Nerve Gas Terrorism in Matsumoto. J. Clin. Neurosci. 2002, 9 (1), 17-21.
62. Lee, H. J.; Owens, J. R. Design of Superhydrophobic Ultraoleophobic NyCo. J. Mater. Sci. 2010, 45 (12), 3247-3253.
63. Gadd, G. M.; de Rome, L. Biosorption of copper by fungal melanin. Appl Microbiol Biotechnol 1988, 29, 610-617.
64. Page, W. J.; Shivprasad, S. Iron Binding to Azotobacter salinestris Melanin, Iron Mobilization and Uptake Mediated by Siderophores. BioMetals 1994, 8 (1), 59-64.
65. Liu, Y.; Hong, L.; Kempf, V. R.; Wakamatsu, K.; Ito, S.; Simon, J. D. Ion-Exchange and Adsorption of Fe(III) by Sepia Melanin. Pigment Cell. Res. 2004, 17, 262-269.
66. Chen, S.; Xue, C.; Wang, J.; Feng, H.; Wang, Y.; Ma, Q.; Wang, D. Adsorption of Pb(II) and Cd(II) by Squid Ommastrephes bartrami Melanin. Bioinorg. Chem. Appl. 2009, 2009, 901563.

### Example 2B: Supporting Information to Example 2A: Synthetic Porous Melanin

This Example includes exemplary, non-limiting, materials or compositions, methods or steps, features, properties, and/or other embodiments useful in various aspects disclosed herein.

Materials: Tetraethyl orthosilicate (TEOS) and 25 wt % poly(acrylic acid) solution (PAA) were purchased from Acros Organics. Hexadecyltrimethylammonium bromide (CTAB) was ordered from Tokyo Chemical Industry (TCI). Dopamine hydrochloride was obtained from Alfa Aesar. Ammonium hydroxide was purchased from Fisher Scientific. Hydrofluoric acid (HF), ethanol, and Trizma@Base (tris) were obtained from Sigma Aldrich. All materials were used as received without further purification.

Preparation of Mesoporous Silica: Mesoporous silica nanoparticles (MS) were prepared according to a reported literature method.¹ 0.55 g CTAB was dissolved in 25 mL ultrapure water and 3.00 g PAA was added under vigorous stirring until solution was clear. 2.0 g ammonium hydroxide was added and stirred for 20 min, and solutions turned cloudy. Then, 2.08 g TEOS was added and stirred for 15 min. The mixture was placed in an oven at 120 ºC for 48 h. The reaction solution was centrifuged, washed with ultrapure water, and dried at 60° C. The organic template was removed by calcination for six h at 550° C.

Preparation of 5% and 25% Loaded Synthetic Porous Melanin (SPM): Mesoporous silica nanoparticles were sonicated in ultrapure water for an hour prior to coating. 250 mg MS and 225 mg dopamine (10:9 MS:dopamine by mass) were added to 225 mL ultrapure water and 25 mL ethanol (9:1 H₂O: EtOH by volume) and vigorously stirred at room temperature. After 1 h of stirring tris was added to the solution (10 mM, pH 8.5) and the mixture was stirred for an additional 4 h, yielding 5% Loaded SPM, or 21 h, yielding 25% Loaded SPM. The solution was washed with ultrapure water for a total of five times, centrifuging and resuspending in ultrapure water between washes. Afterwards, the mesoporous silica template was etched with hydrofluoric acid (10 wt %) overnight at room temperature. The remaining particles were centrifuged and washed with ultrapure water five times and resuspended in ultrapure water.

Preparation of Solid PDA Particles: Solid PDA used as a control was synthesized by adding 900 mg dopamine to 300 mL ultrapure water under vigorous stirring at room temperature. Once the dopamine was dissolved, 4 mL 1 M NaOH was quickly injected into the solution. After stirring overnight (18 h), the solution was centrifuged and washed with ultrapure water 5 times and resuspended in ultrapure water.

Characterization: All SPM particles were initially characterized by transmission electron microscopy (TEM, Hitachi HT-7700, 120 KV, or STEM, Hitachi HD-2300A, 200 KV). Fourier transform infrared spectrometer (FT-IR, Thermo Nicolet, Nexus 870 Spectrometer), dynamic light scattering (DLS, Malvern Instruments Ltd, Nano ZS), zeta-potential (Malvern Instruments Ltd, Nano ZS), and ultraviolet-visible spectroscopy (UV-Vis, Agilent Technologies Cary 100 UV-Vis) were used to investigate hydrodynamic diameters. Thermogravimetric analysis (TGA, Netzsch STA 449 F1 “Jupiter” simultaneous thermal analyzer), was completed under air atmosphere and in a temperature range from room temperature (25° C.) to 1000° C.

Sample Activation: Using a Micromeritics Smart VacPrep, samples were activated thermally under vacuum at 100° C. for the mesoporous silica and 75° C. for the pre-etched 5% Loaded SPM (MS@5% SPM) and pre-etched 25% Loaded SPM (MS@25% SPM).

Silica samples were activated using Micromeritics Smart VacPrep and were placed under vacuum at 300° C. for eighteen hours prior to sorption measurements.

Melanin samples were activated using a tousimis SAMDRI-PVT-3D Advanced Manual Critical Point Dryer. Prior to activation, samples were exchanged into ethanol overnight. Using the supercritical dryer, the sample was added to the sample chamber, cooled to 0-10° C., and pressurized to 800 psi. The ethanol was exchanged with liquid CO₂ over the course of 10 hours, purging the system for five minutes every two hours. After the fifth purge, the temperature was raised to 40° C. and the system was pressurized to 1200-1400 psi. The pressure was released slowly overnight at a rate of 0.5 cc/min. Samples were immediately transferred onto a Micromeritics Smart VacPrep and were placed under vacuum for two hours at 25° C. prior to sorption measurements.

Nitrogen Isotherms: For silica and pre-etched SPM samples, N₂ isotherms were collected on a Micromeritics TriStar physisorption instrument at 77 K.

For melanin samples, nitrogen physisorption measurements were collected using a Micromeritics ASAP 2020 instrument at 77 K. Pore-size distributions were obtained using density functional theory (DFT) calculations with a carbon slit geometry and a N₂ DFT model.

CO₂, CH₄, H₂ Isotherms: CO₂, CH₄, and H₂ isotherms were measured using a Micromeritics ASAP 2020 instrument at 273 K, 288 K, and 298 K. Samples were placed under vacuum at 25° C. overnight using a Micromeritics Smart VacPrep prior to each measurement.

NH₃ Isotherms: Ammonia isotherms were collected using a Micromeritics 3Flex instrument at 298 K. Prior to measurements, the activated samples were placed overnight at 25° C. using a Micromeritics Smart VacPrep.

Qst Calculations: Heat of adsorption calculations were obtained using the Micromeritics MicroActive software. The calculations are based on the Clausius-Clapeyron equation (Equation 2.1).

$${Q}_{st} = \frac{{RT}_{1} {T}_{2} ln ( {P}_{1} / {P}_{2} )}{{T}_{2} - {T}_{1}} \qquad ( Equation 2.1 )$$

R is the gas constant (R=8.314 J·K⁻¹·mol⁻¹), T₁ and T₂ represent the adsorption temperature, and P₁ and P₂ indicate the equilibrium pressure (P/P₀).

Ideal Adsorbed Solution Theory (IAST) Calculations: IAST calculations for CO₂/CH₄ were performed by using the Python package pyIAST.² Isotherms were fit using a Brunauer-Emmett-Teller (BET) model.

Diazinon and Paraoxon Sorption Experiments: Target solutions at varied concentrations (1 to 100 ppm) were prepared in deionized water to generate solution binding isotherms of paraoxon and diazinon. The melanin materials were added to target solutions in a scintillation vial (total volume 20 mL) using masses of 40, 20, and 10 mg (±1 mg). Samples were mixed on a rotisserie mixer for 2 h in the dark at room temperature. Then the samples were filtered using 0.2 μm PTFE syringe filters. Analysis of the target remaining in the sample was completed by HPLC. A Shimadzu High Performance Liquid Chromatography (HPLC) system with dual-plunger parallel flow solvent delivery modules (LC-20AD) and an auto-sampler (SIL-20AC; 40 μL injection volume) coupled to a photodiode array detector (SPD-M20A; 277 nm) was used. The stationary phase was a C18 stainless steel analytical column (Luna, 150 mm×4.6 mm, 3 μm diameter; Phenomenex, Torrance, CA) with an isocratic 45:55 acetonitrile: 1% aqueous acetic acid mobile phase (1.2 mL/min).³ The amount of target bound was determined based on the difference between that in the sample and that found in the original target preparation using the same HPLC method. The resulting data was fit using the Langmuir isotherm to generate the saturation loading for the materials in gram/gram and an affinity coefficient (1/M). The Langmuir expression is phenomenological and provided a reasonably good fit for the data collected here. It has been used previously for determination of parameters related to binding of energetics and pesticides by porous adsorbent materials.⁴⁻⁷

Coating NyCo Fabric with Melanin: PDA deposition was performed according to previously reported protocol, with a few modifications.⁸ NyCo fabrics (1 inch) were weighted using a microbalance and subsequently washed with ultrapure water. The fabrics were then immersed into 8 mL of a 3 mg/mL nanoparticle solution (PDA, 5%, or 25% Loaded SPM) in water or into 8 mL of 4 mg/mL dopamine solution in water. The solutions were stirred at 45° C. for 15 hours. After this time, the samples were placed into centrifuge tubes containing 10 mL water and washed by vortexing the tubes for about 30 seconds. This process was repeated three times. After each cycle the solution was removed, and fresh water was added. To remove unbound nanoparticles from the fabric surface, the samples were further washed by sonication in 10 mL water for 2 minutes. This process was repeated 6 times. Finally, the samples were dried into an incubator at 40° C. degrees for 30 minutes. Once dried, the fabrics were weighted, and the amount of deposited melanin was calculated.

Water Vapor Transport Rate for Coated NyCo Fabrics: The water vapor transport (WVT) rate for the treated fabrics was evaluated using a circular fabric sample with a total exposed area of 1.65 cm².⁹⁻¹¹ This method follows the guidance provided by ASTM E96, Water Vapor Transport: Upright Open Cup Method to characterize water vapor transport through the fabric samples and uses an incubator modified to provide an enclosure at 25° C. A scintillation vial (20 mL) is loaded with 16.9 mL deionized water. The fabric sample is sealed over this vial, and vial is weighed. Desiccant drives a humidity differential in the incubator, and a dry nitrogen stream flows across the surface of the sample (0.25 L/min). Using an analytical balance, the weight of the vial is measured at 30 to 45 min intervals.

Dimethyl Methylphosphonate Breakthrough Studies for Coated NyCo Fabrics: The permeation of dimethyl methylphosphonate (DMMP) through fabric samples was evaluated using the guidance provided by Test Operations Procedure (TOP) 8-2-501, Permeation Testing of Materials with Chemical Agents or Simulants (Swatch Testing).^{10, 12, 13} An internal, probe driven heater was used to control the temperature within a custom environment. The ratio of humid to dry air entering this chamber is addressed using probe driven mass flow controllers. The stainless-steel aerosol-vapor-liquid-assessment group (AVLAG) cell holds the sample horizontally with O-ring seals. Diffusive permeation testing uses a nitrogen stream. The headspace above the swatch, in which the target is placed, is stagnant with no pressure difference above and below the swatch. The sample is supported between two solid support discs with aligned 0.64 cm² circular openings. This assembly is placed in the AVLAG cell, and humidity is equilibrated for 2 h. Target is introduced as liquid droplets using a repeating dispenser.

A dedicated FID allows for continuous monitoring of target concentrations. DMMP provides a simulant for phosphorous containing nerve agents. The threshold for initial target breakthrough used here is based on the 1 h marginal exposure level in air (military exposure guideline, MEG). A hazard level qualified as “marginal” is defined as causing degraded mission capability or unit readiness on the basis of the proportion of the unit likely to exhibit effects, the nature of those effects, and confidence in the available data. The 1 h marginal air exposure limit for DMMP is 500 mg/m³;¹⁰ none of the materials evaluated permitted target breakthrough at this rate. To provide a point of comparison, 5.0 mg/m³ was used as the threshold value for DMMP analysis. The peak DMMP rate through the NyCo fabric was 7.5 g/m²/h with initial breakthrough at <1 min and 1,030 μg recovered over the 1,000 min experiment duration.

### REFERENCES CITED IN OR RELEVANT TO EXAMPLE 2B

1. Wang, J.-G.; Zhou, H.-J.; Sun, P.-C.; Ding, D.-T.; Chen, T.-H. Hollow Carved Single-Crystal Mesoporous Silica Templated by Mesomorphous Polyelectrolyte-Surfactant Complexes. Chem. Mater. 2010, 22 (13), 3829-3831.
2. Simon, C. M.; Smit, B.; Haranczyk, M. pyIAST: Ideal Adsorbed Solution Theory (IAST) Python Package. Comput. Phys. Commun. 2016, 200, 364-380.
3. Gebreegzi, Y. T.; Foster, G. D.; Khan, S. U. Simultaneous Determination of Carbaryl, Malathion, Fenitrothion, and Diazinon Residues in Sesame Seeds (Sesamum indicum L.). J. Agric. Food Chem. 2000, 48 (11), 5165-5168.
4. Johnson, B. J.; Melde, B. J.; Charles, P. T.; Cardona, D. C.; Dinderman, M. A.; Malanoski, A. P.; Qadri, S. B. Imprinted Nanoporous Organosilicas for Selective Adsorption of Nitroenergetic Targets. Langmuir 2008, 24 (16), 9024-9029.
5. Johnson, B. J.; Melde, B. J.; Charles, P. T.; Dinderman, M. A.; Malanoski, A. P.; Leska, I. A.; Qadri, S. B. Macroporous Silica for Concentration of Nitroenergetic Targets. Talanta 2010, 81 (4-5), 1454-60.
6. Johnson, B. J.; Melde, B. J.; Moore, M. H.; Malanoski, A. P.; Taft, J. R. Improving Sorbents for Glycerol Capture in Biodiesel Refinement. Materials 2017, 10 (6).
7. Johnson, B. J.; Malanoski, A. P.; Leska, I. A.; Melde, B. J.; Taft, J. R.; Dinderman, M. A.; Deschamps, J. R. Adsorption of Organophosphates from Solution by Porous Organosilicates: Capillary Phase-Separation. Micropor. Mesopor. Mat. 2014, 195, 154-160.
8. Battistella, C.; McCallum, N. C.; Gnanasekaran, K.; Zhou, X.; Caponetti, V.; Montalti, M.; Gianneschi, N. C. Mimicking Natural Human Hair Pigmentation with Synthetic Melanin. ACS Cent. Sci. 2020, 6 (7), 1179-1188.
9. Kar, F.; Fan, J. T.; Yu, W. Comparison of Different Test Methods for the Measurement of Fabric or Garment Moisture Transfer Properties Meas. Sci. Technol. 2007, 18 (7), 2033-2038.
10. Martin, B. D.; Justin, G. I. A.; Moore, M. H.; Naciri, J.; Mazure, T.; Melde, B. J.; Stroud, R. M.; Ratna, B. An Elastomeric Poly(Thiophene-EDOT) Composite with a Dynamically Variable Permeability Towards Organic and Water Vapors. Adv. Funct. Mater. 2012, 22 (15), 3116-3127.
11. Pushpadass, H. A.; Marx, D. B.; Hanna, M. A. Effects of Extrusion Temperature and Plasticizers on the Physical and Functional Properties of Starch Films. Starch—Starke 2008, 60 (10), 527-538.
12. D'Onofrio, T. G., Development of a Contact Permeation Text Fixture and Method, Technical Report EC-BC-TR-1141. Center, U.S.A E. C. B., Ed. Aberdeen Proving Ground, M D, 2013.
13. Johnson, B. J.; Melde, B. J.; Moore, M. H.; Taft, J. R. Deposition of Porous Sorbents on Fabric Supports. J. Vis. Exp. 2018, (136), e57331.

### Example 3: Catalytic Degradation

This Example includes exemplary, non-limiting, materials or compositions, methods or steps, features, properties, and/or other embodiments useful in various aspects disclosed herein.

Optionally, any of the devices described herein include one or more catalytic materials. Optionally, the one or more catalytic materials facilitate catalytic degradation of materials, molecules, or compounds in or at the gas-capture device, such as at or in proximity of a substrate of the gas-capture device and/or at or in proximity of a porous artificial melanin material of the gas-capture device and/or at or in proximity of the one or more catalytic materials. Optionally, the catalytically degraded materials, molecules, or compounds are material, molecules, or compounds adsorbed in the gas-capture device, such as at or in proximity of a substrate of the gas-capture device and/or at or in proximity of a porous artificial melanin material of the gas-capture device and/or at or in proximity of the one or more catalytic materials. Optionally, the catalytically degraded materials, molecules, or compounds are the one or more gaseous compounds captured by the gas-capture device.

Optionally, any of the methods described herein comprise catalytically degrading one or more materials, molecules, or compounds in or at the gas-capture device. Optionally, any of the methods described herein comprise catalytically degrading one or more materials, molecules, or compounds in or at the gas-capture device using one or more catalytic materials of the gas-capture device. Optionally, the step of catalytically degrading comprises catalytically degrading the one or more materials, molecules, or compounds at or in proximity of a substrate of the gas-capture device and/or at or in proximity of a porous artificial melanin material of the gas-capture device and/or at or in proximity of the one or more catalytic materials. Optionally, the catalytically degraded materials, molecules, or compounds are material, molecules, or compounds adsorbed in the gas-capture device, such as at or in proximity of a substrate of the gas-capture device and/or at or in proximity of a porous artificial melanin material of the gas-capture device and/or at or in proximity of the one or more catalytic materials. Optionally, the catalytically degraded materials, molecules, or compounds are the one or more gaseous compounds captured by the gas-capture device. Generally, the step of catalytically degrading occurs or is performed concurrently with or after the step of capturing.

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a cell” includes a plurality of such cells and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

When a group of substituents is disclosed herein, it is understood that all individual members of that group and all subgroups, including any isomers, enantiomers, and diastereomers of the group members, are disclosed separately. When a Markush group or other grouping is used herein, all individual members of the group and all combinations and subcombinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individual or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Methods for making such isotopic variants are known in the art. Specific names of compounds are intended to be exemplary, as it is known that one of ordinary skill in the art can name the same compounds differently.

Certain molecules disclosed herein may contain one or more ionizable groups [groups from which a proton can be removed (e.g., —COOH) or added (e.g., amines) or which can be quaternized (e.g., amines)]. All possible ionic forms of such molecules and salts thereof are intended to be included individually in the disclosure herein. With regard to salts of the compounds herein, one of ordinary skill in the art can select from among a wide variety of available counterions those that are appropriate for preparation of salts of this invention for a given application. In specific applications, the selection of a given anion or cation for preparation of a salt may result in increased or decreased solubility of that salt.

Every compound, material, system, formulation, combination of components, and method described or exemplified herein can be used to practice the invention, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. A method of capturing one or more target compounds using a capture device, the method comprising:
exposing the capture device to an environment comprising the one or more target compounds; wherein the device comprises:
a porous artificial melanin material comprising:
one or more melanin oligomers, polymers, or a combination thereof; wherein the one or more melanin oligomers, polymers, or a combination thereof comprise a plurality of covalently-bonded melanin base units; wherein the one or more melanin oligomers, polymers, or a combination thereof are arranged to form an internal structure having a plurality of pores; wherein the porous artificial melanin material is characterized by a pore volume per mass of material greater than or equal to 0.1 cm³/g and wherein at least a portion of said pores have at least one size dimension greater than or equal to 0.5 nm; and
capturing the one or more target compounds via an interaction between the porous artificial melanin material and the one or more target compounds.

2. The method of claim 1, wherein the one or more target compounds are one or more gaseous compounds and/or one or more solvated or aqueous compounds; and wherein the environment is a gaseous and/or a liquid environment.

3. The method of claim 1, wherein the one or more target compounds are one or more solvated or aqueous compounds, and the environment is a liquid environment.

4. The method of claim 1, wherein the one or more target compounds are one or more gaseous compounds, the environment is a gaseous environment, and the capture device is a gas-capture device.

5. A method of capturing one or more target compounds using a gas-capture device, wherein the one or more target compounds are one or more gaseous compounds, the method comprising:
exposing the gas-capture device to a gaseous environment comprising the one or more gaseous compounds; wherein the device comprises:
a porous artificial melanin material comprising:
one or more melanin oligomers, polymers, or a combination thereof; wherein the one or more melanin oligomers, polymers, or a combination thereof comprise a plurality of covalently-bonded melanin base units; wherein the one or more melanin oligomers, polymers, or a combination thereof are arranged to form an internal structure having a plurality of pores; wherein the porous artificial melanin material is characterized by a pore volume per mass of material greater than or equal to 0.1 cm³/g and wherein at least a portion of said pores have at least one size dimension greater than or equal to 0.5 nm; and
capturing the one or more gaseous compounds via an interaction between the porous artificial melanin material and the one or more gaseous compounds.

6. The method of claim 2, wherein the step of capturing is characterized by an uptake of the one or more target compounds selected from the range of at least 1.5 cm³/g at a temperature of 273 K, 288 K, or 298 K and at a pressure of 1 bar.

7. The method of claim 2, wherein the step of capturing is characterized by:
an uptake of CO₂ gas selected from the range of 11 cm³/g to 51 cm³/g,
an uptake of CH₄ gas selected from the range of 0.2 cm³/g to 14 cm³/g,
an uptake of H₂ gas selected from the range of 0.2 cm³/g to 13 cm³/g,
an uptake of N₂ gas selected from the range of 99 cm³/g to 1001 cm³/g, and/or
an uptake of NH₃ gas selected from the range of 179 cm³/g to 379 cm³/g,
at a temperature of 270 K to 325 K and at a pressure of 1 bar.

8. The method of claim 2, wherein the step of capturing is characterized by:
a saturation loading of aqueous diazinon selected from the range of 14 g/g to 125 g/g,
an affinity of aqueous diazinon selected from the range of 9000 M⁻¹ to 92000 M⁻¹,
a saturation loading of aqueous paraoxon selected from the range of 4 g/g to 13 g/g, and/or
an affinity of aqueous paraoxon selected from the range of 3000 M⁻¹ to 12000 M⁻¹,
at a temperature of 270 K to 325 K.

9. The method of claim 2, wherein the step of capturing is characterized by:
a peak rate of permeation of aqueous dimethyl methylphosphonate through a nylon-cotton textile having the porous artificial melanin material attached thereto, the peak rate being less than or equal to 1 g/m²/h.

10. The method of claim 2, wherein the step of capturing is characterized by a selectivity for CO₂ being greater than that for CH₄ by 50% to 200%.

11. The method of claim 2, wherein the one or more target compounds comprise one or more greenhouse gas compounds, one or more toxic compounds, one or more nerve agents or nerve toxins, one or more chemical warfare agents, one or more pesticides, one or more chemical irritants, one or more decontamination or sterilization agents, or any combination of these.

12. The method of claim 2, wherein the one or more target compounds are selected from the group consisting of CH₄, NH₃, CO₂, N₂, H₂, NH₃, diazinon, paraoxon, dimethyl methylphosphonate, and any combination thereof.

13. The method of claim 2, wherein one or more gaseous compounds are characterized by a relative amount in the gaseous environment selected from the range of greater than 0 mol % to 100 mol %; and wherein the pressure of the gaseous environment is selected from the range of greater than 0 to 1 bar.

14. The method of claim 1, wherein the interaction comprises adsorption of the one or more target compounds at or to the porous artificial melanin material.

15. The method of claim 1, wherein the porous artificial melanin material is a coating on or otherwise incorporated in a textile material; and wherein the textile material comprising the porous artificial melanin material is characterized by a water vapor transport rate within 20% of a water vapor transport rate of the same or equivalent textile material free of the porous artificial melanin material.

16. The method of claim 1, wherein the porous artificial melanin material is on a substrate.

17. The method of claim 1, wherein the device is an article of clothing, is incorporated with an article of clothing, and/or comprises an article of clothing.

18. The method of claim 1, wherein the device is a textile material, is incorporated with a textile material, and/or comprises a textile material.

19. The method of claim 1, wherein the device is a personal protective equipment, is incorporated with a personal protective equipment, and/or comprises a personal protective equipment.

20. The method of claim 1, wherein the porous artificial melanin material is characterized by an average pore volume per mass of material selected from the range of 0.3 cm³/g to 0.7 cm³/g and/or wherein the porous artificial melanin material is characterized by a Brunauer-Emmett-Teller area selected from the range of 100 m²/g to 1000 m²/g.

21. (canceled)

22. (canceled)

23. The method of claim 1, wherein: (i) the pores of said porous artificial melanin material include micropores each having at least one average size dimension selected from the range of 0.5 nm to 2 nm; and/or (ii) the pores of said porous artificial melanin material include mesopores each having at least one average size dimension selected from the range of 2 nm to 200 nm.

24. The method of claim 1, wherein the pores are characterized by a distribution of pore size dimensions over the range of 0.5 nm to 200 nm.

25. The method of claim 1, wherein said porous artificial melanin material is at least partially an amorphous material.

26. (canceled)

27. (canceled)

28. The method of claim 1, wherein the porous artificial melanin material is at least partially in the form of porous artificial melanin particles.

29. The method of claim 28, wherein said porous artificial melanin particles are characterized by an average size dimension selected from the range of 10 nm to 500 nm in diameter.

30. (canceled)

31. The method of claim 1, wherein said porous artificial melanin particles are purified or isolated.

32. The method of claim 1, wherein the porous artificial melanin material is provided as a film or a coating; or wherein the porous artificial melanin material is at least partially in the form of porous artificial melanin particles provided as a film or a coating.

33. The method of claim 1, wherein said melanin base units are one or more substituted or unsubstituted catechol-based monomers, substituted or unsubstituted polyol-based monomers, substituted or unsubstituted phenol-based monomers, substituted or unsubstituted indole-based monomers, substituted or unsubstituted benzothiazine-based monomers, substituted or unsubstituted benzothiazole-based monomers, substituted or unsubstituted dopamine-based monomers, or any combination of these.

34. The method of claim 1, wherein the porous artificial melanin material comprises allomelanin.

35. (canceled)

36. (canceled)

37. (canceled)

38. (canceled)

39. (canceled)

40. (canceled)

41. The method of claim 1, wherein the porous artificial melanin particles are characterized by a peak size selected from the range of 10 nm to 300 nm and a polydispersity index less than or equal to 0.10.

42. (canceled)

43. (canceled)

44. (canceled)

45. The method of claim 1, wherein the porous artificial melanin material comprises a plurality of the melanin oligomers; wherein each melanin oligomer is non-covalently associated with at least one other melanin oligomer or a melanin monomer via at least one of hydrogen bonding and π-π stacking of naphthalene rings; and wherein the melanin monomer comprises the melanin base unit.

46. A capture device comprising a porous artificial melanin material comprising:
one or more melanin oligomers, polymers, or a combination thereof;
wherein the one or more melanin oligomers, polymers, or a combination thereof comprise a plurality of covalently-bonded melanin base units; wherein the one or more melanin oligomers, polymers, or a combination thereof are arranged to form an internal structure having a plurality of pores; wherein the porous artificial melanin material is characterized by a pore volume per mass of material greater than or equal to 0.1 cm³/g and wherein at least a portion of said pores have at least one size dimension greater than or equal to 0.5 nm.

47. (canceled)

48. (canceled)

49. (canceled)

50. (canceled)

51. A method of making a capture device, the method comprising:
depositing or incorporating a porous artificial melanin material onto or into a substrate; wherein the porous artificial melanin material comprises:
one or more melanin oligomers, polymers, or a combination thereof; and
wherein the one or more melanin oligomers, polymers, or a combination thereof comprise a plurality of covalently-bonded melanin base units; wherein the one or more melanin oligomers, polymers, or a combination thereof are arranged to form an internal structure having a plurality of pores; wherein the porous artificial melanin material is characterized by a pore volume per mass of material greater than or equal to 0.1 cm³/g and wherein at least a portion of said pores have at least one size dimension greater than or equal to 0.5 nm.

52. (canceled)

53. (canceled)

54. (canceled)

55. (canceled)

56. (canceled)

57. (canceled)

58. (canceled)

59. (canceled)

60. The method of claim 1, wherein the porous artificial melanin material has a thickness and/or molecular weight corresponding a polymerization of said porous artificial melanin material for a time selected from the range of 0.5 hours to 24 hours.

61. (canceled)

62. The method of claim 1 comprising catalytically degrading of the one or more target compounds.

63. (canceled)

64. (canceled)

65. (canceled)

66. The method of claim 1, wherein the capture device comprises one or more catalytic materials for catalytic degradation of the one or more target compounds.

67. (canceled)

68. The method of claim 1 comprising removing or capturing CO₂ from the gaseous environment, removing or capturing toxic gas(es) from air, and/or storing of one or more useful target compounds, such as for transport and rapid delivery in a solid state device.

69. (canceled)

70. (canceled)

71. (canceled)

72. (canceled)

73. (canceled)

74. (canceled)

75. (canceled)

76. (canceled)

77. (canceled)

78. (canceled)

79. (canceled)

80. The method of claim 1, wherein the interaction between the porous artificial melanin material and the one or more target compounds comprises adsorption of the one or more target compounds at one or more internal portions and/or one or more external portions of the porous artificial melanin material.

81. (canceled)

82. (canceled)

83. (canceled)

84. (canceled)

85. (canceled)

86. (canceled)
